(19) United States
(12) Patent Application Publication
(10) Pub. No.: US 2004/0224425 A1
(43) Pub. Date: Nov. 11, 2004

(54) Biomolecule open channel solid phase extraction systems and methods

(76) Inventors: Douglas T. Gjerde, Saratoga, CA (US); Christopher T. Hanna, San Francisco, CA (US)

Correspondence Address: PhyNexus, Inc., Attn: IP Dept., Suite A, 3670 Charter Park Dr., San Jose, CA, 95136, US

(21) Appl. No.: 10/733,664

(22) Filed: Dec. 10, 2003

Related U.S. Application Data
(63) Continuation-in-part of application No. 10/434,713, filed on May 8, 2003.
(60) Provisional application No. 60/483,527, filed on Jun. 27, 2003.

(51) Int. Cl. G01N 1/18

(52) U.S. Cl. 436/518; 436/178; 422/100

(57) ABSTRACT

A fused silica extraction capillary is provided having an internal solid phase extraction surface that binds an analyte, wherein at least some portion of the capillary is coiled at a bend radius of less than 3 cms. Also provided are methods for making and using the capillary and devices incorporating the capillary. The methods and devices are particularly useful in connection with biomoecule analytes, such as proteins and polynucleotides.

### CROSS-REFERENCE TO RELATED APPLICATIONS

This application claims priority to and benefit of U.S. patent application Ser. No. 10/434,713, filed May 8, 2003, and U.S. Provisional Patent Application Ser. No. 60/483,527, filed Jun. 27, 2003.

### FIELD OF THE INVENTION

This invention relates to apparatus and methods for separating and concentrating analytes from solutions. The analytes can be fragile biomolecules and biomolecule complexes which are to be purified and concentrated for application to protein chips or for introduction into a mass spectrometer for mass spectrum analysis.

### BACKGROUND OF THE INVENTION

Solid phase extraction has been used to extract analytes from water and other liquids to prepare them for analysis. For example, the technique has found success in monitoring drinking water by extraction of organics from the water followed by high pressure liquid chromatography separation and mass spectrometry (MS) detection to determine the identity and concentration of pollutants. Proteins and nucleic acid materials are frequently isolated from biological samples by passing them through a packed column and cartridge containing a solid phase where the molecules of interest are adsorbed. After the sample has passed through the column and the sample molecules have been adsorbed, a solvent is used to desorb the molecules of interest and form a concentrated solution. A portion of the concentrated solution is then analyzed by a high performance liquid chromatograph (HPLC), mass spectrometer or another selected analytical instrument.

Numerous articles are cited and incorporated by reference in this application. The citation format for these articles herein is as follows: Author(s), Publication, Volume, Page number and Year and is intended to include and incorporate by reference all pages of each article.

Because the available size of some raw samples are small, efforts have been made to decrease the size of the extraction columns, most often by simply using smaller packed columns. Capillary columns provide one approach for miniaturizing columns. Most efforts have been made with packed capillary columns. More recently, use of open tube capillaries to extract sample molecules for liquid chromatography have been reported by Ralf Eisert, et al., Analytical Chemistry, 69:3140 (1997) and Hiroyuki Kataoka, et al., Analytical Chemistry, 71:4237 (1999). The tubes were fused silica tubes that had been adapted from tubes used in capillary electrophoresis or gas chromatography systems.

An open tube capillary solid phase extraction has also been used to preconcentrate samples for capillary electrophoresis (CE). Norberto Guzman, Journal of Liquid Chromatography, 18:3751 (1995) and Jianyi Cai, et al., Journal of Liquid Chromatography, 16(9&10):2007 (1993). The capillary tube with an extraction phase coated on the wall is assembled as part of the overall CE capillary. Sample is pumped through the CE capillary assembly or pulled through using electroosmotic flow (EOF). Electroosmotic flow is the force that carries the bulk liquid through the capillary. The capillary is washed with running buffer, and desorbing buffer is introduced to the capillary followed by the running buffer. The voltage is applied and the separation of analytes is accomplished.

This invention is used for the capture of analytes by solid phase extraction with a capillary channel and collection of the analytes into a controlled volume of solvent. This invention is useful for analytes including biomolecules and is compatible with requirements for sample preparation and analysis by analytical technology—especially biochips and mass spectrometry.

This invention is particularly useful in the field of proteomics. Proteomics can be defined as the comprehensive study of proteins and their functional aspects. Proteins perform the work of the cell. Single proteins can have many forms. The function of a protein depends on the form, interactions, and complexes of the protein. A deeper understanding of proteins' biological functions is needed so that drugs can be developed.

Protein sample processing is a complex problem within proteomics. Proteins function individually or as complexes (groups). Proteins cannot be amplified, as DNA is amplified with polymerase chain reaction (PCR) methods. Proteins must be enriched and purified before they can be analyzed. Protein processing methods and systems must be flexible; more than a million possible proteins are expressed. For analysis it is necessary to separate and concentrate the proteins of interest from many thousands of other proteins, while selectively removing other materials that will interfere with the protein analytical process including cellular material such as sugars, carbohydrates, lipids, DNA, RNA and salts. Reproducible recovery is needed and protein function must be retained during processing. Structural differences between forms must be preserved and final processing of samples must be easily integrated into many different detection schemes, for example mass spectrometry, protein chips, and the like.

Solid phase extraction is one of the primary tools for preparing protein samples prior to analysis. The method purifies proteins according to their identity, class type or structure, or function to prepare them for analysis by mass spectrometry or other analytical methods.

The process of solid phase extraction uses an extraction phase in the form of a column or bed, and the sample may be either loaded onto the column or added to a bulk solution to extraction beads. The extraction phase retains the sample, the extraction phase is washed to remove contaminants, and then the sample is removed with the extraction or recovery solvent.

Extraction columns are used to prepare the protein samples for analysis. Often very low amounts of proteins are expressed in a sample, and sample preparation procedures are needed to isolate and recover the protein before analysis.

The solid phase extraction of biomolecules such as nucleic acids and proteins is commonly performed by columns packed with a variety of extraction phases.

The need for biomolecule extraction for proteins is gaining rapidly. Large numbers of samples need to be analyzed by a variety of techniques to determine the function of proteins. Typical sample volume is 0.5 to 5 mL on a typical column bed volume 1 to 5 mL requiring a typical desorption solvent volume of 5 to 10 mL.

There are a number of companies that have developed products whose principle aim is the purification of certain proteins or protein classes by solid phase extraction. The intent of these products is the simplification of proteomic analyses by providing a sample of only those proteins in which the investigator is interested. These products are often packaged for a single use and disposal. Packed-bed columns operate at relatively low pressures, thus making them simple to operate in a highly parallel and automated manner. Due to the very nature of a packed-bed approach, it is limited with respect to reliable quantification and/or enrichment of sample. A packed-bed approach is extremely difficult to apply in a manner that is both cost-effective and reliable. It cannot be effectively applied to a nanoscale process level.

There are many shortcomings to the packed-bed approach. One of the most dramatic drawbacks is the cost of manufacturing the packed columns. Each column requires a separate manufacturing event, so that it is impossible to make a very large number of them “all at once.” This consequently makes quality control of the lot more challenging, as quality control uses random sampling of the lot, and failures can be easily missed.

Other drawbacks include: losses of materials due to unswept volumes leading to low recoveries and irreproducibility of results; dilution of materials due to large elution volumes applied in an attempt to minimize these selfsame unswept volumes; depending on implementation, requirements often to adhere to some flow “directionality,” thus introducing limitations on full integration of sample processing; manufacturing difficulties for micro- or nano-scale volumes in a simple and low-cost manner; and materials used in commercially available systems are typically porous which often cause severe loss of materials.

Moreover, packed columns have extensive carry-over from sample to sample, are expensive to manufacture, and may be difficult to multiplex (extract multiple samples simultaneously). Proteins may be irreversibly adsorbed to the extraction phase or may be trapped by frits and other “dead zones” within the column making recovery of the proteins incomplete.

A need exists to improve the extraction columns for solid phase extraction of biomolecules. U.S. Pat. No. 5,833,927 discloses a device and method for affinity separation and confirms the need for solid phase extraction.

These formats commonly use a packed column. Proteins are then eluted from these packed column phases, and are either analyzed directly or (as is more typical) desalted and/or dialyzed prior to further analysis.

A need therefore exists for a device and method that can concentrate, clean and deliver a defined volume of analyte molecules and more specifically biomolecules from a number of sample types. The device and method needed must not be limited to any particular analytical process or instrument; must be operational on a small scale; must tolerate air and particulates typically found in samples; must be disposable, if needed; and must be capable of being multiplexed, if needed.

The term “liquid segment” is defined herein as a block of liquid in a channel, bounded at each end by a block of liquid or gas.

The term “leading edge desorption” is defined as a process wherein the leading segment of a liquid passing through a channel desorbs all or substantially all of a biomolecule from the channel wall. This leading segment becomes a liquid segment bounded on its tail by solvent which is not a part of the leading segment.

The term “solid phase extraction tube enrichment factor” is defined as the ratio of the volume of a channel, to the volume of the liquid segment containing the desorbed analyte.

The term “solid phase extraction enrichment factor” is defined as the ratio of the volume of a sample to the volume of liquid segment containing the desorbed analyte.

The term “agitated flow” is defined to be liquid flow through a channel with secondary flow patterns moving liquid toward and away from the walls of the channel as the liquid moves through the channel.

The term “protein chip” is defined as a small plate or surface upon which an array of separated, discrete protein biomolecules dots are to be deposited or have been deposited. In general, a chip bearing an array of discrete proteins is designed to be contacted with a sample having one or more biomolecules which may or may not have the capability of binding to the surface of one or more of the dots, and the occurrence or absence of such binding on each dot is subsequently determined. A reference that describes the general types and functions of protein chips is Gavin MacBeath, Nature Genetics Supplement, 32:526 (2002).

The term “agitation aspect ratio” (AAR) is defined herein as the ratio of the effective curve diameter central axis of a non-linear channel and the effective tubing diameter. It can be calculated by the formula:

$$AAR = \frac{EffectiveCurveDiameterOfTubingCentralAxis}{EffectiveTubingDiameter}$$

The term “OCCD,” as used herein, is defined as an open capillary channel device comprising a rigid or flexible object such as a block, tube or other conduit device having one or more capillary flow passageways, each passageway having an inlet and an outlet. It can be a single object having a single capillary passageway such as a capillary tube, a bundle of tubes, a solid block with a capillary passageway therethrough, a solid block with a plurality of capillary passageways therethrough, or the like. The passageways can have linear or non-linear central axes.

The term “tube enrichment factor” or “TEF,” as used herein, is defined as the ratio of the total volume of a capillary channel divided by the volume of sample desorption solution which can be produced by a device. For example, a tube having a total tube volume (Vₜ) of 0.45 μL (i.e., 450 nL) has 5 μL of sample solution pumped through it to extract an analyte biomolecule. The tube is washed and the fluid displaced with air. The biomolecule is desorbed with a segment of desorption liquid (V_{d}) having a volume of 45 nL. The tube enrichment factor (TEF) is determined by the following equation to be 10.

$$TEF = \frac{Vt}{Vd} = \frac{450 nL}{45 nL} = 10$$

### SUMMARY OF THE INVENTION

One object of the invention is to provide a channel or a group of channels configured to desorb a biomolecule material with a small defined volume or segment of liquid, and to transport the small segment of liquid to the location where it is used.

Another object of the invention is to provide a system and method wherein the fluid segment containing the desorbed biomolecule is in a concentrated, small volume suitable for use in any appropriate instrument or protein chip, or delivered to a vial for further use. The final concentration of the biomolecule is determined by the tube enrichment factor of the system, and the original sample volume, tube volume and concentration. That is, the enrichment factor is equal to the original sample volume divided by the column volume and multiplied by the TEF. This assumes 100% efficiency in the extraction and desorption processes.

In an embodiment, the invention provides a device having as a component an open capillary channel device (OCCD) for open tubular solid phase extraction of molecules. In some embodiments of the invention, the OCCD is capable of providing a tube enrichment factor (TEF) of at least 1. The device can comprise at least one length of channel having a first end connected to a pump means for pumping liquid and gas, and a second end, the inner surface of the channel is an extraction surface. The pump means can be a syringe, pressurized container, centrifugal pump, electrokinetic pump, or an induction based fluidics pump. For some applications, the second end can be connected to an interface for a protein chip sample applicator or a mass spectrometer.

In this capillary channel, the extraction surface can have a binding property which can be provided by having an extraction agent bound thereto. The extraction agent can comprise an affinity binding agent having binding affinity for selected biomolecules. The affinity binding agent can be a chelated metal having a binding affinity for a selected biomolecule; a protein having a binding affinity for a selected protein; an organic molecule or group having a binding affinity for a selected protein; a sugar having a binding affinity for a selected protein; nucleic acid having a binding affinity for a selected protein; or a nucleic acid or a sequence of nucleic acids having a binding affinity for a selected nucleic acid or nucleic acid sequence, for example.

The extraction surface can be a variety of surfaces selected for the specific extraction and concentration process for which it will be used. It can have a non-polar surface; non-polar reverse phase surface for interacting with an aqueous and organic solvent mixture mobile phase; a polar surface for interacting with a non-polar mobile phase; an ion exchange property; weak hydrophobic property; or a neutral hydrophilic property, for example.

In the method of this invention for molecular open tubular solid phase extraction with an open capillary channel device having an affinity extraction surface for sample molecules, the method can comprise the steps of (a) binding sample molecules from a sample solution to the affinity extraction surface of the capillary channel, the capillary channel having a total capillary volume; and (b) desorbing a substantial portion of the sample molecules from the affinity extraction surface with a desorbent liquid passed through the capillary channel. The total volume of desorbent liquid can, but need not necessarily, be less than the total volume of the capillary, e.g., at least 10 times smaller than the total capillary volume. The method can have an effective tube enrichment factor of at least 1 and can have an effective tube enrichment factor of up to 400 or more.

The sample solution can be dilute, and the sample solution can be passed through the channel at a rate and time that affects binding of a substantial portion of the sample biomolecules to the affinity extraction surface. The direction of passage of the sample solution through the channel can be reversed at least once to increase the contact time between the sample solution and the affinity extraction surface. The direction of passage of the desorbent through the channel can also be reversed at least one time to increase the contact time between the desorbent and the affinity extraction surface.

A wash solution can be passed through the capillary channel between step (a) and step (b) above. The wash solution can be displaced from the capillary channel by a gas before step (b). The affinity binding agent can be a chelated metal having a binding affinity for a selected biomolecule; a protein having a binding affinity for a selected protein; an organic molecule or group having a binding affinity for a selected protein; a sugar having a binding affinity for a selected protein; nucleic acid having a binding affinity for a selected protein; or a nucleic acid or a sequence of nucleic acids having a binding affinity for a selected nucleic acid or nucleic acid sequence. The wash solution can be displaced from the capillary channel in step (b). The sample concentration can increased at least 1000 times or more. The molecule can be a biomolecule, and the product of step (b) can be applied to a protein chip or a mass spectrometer.

In some embodiments, a coiled fused silica capillary tubing is used as the capillary channel.

### BRIEF DESCRIPTION OF THE DRAWINGS

FIGS. 1-4 are schematic drawings showing the operation of an open tube extraction channel of this invention.

FIG. 5 is a drawing of a looped configuration for a capillary channel tube of this invention.

FIG. 6 is a drawing of a multiplexed group of capillary channel tubes of FIG. 5.

FIG. 7 is a drawing of a multiplexed group of capillary channel tubes of FIG. 5 enclosed in a housing enabling indexed processing of samples in each channel tube and indexed deposition of extracted and concentrated analyte from each channel tube into or onto a target.

FIG. 8 is a schematic drawing of a moveable platform system of this invention with sample solutions, gas vials, and a target supported on the platform.

FIG. 9 is a schematic drawing of a moveable platform system of this invention wherein the sample, conditioning/wash liquid, desorption liquid, and gas are provided from reservoirs through a valve system, and both an electrospray interface and a target are supported on the platform.

FIG. 10 is a schematic drawing of a moveable platform system of this invention wherein the conditioning/wash liquid, desorption liquid, and gas are provided reservoirs through a valve system; and the sample, electrospray interface and a target are supported on the platform.

FIG. 11 is a schematic drawing wherein sample, conditioning/wash liquid, desorption liquid, and gas are provided in pressurized containers; waste and a target are supported on a moveable platform, and both ends of the extraction channel are movable.

FIG. 12 is a single syringe capillary embodiment of this invention.

FIG. 13 breakthrough curves for benzyl alcohol and lysozyme at 60 uL/min shows the breakthrough curves in Example 36 for neutral marker (benzyl alcohol) and lysozyme at 60 μl/min.

FIG. 14 breakthrough curves for benzyl alcohol and lysozyme at 120 ul/min shows the breakthrough curves for neutral marker (benzyl alcohol) and lysozyme at 120 μL/min.

FIG. 15 breakthrough curves for benzyl alcohol and lysozyme at 300 ul/min shows the breakthrough curves for neutral marker (benzyl alcohol) and lysozyme at 300 μL/min.

FIG. 16 breakthrough curves for benzyl alcohol and lysozyme at 600 ul/min shows the breakthrough curves for neutral marker (benzyl alcohol) and lysozyme at 600 μL/min.

FIG. 17 breakthrough curves for benzyl alcohol at 60 uL/min, and lysozyme at 60 uL/min and 600 uL/min shows the breakthrough curves for neutral marker (benzyl alcohol) at 60 μL/min, and lysozyme at 60 μL/min and 600 μL/min.

FIG. 18 lysozyme eluted from a coiled column, loaded at 60 uL/min shows the breakthrough curves for Lysozyme eluted from a coiled column, loaded at 60 μL/min.

FIG. 19 lysozyme eluted from a straight column, loaded at 60 uL/min shows the breakthrough curves for Lysozyme eluted from a straight column, loaded at 60 μL/min.

FIG. 20 lysozyme eluted from a coiled column, loaded at 600 uL/min shows the breakthrough curves for Lysozyme eluted from a coiled column, loaded at 600 μL/min.

FIG. 21 depicts coiled tubing in a helical format.

FIG. 22 is a table that predicts applied bending stress in kpsi as a function of total OD and bend radius published a table, reproduced from “Mechanical Stress and Fiber Strength,” The Book on the Technologies of Polymicro (Polymicro Technologies LLC, Phoenix, Ariz., 2002) page 3-7.

### DETAILED DESCRIPTION OF THE INVENTION

The shortcomings of the prior art methods set forth above have been overcome with an open tube column format for affinity and chromatographic separations.

This invention relies on the use of open tubular columns for solid phase extraction of biomolecules. The walls of open tubular columns are generally nonporous, making capture and release of proteins more predictable and more complete.

There are no upswept volumes so that losses are dramatically minimized or eliminated. Having no unswept volumes does not necessarily mean that the tube walls become dry if a gas is pumped through the capillary. The extraction phase will remain hydrated or solvated as long as the capillary channel is not heated or a large amount of gas is passed through the capillary channel. However, having no unswept volumes will allow the introduction, control and collection of defined volumes of liquid that can contain the analyte of interest. The tube or capillary channel must have the property of allowing movement and removal of liquid. From this respect, the tube could contain secondary structures, including roughness and protrusions or even beads or monolith structure as long as the channels that are formed in the secondary structure do not cause unswept volumes. A reference (Ronald Majors, 2002 Pittsburgh Conference, Part I, LC/GC Europe, April 2002, pp 2-15) gives details on the encapsulated and monolith structures.

Furthermore, the extraction phase device can serve as both separation medium and transfer tubing. For example, the deposition end of the fused silica tube can be positioned to deposit the purified and/or enriched sample directly onto a protein chip, MALDI target or an electrospray nozzle. In this way, the analyte may be transferred without losses.

It is possible to repeatedly expose both sample and desorption solvent to the extraction phase (i.e. simply flowing it back and forth). In the case of sample, this can mean greater extraction efficiencies and hence greater recoveries. In the case of desorption solvent, this can mean dramatically reduced desorption volume, resulting in a more enhanced desorbed sample. Concentrations of the sample can be increased by using only a small slug of desorbing solvent that passes back and forth over the stationary phase before it is deposited from the open tube column to the target.

Biomolecules can be large and bulky, and therefore transport to and from the extraction phase contained on the wall may be much slower than for small (organic) molecules. Nevertheless, it is possible to perform efficient extraction and recovery of these large molecules with the method and device of this invention.

Performance in the open tube column can be improved by improving transport to and from the surface. This is done by introducing agitated flow (e.g., turbulent or non-turbulent tortuous flow) within the capillary column.

Microliter or nanoliter volumes can be prepared and spotted directly on a target. Many of the new analytical approaches require manipulation of small volumes of sample.

The open capillaries (˜0.1 mm ID) are coated with affinity groups. They can be used to process large sample volumes (up to many mLs), selectively trapping proteins of interest on walls. The analyte can be eluted into nano-scale volumes with high enrichment factors and exceptional purity.

The device and method provides high flexibility, can be used with many chemistries by applying the appropriate chemicals to the channel walls. The device is highly robust, has low manufacturing costs, and can be readily adapted to highly parallel operations.

A variety of general systems can be used with open tubular devices to carry out the methods of this invention. They can include combination of a capillary channel and a pump for gas and liquids such as conditioning fluid, sample, wash fluid, and desorption fluid. The pump can be a syringe (pressure or vacuum), pressure vessel (vial), or centrifugation device. The capillary can have a wall modification for extraction of biomolecule(s) or protein(s). The capillary channel can have a shape and wall configuration to promote agitated flow. The system can include means to position the end of capillary channel above, on or in a deposition target. This may be the same end of the capillary where the conditioning fluid, sample, and wash fluid are introduced or the opposite end. The target may be an injector; protein chip, mass spectrometer, HPLC, or other analytical device or other device for holding or containing sample (such as a vial or tube). This combination of functions can be provided by a single extraction channel.

The channel can be a single tube or be formed as a block of multiple tubes or a multichannel block (multicapillary format).

Depending upon the system configuration, the methods can be carried out by loading the sample into the capillary channel from either end, washing the capillary channel from either end, and desorbing with a segment of solvent from either end, where the segment containing desorbed protein(s) or biomolecules(s) is directed to or deposited on a target. The target can be a spot on a protein chip device.

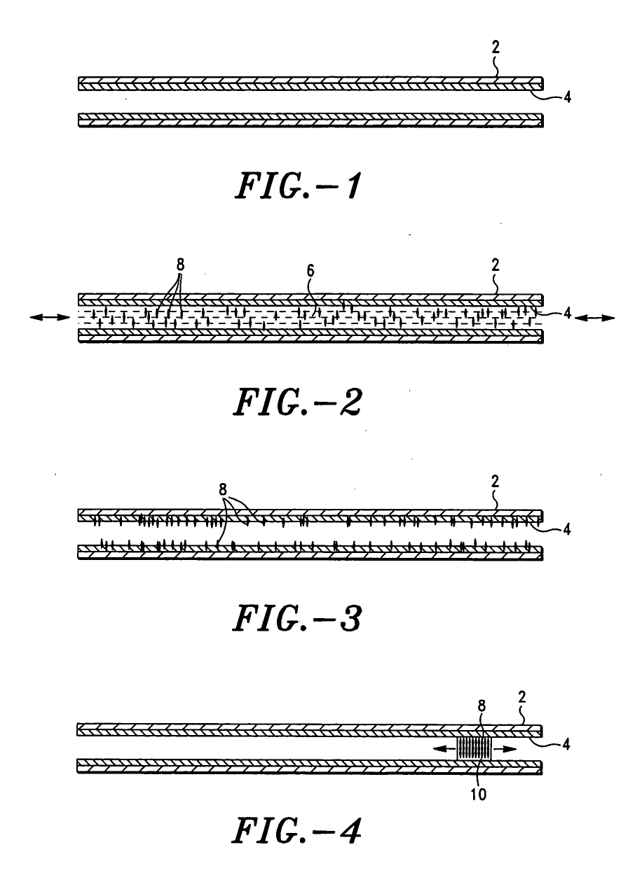

FIGS. 1-4 are schematic drawings of the operation of an open tube extraction channel of this invention. FIG. 1 shows a tubular channel 2, the inner wall surface including an extraction agent 4.

FIG. 2 shows the tubular channel of FIG. 1 as sample 6 is passed through the capillary, and the specific extraction agents 4 react with the sample 6 and extract the proteins 8 of interest from the sample, quantitatively adsorbing the desired protein or biomolecule 8 onto the chemical groups onto the capillary wall. The sample can be passed back and forth in the tube. After the sample 6 has been loaded and exposed to the surface 4, the desired protein or biomolecule 8 is quantitatively adsorbed onto the chemical groups on the capillary wall. Contaminants and irrelevant proteins that were present in the sample are washed away with a fresh wash solution (not shown).

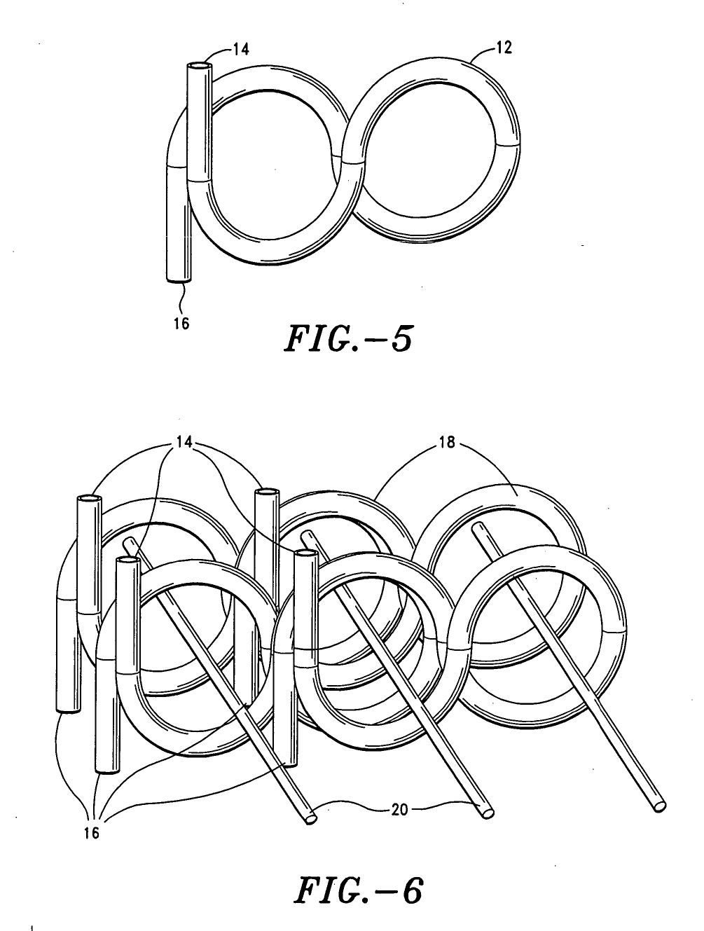

FIG. 3 shows the tubular channel of FIG. 2 after the liquid has been displaced from the capillary 2 with a gas such as air.

FIG. 4 shows the tubular channel of FIG. 3 as a segment of desorption solvent 10 is passed through the tube 2 to desorb and recover the protein or biomolecule 8.

As an alternative to the procedure shown in FIG. 4, a desorption fluid can be pumped through the capillary channel in one direction, the front boundary of the fluid desorbing and collecting the biomolecules 8 that were adsorbed to the wall 4. The protein or biomolecule 8 desorbs quickly from the wall, and the protein or biomolecule 8 will travel in the front boundary segment of the desorption solvent as the solvent travels down the tube.

The biomolecule material collected in the solvent segment 10 can be directed and deposited into or onto the target, i.e. a collection vial, a tube, a surface, or an instrument.

FIG. 5 shows a looped configuration for a capillary channel tube of this invention. The coiled capillary channel 12, shown in the form of tubing having an upper end 14 and a lower end 16, is coiled into a figure eight configuration. This configuration provides, for a selected external container volume, increased tube length, and the coiled configuration has a tortuosity which produces a controlled agitated flow. The inner surface of the open-tube element is coated with a binding agent as a selected affinity phase or other stationary phase suitable for extracting a selected molecule.

FIG. 6 is a drawing of a multiplexed group of capillary channel tubes of FIG. 5. As shown in the FIG. 5, the coiled configuration of open-tube capillary channels can be multiplexed in a housing which retains the agitated flow conditions as well as compactness. The coils 18 can be formed and held into place with pegs 20, forming an array of upper ends 14 and an array of lower ends 16. An array of mounted, parallel stationary pegs 20 can be used as winding pegs around which lengths of flexible capillary tubing are wound to form this grouping of coils. The coiled configuration is suitable for multiplexed open capillary systems which provide highly parallel processing of samples, exploiting the exceptionally small tubing dimensions.

FIG. 7 is a drawing of a multiplexed group of capillary channel tubes having the configuration shown in FIG. 6, the multiplexed group being enclosed in a housing 22. This enables indexed processing of samples in each channel tube and indexed deposition of extracted and concentrated analyte from each channel tube into or onto a target. Housing 22 supports fifteen open-tube coils of capillary tubing, the top end 14 (FIG. 17) of each tube being positioned in an array 24 in the top 26 of the housing 22. The lower end 16 of each tube is positioned in an array (not shown) in the bottom surface of the housing 22.

The deposition probe housing 28 includes a deposition probe 30 with a tip 32 that can be positioned by movement of the deposition probe housing 28 to a selected position on the target 34. The target can be a MALDI target, a protein chip such as a surface plasmon resonance (SPR) chip, or the like. The coiled configuration can be designed into integrated configurations for protein chip arraying, MALDI target spotting, and nano-collection (such as with injector arrays), for example.

The capillary channel and the method of its use are central aspects of Biomolecule Open Tubular Solid Phase Extraction (BOTSPE).

Important features of the capillary channel are diffusion distance, channel aspect ratio (CAR), channel configuration, and the extraction surface type and its physical and chemical characteristics.

The diffusion distance is the distance that a molecule must travel before it can interact with the extraction on the surface. Generally, the maximum diffusion distance is a function of the internal radius of the channel.

The channel aspect ratio is the ratio of channel length to average channel inner diameter. The channel aspect ratio of the capillary channels of this invention can be from 10 to 40,000. For optimal operation it can be from 10 to 200,000.

The extraction process depends upon migration or diffusion of the molecules to the surface of the channel. In cases where the molecules do not have enough time to diffuse to the extraction surface of the channel, the channel may be extended, the sample may be passed through the channel multiple times, or the sample may be agitated as it travels through the channel.

The cross-sectional shape of the capillary channel is not critical and can be any desired shape, for example, it can be round, oval, rectangular or another polygonal shape, or comprise combinations of shapes of an open tube.

The capillary channel can be single or bundled tubing, or it can be one or more channels in a block or chip. The channels can be straight. They can be non-linear shapes in the form of coils or other curved shapes which will promote agitated flow through the channels. The channels can be straight wall, undulating, knitted, circular, knotted, coiled, a combination of coiling and reverse coiling or filled with large bead to promote transport to the tube surface. Coiled tubes can be cut to length for a specific application single sample use, eliminating cross-contamination.

The capillary channel may be composed of a number of different materials. These include fused silica, polypropylene, polymethylmethacrylate, polystyrene, (nickel) metal capillary tubing, and carbon nanotubes. Polymeric tubes are available as straight tubing or multihole tubing (Paradigm Optics, Inc., Pullman, Wash.). Functional groups may be needed on the capillary tube surface to perform solid phase extraction. Methods to attach chemical groups to polymers are described in the following organic synthesis texts, and these texts are hereby incorporated by reference herein in their entireties, Jerry March, ADVANCED ORGANIC CHEMISTRY, 3^{rd} ed., Wiley Interscience: New York (1985); Herbert House, MODERN SYNTHETIC REACTIONS, 2^{nd} ed., Benjamin/Cummings Publishing Co., California (1972); and James Fritz, et al., ION CHROMATOGRAPHY, 3rd, ed., Wiley-VCH, New York (2002). Nickel tubing is available from Valco Instrument, Inc., Houston, Tex. Formation of carbon nanotubes has been described in a number of publications including Kenichiro Koga, et al., Nature, 412:802 (2001).

The influence of flow tortuosity on open tubular separation of proteins can be very important because of the effects of flow tortuosity on molecular diffusion in a flowing liquid.

The physical size of the target molecule will impact the performance of the device performing extractions onto the walls of open-tube solid-phase extraction devices. In the case of a small molecule (e.g. 500 Da), the diffusion constant (Dₘ) is on the order of 1.5×10⁻⁵ cm²/s. However, in the case of a protein, even a small protein on the order of 17,000 Da, the diffusion constant is roughly ten times lower—on the order of 1.3×10⁻⁶ cm²/s. The higher diffusion constant for a small molecule means that if it is dissolved in a stream flowing through a capillary under a given set of conditions, it will diffuse to and make contact with the capillary wall. On the other hand, if a protein is dissolved and is flowing through the same capillary under the exact same set of conditions, it too will eventually diffuse to and make contact with the capillary wall—but at a considerably slower rate than the small molecule. Therefore, BOTSPE of proteins will always be less efficient than small molecules unless there is some means of increasing the rate at which the proteins move to the wall.

Diffusion coefficients for molecules and proteins are shown in Table A.

TABLE A

| System | D (cm²s⁻¹) |
|---|---|
| Small molecule in water | 1-1.5 × 10⁻⁵ |
| Small protein in water (10-20 kD) | 1 × 10⁻⁶ |
| Large protein in water (100 kD) | 7 × 10⁻⁷ |

One way to facilitate movement of the larger proteins to the wall is to introduce some form of agitated flow. “Agitated flow” can be defined as those means that introduce flow components that are perpendicular to the inner wall of the capillary (as compared to flow that is parallel to the wall). One way to introduce agitation to the system is to introduce a flow path that is tortuous, i.e. the direction of flow is deliberately changed or modified so as to effectively disrupt (or agitate) an entirely linear flow pattern.

There are various means of introducing tortuosity, and one means is to “coil” or “knot” the tubing that contains the flowing stream. This strategy is often applied in the context of creating continuous-flow chemical reactors in flow injection analysis or post-column reactors in HPLC. The knotted reactors promote a high degree of “mixing” by maximizing flow of the dissolved sample zone towards and away from the tube walls (“radial flow”), while simultaneously minimizing the spread of the sample zone along the linear flow axis (“axial flow”). It is this process of maximizing the radial flow component through introduction of tortuous flow that serves to increase the rate at which the proteins are moved to the capillary wall.

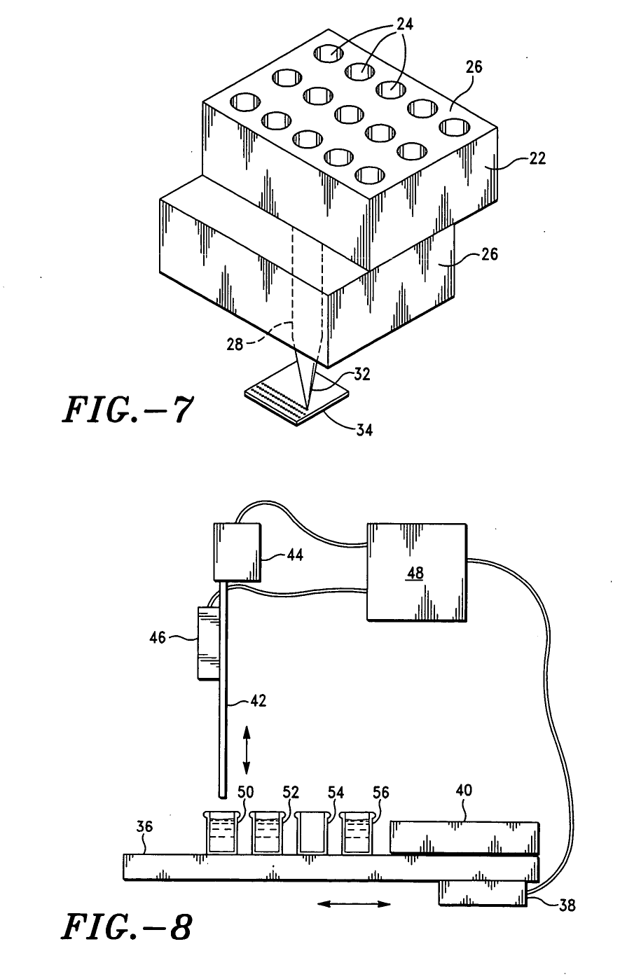

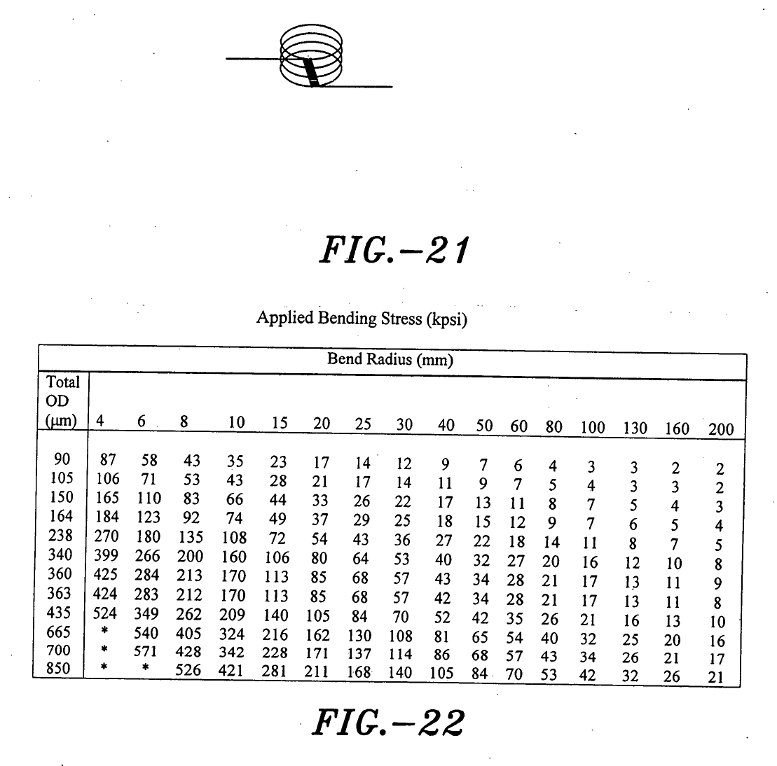

As used herein the term “coiling” is used to refer to any bending of the tubing that results in a non-linear flow path. Non-limiting examples include coiling into a simple helix (see, for example, FIG. 21), into a “figure-8” (see, for example, FIG. 8 and Example 36), or any other configuration that results in a non-linear flow path and which is compatible with the physical characteristics of the tubing. Coils can be tight or loose, need not be in any regular or symmetrical configuration, e.g., it can consist of multiple loops or bends of varying curvature radius.

The features which specify the type of extraction performed with the capillary channel devices of this invention are the inner wall characteristics and chemistry. Agitated flow is not a previously reported aspect of extraction processes and devices. Agitated flow can be introduced by use of irregular channel surfaces or by providing a tortuous path. The agitated flow can improve performance in the open channel column by improving the transport rate to and from the surface if the inner diameter of the channel is greater than about 10 μm. For very small diameters (e.g. 10-20 μm), agitation is not needed but performance is still enhanced. The configuration of a tortuous channel is described by the agitation aspect ratio (AAR). The AAR is the ratio of the effective tubing diameter divided by the effective curve diameter of the tubing central axis. The lowest possible AAR is 1 for a capillary channel, assuming the tightest curve that can be formed and thinnest possible channel wall. AARs less than 1.75 can be formed for channels with very thin channel walls. The calculation is true for a channel of any diameter. In more common configurations, the AAR can be within the range of 1.75 to 2000 and is optimal for 10 to 100.

Optionally, higher temperatures can be used to increase transport rates if they do not pose a risk of damage to the analyte. Back and forth movement of the sample can also introduce agitation into the extraction process. Back and forth flow also increases contact times.

The inner walls of the channel can be relatively smooth, rough, textured or patterned. Preferably, they are relatively non-porous. The inner surface can have irregular structure such as is described by Paul Kenis, et al., Acc. Chem. Res., 33:841 (2000) and Paul Kenis, et al., Science, 285:83 (1999). The tube can contain a monolith structure provided that it has channels for liquid passage.

The extraction chemistry is provided by functional groups on the inner wall surface. The extraction phase molecule can be a molecule bonded to the surface, or it can be a polymeric phase bonded to the surface. The polymeric phase may extend outwardly into the channel as a multi functional site molecule. Polymeric phase coatings can have a thickness less than 5 μm so that the extraction is primarily a wall interaction and not an interaction with extraction phase matrix. This makes the extraction most dependent on transport of the sample molecule to the wall and not dependent on transport of sample molecules through an extraction matrix.

The extraction agent is selected specifically for the extraction process and the analyte. The extraction processes can be affinity, reverse phase, normal phase, ion exchange, hydrophobic interaction chromatography, or hydrophilic interaction chromatography agents.

Many of the chemistries used in chromatography can be used in BOTSPE.

Affinity separations use a technique in which a biospecific adsorbent is prepared by coupling a specific ligand (such as an enzyme, antigen, or hormone) for the macromolecule of interest to a solid support. This immobilized ligand will interact selectively with molecules that can bind to it. Molecules that will not bind elute unretained. The interaction is selective and reversible. The references listed below show different types of affinity groups used for solid phase extraction and are hereby incorporated by reference herein in their entireties. Antibody Purification Handbook, Amersham Biosciences, Edition AB, 18-103746 (2002); Protein Purification Handbook, Amersham Biosciences, Edition AC, 18-1132-29 (2001); Affinity Chromatography Principles and Methods, Amersham Pharmacia Biotech, Edition AC, 18-1022-29 (2001); The Recombinant Protein Handbook, Amersham Pharmacia Biotech, Edition AB, 18-1142-75 (2002); and Protein Purification: Principles, High Resolution Methods, and Applications, Jan-Christen Janson (Editor), Lars G. Ryden (Editor), Wiley, John & Sons, Incorporated (1989).

Affinity molecules from which a suitable affinity binding agent can be selected from the agents listed in Table B, wherein the affinity agents are from one or more of the following interaction categories:

1. Chelating metal-ligand interaction

2. Protein-Protein interaction

3. Organic molecule or moiety-Protein interaction

4. Sugar-Protein interaction

5. Nucleic acid-Protein interaction

6. Nucleic acid-nucleic acid interaction

TABLE B

| Examples of Affinity | | |
|---|---|---|
| molecule or moiety fixed | | Interaction |
| at surface | Captured biomolecule | Category |
| Ni-NTA | His-tagged protein | 1 |
| Ni-NTA | His-tagged protein within | 1, 2 |
| | a multi-protein complex | |
| Fe-IDA | Phosphopeptides, | 1 |
| | phosphoproteins | |
| Fe-IDA | Phosphopeptides or | 1, 2 |
| | phosphoproteins within a | |
| | multi-protein complex | |
| Antibody or other | Protein antigen | 2 |
| Proteins | | |
| Antibody or other | Small molecule-tagged | 3 |
| Proteins | protein | |
| Antibody or other | Small molecule-tagged | 2, 3 |
| Proteins | protein within a multi- | |
| | protein complex | |
| Antibody or other | Protein antigen within a | 2 |
| Proteins | multi-protein complex | |
| Antibody or other | Epitope-tagged protein | 2 |
| Proteins | | |
| Antibody or other | Epitope-tagged protein | 2 |
| Proteins | within a multi-protein | |
| | complex | |
| Protein A, Protein G or | Antibody | 2 |
| Protein L | | |
| Protein A, Protein G or | Antibody | 2 |
| Protein L | | |
| ATP or ATP analogs; 5′- | Kinases, phosphatases | 3 |
| AMP | (proteins that requires | |
| | ATP for proper function) | |
| ATP or ATP analogs; 5′- | Kinase, phosphatases | 2, 3 |
| AMP | within multi-protein | |
| | complexes | |
| Cibacron 3G | Albumin | 3 |
| Heparin | DNA-binding protein | 4 |
| Heparin | DNA-binding proteins | 2, 4 |
| | within a multi-protein | |
| | complex | |
| Lectin | Glycopeptide or | 4 |
| | glycoprotein | |
| Lectin | Glycopeptide or | 2, 4 |
| | glycoprotein within a | |
| | multi-protein complex | |
| ssDNA or dsDNA | DNA-binding protein | 5 |
| ssDNA or dsDNA | DNA-binding protein | 2, 5 |
| | within a multi-protein | |
| | complex | |
| ssDNA | Complementary ssDNA | 6 |
| ssDNA | Complementary RNA | 6 |
| Streptavidin/Avidin | Biotinylated peptides | 3 |
| | (ICAT) | |
| Streptavidin/Avidin | Biotinylated engineered | 3 |
| | tag fused to a protein | |
| | (see avidity.com) | |
| Streptavidin/Avidin | Biotinylated protein | 3 |
| Streptavidin/Avidin | Biotinylated protein | 2, 3 |
| | within a multi-protein | |
| | complex | |
| Streptavidin/Avidin | Biotinylated engineered | 2, 3 |
| | tag fused to a protein | |
| | within a multi-protein | |
| | complex | |
| Streptavidin/Avidin | Biotinylated nucleic acid | 3 |
| Streptavidin/Avidin | Biotinylated nucleic acid | 2, 3 |
| | bound to a protein or | |
| | multi-protein complex | |
| Streptavidin/Avidin | Biotinylated nucleic acid | 3, 6 |
| | bound to a | |
| | complementary nucleic | |
| | acid | |

In reversed-phase chromatography, an aqueous/organic solvent mixture is commonly used as the mobile phase, and a high-surface-area nonpolar solid is employed as the stationary phase. The latter can be an alkyl-bonded silica packing, e.g., with C₈ or C₁₈ groups covering the silica surface. The basis of solute retention in reversed-phase chromatography is still somewhat controversial; some workers favor an adsorption, while others believe that the solute partitions into the nonpolar stationary phase. Probably both processes are important for many samples. Competition between solute and mobile-phase molecules exists for a place on the stationary-phase surface. That is, an adsorbed molecule will displace some number of previously adsorbed molecules (Chromatography, 5^{th} edition, PART A: FUNDAMENTALS AND TECHNIQUES, editor: E. Heftmann, Elsevier Science Publishing Company, New York, pp A25 (1992)). The near universal application of reversed-phase chromatography stems from the fact that virtually all organic molecules have hydrophobic regions in their structure and are capable of interacting with the stationary phase. Since the mobile phase is polar and generally contains water, the method is ideally suited to the separation of polar molecules which are either insoluble in organic solvents or bind too strongly to inorganic oxide adsorbents for normal elution. Reversed-phase chromatography employing acidic, low ionic strength eluents has become a widely established technique for the purification and structural elucidation of proteins. However, the structure of biopolymers is very sensitive to mobile phase composition, pH and the presence of complexing species which can result in anomalous retention and even denaturing of proteins. A general characteristic of reversed-phase systems is that a decrease in polarity of the mobile phase, that is increasing the volume fraction of organic solvent in an aqueous organic mobile phase, leads to a decrease in retention; a reversal of the general trends observed in liquid-solid chromatography or normal phase chromatography. It is also generally observed for reversed-phase chromatography that for members of a homologous or oligomous series, the logarithm of the solute capacity factor is a linear function of the number of methylene groups or repeat units of the oligomeric structure (ADVANCED CHROMATOGRAPHIC AND ELECTROMIGRATION METHODS IN BIOSCIENCES, editor: Z. Deyl, Elsevier Science BV, Amsterdam, The Netherlands, pp 528 (1998); CHROMATOGRAPHY TODAY, Colin F. Poole and Salwa K. Poole, and Elsevier Science Publishing Company, New York, pp 394 (1991)). The references listed below show different types of surfaces used for reverse phase separations and are hereby incorporated by reference herein in their entireties: CHROMATOGRAPHY, 5^{th} edition, Part A: Fundamentals and Techniques, editor: E. Heftmann, Elsevier Science Publishing Company, New York, pp A25 (1992); ADVANCED CHROMATOGRAPHIC AND ELECTROMIGRATION METHODS IN BIOSCIENCES, editor: Z. Deyl, Elsevier Science BV, Amsterdam, The Netherlands, pp 528 (1998); CHROMATOGRAPHY TODAY, Colin F. Poole and Salwa K. Poole, and Elsevier Science Publishing Company, New York, pp 394 (1991).

In ion-pair chromatography, the column packing is usually the same as in reversed-phase chromatography; e.g., a C₈ or C₁₈ silica. The mobile phase is likewise similar to that used in reverse phase chromatography: an aqueous/organic solvent mixture containing a buffer plus a so-called ion-pair reagent. The ion-pair reagent will be positively charged for the retention and separation of sample anions and negatively charged for the retention of sample cations. Typical examples of ion-pair reagents are hexane sulfonate and tetrabutylammonium. The basis of retention in ion-pair chromatography is still controversial, two different processes being possible: (a) adsorption of ion pairs or (b) formation of an in situ ion exchanger. Although these two processes appear somewhat different, they lead to quite similar predictions of retention as a function of experimental conditions. Retention in ion-pair chromatography can be continuously varied from a reversed-phase process to an ion-exchange process. This capability provides a number of practical advantages. For example, variation of the mobile phase composition allows a considerable control over the retention of individual sample ions. This can be used to separate particularly difficult samples, e.g., mixtures of anionic, cationic, and/or neutral molecules (CHROMATOGRAPHY, 5^{th} Edition, Part A: Fundamentals And Techniques, editor: E. Heftmann, Elsevier Science Publishing Company, New York, pp A28 (1992)).

In normal phase chromatography, the stationary phase is a high-surface-area polar adsorbent, e.g., silica or a bonded silica with polar surface groups. The mobile phase (a mixture of organic solvents) is less polar than the stationary phase. Consequently, more polar solutes are preferentially retained; there is often little difference in the retention of different homologs or a particular compound class. This has led to the use of normal phase chromatography for so-called compound-class (group-type) separations, where, e.g., alcohols are separated as a group from monoesters and other compound classes. The basis of normal phase chromatography retention is and adsorption/displacement process. Another feature of normal phase chromatography retention is the so-called localization of adsorbed solute and mobile-phase molecules on the stationary-phase surface. Localization refers to the formation of discreet bonds (by dipole/dipole or hydrogen-bonding interactions) between polar sites on the adsorbent and polar substituents in the solute molecule. Localization, in turn, confers a high degree of specificity to the interaction of solute isomers with the adsorbent surface, leading to typically better separations of isomers by normal phase chromatography than by other chromatographic methods (CHROMATOGRAPHY, 5^{th} edition, Part A: Fundamentals and Techniques, editor: E. Heftmann, Elsevier Science Publishing Company, New York, pp A27 (1992)).

The references listed below show different types of groups used for ion-pair chromatography and are hereby incorporated by reference herein in their entireties: Reference: CHROMATOGRAPHY, 5^{th} Edition, Part A: Fundamentals and Techniques, editor: E. Heftmann, Elsevier Science Publishing Company, New York, pp A28 (1992); and CHROMATOGRAPHY TODAY, Colin F. Poole and Salwa K. Poole, Elsevier Science Publishing Company, New York, pp 411 (1991).

In normal phase chromotagraphy, the stationary phase is a high-surface-area polar adsorbent, e.g., silica or a bonded silica with polar surface groups. The mobile phase (a mixture of organic solvents) is less polar than the stationary phase. Consequently, more polar solutes are preferentially retained; there is often little difference in the retention of different homologs or a particular compound class. This has led to the use of normal phase chromatography for so-called compound-class (group-type) separations, where, e.g., alcohols are separated as a group from monoesters and other compound classes. The basis of normal phase chromatography retention is an adsorption/displacement process. Another feature of normal phase chromatography retention is the so-called localization of adsorbed solute and mobile-phase molecules on the stationary-phase surface. Localization refers to the formation of discrete bonds (by dipole/dipole or hydrogen-bonding interactions) between polar sites on the adsorbent and polar substituents in the solute molecule. Localization, in turn, confers a high degree of specificity to the interaction of solute isomers with the adsorbent surface, leading to typically better separations of isomers by normal phase chromatography than by other chromatographic methods (CHROMATOGRAPHY, 5^{th} edition, Part A: Fundamentals and Techniques, editor: E. Heftmann, Elsevier Science Publishing Company, New York, pp A27 (1992)).

The references listed below show different types of affinity groups used for normal phase chromatography and are hereby incorporated by reference herein in their entireties: CHROMATOGRAPHy, 5th edition, Part A: Fundamentals and Techniques, editor: E. Heftmann, Elsevier Science Publishing Company, New York, pp A27 (1992); and CHROMATOGRAPHY TODAY, Colin F. Poole and Salwa K. Poole, Elsevier Science Publishing Company, New York, pp 375(1991).

Ion Exchange (IEX) is a mode of chromatography in which ionic substances are separated on cationic or anionic sites of the packing. The surface in ion exchange is usually an organic matrix which is substituted with ionic groups, e.g., sulfonate or trimethylammonium. The mobile phase typically consists of water plus buffer and/or salt. The retention of a solute ion occurs via ion exchange with a mobile phase ion or similar (positive or negative) charge. Ion exchange chromatography is often applied to the separation of acidic or basic samples, whose charge varies with pH. In the simple case of solute molecules bearing a single acidic or basic group, the solute will be present as some mixture of charged and neutral species. The fraction of solute molecules that are ionized then determines retention. In the case of ion exchange, the retention of the uncharged species can be ignored (CHROMATOGRAPHY, 5^{th} Edition, Part A: Fundamentals and Techniques, editor: E. Heftmann, Elsevier Science Publishing Company, New York, pp A28 (1992)). Ion exchange chromatography is one of the oldest and most traditional techniques for separating complex mixtures of proteins. The references listed below show different types of groups and surfaces used for ion exchange chromatography and are hereby incorporated by reference herein in their entireties; CHROMATOGRAPHY, 5^{th} Edition, Part A: Fundamentals and Techniques, editor: E. Heftmann, Elsevier Science Publishing Company, New York, pp A28 (1992); CHROMATOGRAPHY TODAY, Colin F. Poole and Salwa K. Poole, Elsevier Science Publishing Company, New York, pp 422 (1991); and ADVANCED CHROMATOGRAPHIC AND ELECTROMIGRATION METHODS IN BIOSCIENCES, editor: Z. Deyl, Elsevier Science BV, Amsterdam, The Netherlands, pp 540 (1998).

Hydrophobic Interaction Chromatography is widely used for the separation and purification of proteins. During separation, proteins are induced to bind to a weakly hydrophobic stationary phase using a buffered mobile phase of high ionic strength and then selectively desorbed during a decreasing salt concentration gradient. Proteins are usually separated in hydrophobic interaction chromatography according to their degree of hydrophobicity, much as in reversed-phase chromatography, but because of the gentler nature of the separation mechanism, there is a greater probability that they will elute with their conformational structure (biological activity) intact. In reversed-phase chromatography, proteins unfold on the bonded phase surface as a consequence of the high interfacial tension existing between the mobile and the bonded stationary phases. These conditions are minimized in hydrophobic interaction chromatography by using stationary phases of lower hydrophobicity together with totally aqueous mobile phases, in general, since solvent strength is controlled by varying ionic strength rather than by increasing the volume fraction of an organic modifier. Retention and selectivity in hydrophobic interaction chromatography depend substantially on the type of stationary phase. Retention increases for more hydrophobic ligands and with it the possibility of denaturing certain proteins. Some proteins are only satisfactorily handled on hydrophilic stationary phases. The ligand density and structure as well as the hydrophobicity of the stationary phase are the primary stationary phase variables that should be optimized for the separation of individual proteins. Mobile phase parameters that have to be optimized are the salt concentration, salt type, slope of the salt gradient, pH, addition of surfactant or organic modifier and temperature. In the absence of specific binding of the salt to the protein molecule and at relatively high salt concentration in the mobile phase, retention increases linearly with the salt molality and at constant salt concentration with the molal surface tension increment of the salt used in the aqueous mobile phase.

The reference listed below shows different types of groups and surfaces used for hydrophobic interactions and is hereby incorporated by reference herein in its entirety: CHROMATOGRAPHY TODAy, Colin F. Poole and Salwa K. Poole, Elsevier Science Publishing Company, New York, 402 (1991).

The following are novel surfaces for capillary channels, and their synthesis are described in the Examples presented hereinbelow:

1) Capillary channels with protein surface that has binding affinity for antibodies such as Protein G, Protein A, Protein A/G, and Protein L, for example.

a) Capillary channels with protein surface that has binding affinity for the Fc region of antibodies such as Protein G, Protein A, and Protein A/G, for example.

b) Capillary channel with protein surface that has binding affinity for Fab region of antibodies such as Protein L.

2) Capillary channels that has metal chelate surfaces (excluding Zinc IDA)

a) Metal NTA (nitrilotriacetate) chelate

i) Nickel NTA

ii) Copper NTA

iii) Iron NTA

iv) Cobalt NTA

v) Zinc NTA

b) Metal IDA (iminodiacetate) chelate (excluding Zinc IDA)

i) Nickel IDA

ii) Copper IDA

iii) Iron IDA

iv) Cobalt IDA

c) Metal CMA (carboxymethylated aspartate) chelate

i) Nickel CMA

ii) Copper CMA

vi) Iron CMA

vii) Cobalt CMA

viii) Zinc CMA

d) Metal chelate surface having affinity for poly-His groups on proteins (excluding Zinc IDA).

e) Metal chelate surfaces having affinity for phosphate groups on proteins.

3) Capillary channel that has glutathione surfaces

4) Capillary channel that has nucleotide (or its analog) surface a) ATP

5) Capillary channel that has a lectin surface

6) Capillary channel that has a heparin surface

7) Capillary channel that has an avidin surface

a) Monomeric

b) Multimeric

The channel can function as both the extraction device and the transport device. The extraction channel can be moved to pick up sample, pick up and discharge wash solvent, and then deposit sample on or in the target. This involves movement of the (nano-scale) extraction device to the sample and detector in contrast to devices which are permanently connected to the detector that move the sample to the device.

The sample can be drawn into the channel or pumped through the channel. The sample may be moved back and forth in the channel as many times as is necessary to achieve the desired desorption. Small particulates and air bubbles have no effect on performance, a remarkable distinction from previous solid phase extraction systems.

The washed solution and desorption solvent also can be introduced from either end and may be moved back and forth in the channel.

In general, the methods of this invention for biomolecule open tubular solid phase extraction with an open channel device for biomolecules having an affinity extraction surface comprise the following steps. A sample solution containing a biomolecule for which the extraction surface has affinity is passed through the capillary channel at a rate which effects binding of a substantial amount of the biomolecules to the extraction surface. Then a desorption solution is passed through the capillary channel at a rate and time which effects elution of a substantial amount of the biomolecules into the eluant.

The procedure can be expanded to improve performance to include additional steps. The procedure can include steps of cleaning and conditioning the open channel column surface by cleaning with an extraction solvent and a desorption solvent.

During the extraction, the sample can contain small particulates or air. Air segments can be optionally introduced or allowed to be present with the sample to introduce agitated flow including turbulence. The channel can be configured to introduce agitated flow. The sample can be introduced into open tube column from either end. The sample can be passed back and forth in the channel to enhance contact with extraction phase, or the movement of the sample can be paused for samples with slow adsorption kinetics. After extraction, the residual liquid can be expelled from the tube with a gas such as air to minimize the wash step.

The wash solution containing air can also be introduced, air segments can be introduced, and the wash solution can be moved back and forth in the channel to improve the washing. After the wash, the residual washing liquid can be expelled from the tube with a gas such as air to facilitate the desorption step.

In preferred embodiments of the invention, a sufficient amount of gas is passed through the capillary prior to the desorption step to substantially displace any liquid present in the channel prior to the desorption step, and/or prior to the wash step. In some cases the direction of flow of gas through the capillary can be reversed during this process to more effectively remove the liquid. More effective removal of the liquid can in some cases also be achieved by blowing gas through the capillary for a longer period of time.

In general, a slug of desorbing solvent can be introduced from either end of the channel to enhance concentration of sample into a small volume. The slug can be moved back and forth over the extraction phase to enhance desorption.

The open channel and a deposition tube to the deposition target can be a continuous channel to facilitate deposition of the desorbed analyte. In this configuration, desorption can be introduced into the open end of the open channel and travel through the open channel to the target; the desorption solvent having a moving front, the initial segment of which desorbs the analyte. Continuing this flow through the deposition tube to the target presents the desorbed analyte in a highly concentrated form to the target. If the target is a chip, the extraction can be performed as part of the arraying process. If the analytical instrument takes samples directly for analysis, the desorbed material can be introduced into the sample inlet of the interface of the instrument.

Desorption solvent can be introduced as either a stream or a plug of solvent. If a plug of solvent is used, a buffer plug of solvent can follow the desorption plug so that when the sample is deposited on the target, a buffer is also deposited to give the deposited sample a proper pH. An example of this is desorption from a protein G surface of IgG antibody which has been extracted from a hybridoma solution. A 10 mM phosphoric acid plug at pH 2.5 is used to desorb the IgG from the tube. A 100 mM phosphate buffer plug at pH 7.5 follows the desorption solvent plug to bring the deposited solution to neutral pH. The deposited material can then be deposited on an SPR chip.

Three solvents are used in BOTSPE, the loading solvent, the rinse solvent and the desorption solvent. The loading solvent is generally the same solvent that is used to extract or dissolve the analyte. It should be sufficiently weak to ensure quantitative sorption of the analyte on the SPE capillary channel.

A rinse solvent is optional. When used, it washes weakly retained contaminants or materials interfering with the process from the channel while leaving the analyte behind. It should be stronger than the loading solvent, but not so strong that it desorbs the analyte.

The desorption solvent should be just strong enough to quantitatively desorb the analyte while leaving strongly bound interfering materials behind. The solvents are chosen to be compatible with the analyte and final detection. The solvents are known conventional solvents. Typical solvents from which a suitable solvent can be selected include methylene chloride, acetonitrile (with or without small amounts of basic or acidic modifiers), methanol (containing larger amount of modifier, e.g. acetic acid or triethylamine, or mixtures of water with either methanol or acetonitrile), ethyl acetate, chloroform, hexane, isopropanol, acetone, alkaline buffer, high ionic strength buffer, acidic buffer, strong acids, strong bases, organic mixtures with acids/bases, acidic or basic methanol, tetrahydrofuran and water. The desorption solvent may be different miscibility than the sorption solvent.

Examples of suitable phases for solid phase extraction and desorption solvents are shown in Table C.

TABLE C

| Desorption | | | |
|---|---|---|---|
| Solvent | Normal Phase | Reverse Phase | Reverse Phase |
| Features | Extraction | Extraction | Ion-Pair Extraction |
| Typical solvent | Low to medium | High to medium | High to medium |
| polarity range | | | |
| Typical sample | Hexane, toluene, | H₂O, buffers | H₂O, buffers, ion- |
| loading solvent | CH₂Cl₂ | | pairing reagent |
| Typical | Ethyl acetate, | H₂O/CH₃OH, | H₂O/CH₃OH, ion- |
| desorption | acetone, CH₃CN | H₂O/CH₃CN | pairing reagent |
| solvent | (Acetone, | (Methanol, | H₂O/CH₃CN, ion- |
| | acetonitrile, | chloroform, | pairing reagent |
| | isopropanol, | acidic methanol, | (Methanol, |
| | methanol, water, | basic methanol, | chloroform, acidic |
| | buffers) | tetrahydrofuran, | methanol, basic |
| | | acetonitrile, | methanol, |
| | | acetone, ethyl | tetrahydrofuran, |
| | | acetate,) | acetonitrile, |
| | | | acetone, ethyl |
| | | | acetate) |
| Sample elution | Least polar | Most polar | Most polar sample |
| selectivity | sample | sample | components first |
| | components first | components first | |
| Solvent change | Increase solvent | Decrease solvent | Decrease solvent |
| required to | polarity | polarity | polarity |
| desorb | | | |
| Desorption | | | |
| Solvent | | Hydrophobic Interaction | |
| Features | Ion Exchange Extraction | Extraction | |
| Typical solvent | High | High | |
| polarity range | | | |
| Typical sample | H₂O, buffers | H₂O, high salt | |
| loading solvent | | | |
| Typical | Buffers, salt solutions | H₂O, low salt | |
| desorption | | | |
| solvent | | | |
| Sample elution | Sample components most | Sample components most | |
| selectivity | weakly ionized first | polar first | |
| Solvent change | Increase ionic strength or | Decrease ionic strength | |
| required to | increase retained | | |
| desorb | compounds pH or | | |
| | decrease pH | | |

FIG. 8 is a schematic drawing of a moveable platform system of this invention with the sample, process solutions and gas in vials, and a target supported on the platform. In this embodiment, a platform 36 is connected to a conventional x and y-axis control system 38 for movement in the horizontal plane (x and y-axis movement) and supports the deposition target 40 and a plurality of vials. The extraction channel 42 is an open tubular device for biomolecule open tubular solid phase extraction. The inner surface of the extraction channel 42 has a binding property. For example, it can be coated with an extraction agent such as an affinity binding agent.

Pump 44, communicating with the extraction channel 42, moves fluids through the extraction channel. In this embodiment, the extraction channel 42 and pump 44 are supported by a conventional z-axis movement controller 46 for vertical movement (z-axis movement). The computer controller 48 is connected to the pump 44, the x and y-axis platform controller 38 and the z-axis pump and extraction tube controller 46. The vials 50, 52, 54 and 56 supported on the platform 36 can be the same or different containers. For example, vial 50 can be a conditioning liquid vial, vial 52 can be a liquid sample vial, vial 54 can be an empty vial containing air, and vial 56 can be a desorption liquid vial.

The pump 44 and the pumps in the other embodiments described in this application can be a syringe pump, electro-osmotic flow pump, an induction based fluidics (IBF) pump of the type described in U.S. Pat. No. 6,149,815, or other device capable of precisely metering small volume flow.

The general operation of this system for open tubular solid phase extraction in conjunction with a tubular extraction channel surface having an affinity binding property can involve the following sequence of steps:

1) As an optional first step, the extraction channel 42 can be lowered into the conditioning fluid vial 50 by the controller 46, and conditioning liquid can be drawn up the extraction channel tube 42 from conditioning liquid vial 50 by the pump 44.

2) The extraction tube 42 and pump are then raised by the controller 46, the platform 36 is moved to place the empty vial or a waste receptor (not shown) under the extraction tube, the extraction tube 42 and pump are lowered by the controller 46, the conditioning liquid is discharged into the empty vial 54 or waste receptor.

3) The platform 36 is moved to place the sample vial under the extraction channel tube 42, the end of the extraction tube 42 and pump are then lowered by the controller 46, and sample is drawn into the extraction channel tube 42. This is done at a rate which effects binding of a substantial amount of the biomolecules to the extraction surface.

4) The extraction tube 42 and pump are then raised by the controller 46, the platform 36 is moved to place the empty vial or a waste receptor (not shown) under the extraction tube, the extraction tube 42 and pump are lowered by the controller 46, and the residual liquid is discharged into the empty vial 54 or waste receptor.

5) The conditioning liquid vial 50 is moved by the platform 36 under the extraction channel 42, and the extraction channel 42 is lowered into the conditioning fluid vial 50 by the controller 46, and conditioning liquid is drawn up the extraction channel tube 42 from conditioning liquid vial 50 by the pump 44.

6) The extraction tube 42 and pump are then raised by the controller 46, the platform 36 is moved to place the empty vial or a waste receptor (not shown) under the extraction tube, the extraction tube 42 and pump are lowered by the controller 46, and the residual liquid is discharged into the empty vial 54 or waste receptor.

7) The extraction tube 42 and pump are then raised by the controller 46, the desorption liquid vial 56 is moved by the platform 36 under the extraction channel 42, and the extraction channel 42 is lowered into the desorption fluid vial 56 by the controller 46.

8) Desorption liquid is drawn up the extraction channel tube 42 from conditioning liquid vial 50 by the pump 44 at a rate and for a time which effects desorption of a substantial amount of the biomolecules into the desorption liquid. How this is done is very important and will be amplified in detail hereinafter.

9) The extraction tube 42 and pump are then raised by the controller 46, the deposition target is moved by the platform 36 under the extraction channel 42, and the extraction channel 42 is lowered to contact its end with a surface of the deposition target to deposit extracted analyte on the surface.

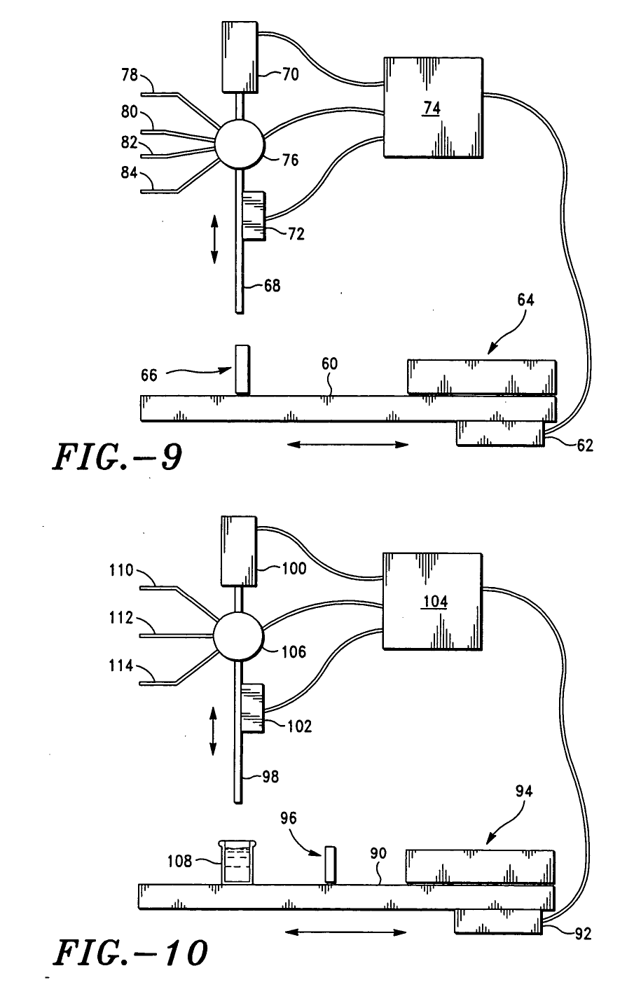

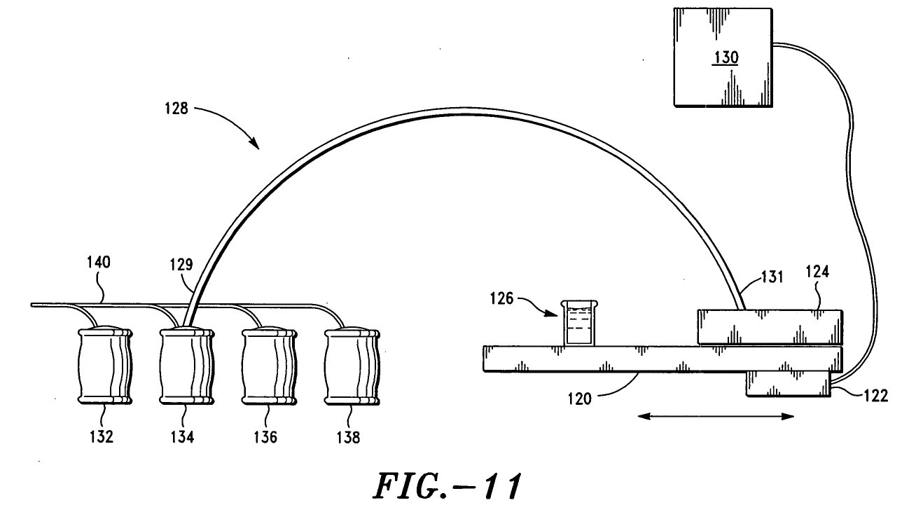

FIG. 9 is a schematic drawing of a moveable platform system of this invention wherein the sample, conditioning/wash liquid, desorption liquid, and gas are provided through a valve system and both an electrospray interface and a target are supported on the platform. In this embodiment, a platform 60 is connected to a conventional x and y-axis control system 62 for movement in the horizontal plane (x and y-axis movement) and supports the deposition target 64 and an electrospray interface 66 of a mass spectrometer (not shown). The extraction channel 68 is an open tubular device for biomolecule open tubular solid phase extraction. The inner surface of the extraction channel 68 has a binding property such as is imparted by affinity binding agent or other extraction agent.

Pump 70, communicating with the extraction channel 68, moves fluids through the extraction channel as will be explained in detail hereinafter. In this embodiment, the extraction channel 68 and pump 70 are supported by a conventional z-axis movement controller 72 for vertical movement (z-axis movement). The computer controller 74 is connected to the pump 70, the x- and y-axis platform controller 62, the z-axis controller 72 and the valve 76.

The valve 76 communicates with the extraction channel 68 and with supply tubes for conditioning/washing liquid 78, liquid sample 80, gas (which can be air) 82 and desorption liquid 84.

With the system shown in FIG. 9, the general operation of this system for open tubular solid phase extraction in conjunction with a tubular extraction channel surface having an affinity binding property can involve the following sequence of steps:

1) As an optional first step, the valve 76 is positioned to pass conditioning liquid from conduit 78 into the extraction tube 68 and is discharged to waste.

2) Then sample liquid is introduced into the extraction channel 68 from sample line 80 by valve 76 to extract analyte.

3) Then gas is introduced into the extraction channel 68 from gas line 82, displacing the sample liquid into waste.

4) Then desorption liquid is introduced into the extraction channel 68 from desorption liquid supply line 84 by way of valve 76 to desorb the analyte.

5) Finally, desorption liquid containing analyte is discharged by pump 70 into the electrospray interface 66. Alternatively, the platform 60 can be moved by x and y-axis platform controller 92 to position a target 64 such as a protein chip under the extraction tube, and desorption liquid containing analyte is discharged by pump 100 from the end of the extraction tube into the target.

FIG. 10 is a schematic drawing of a moveable platform system of this invention wherein the conditioning/wash liquid, desorption liquid, and gas are provided through a valve system, and the sample, electrospray interface and a deposition target are supported on the platform. In this embodiment, a platform 90 is connected to a conventional x and y-axis control system 92 for movement in the horizontal plane (x and y-axis movement) and supports the deposition target 94, electrospray interface 96 of a mass spectrometer (not shown), and sample vial 108. The extraction channel 98 is an open tubular device for biomolecule open tubular solid phase extraction. The inner surface of the extraction channel 98 has a binding property such as is imparted by affinity binding agent or other extraction agent.

Pump 100, communicating with the extraction channel 98, moves fluids through the extraction channel as will be explained in detail hereinafter. In this embodiment, the extraction channel 98 and pump 100 are supported by a conventional z-axis movement controller 102 for vertical movement (z-axis movement). The computer controller 104 is connected to the pump 100, the x and y-axis platform controller 92, the z-axis controller 102, and the valve 106.

The valve 106 communicates with the extraction channel 98 and with supply tubes for conditioning/washing liquid 110, gas (which can be air) 112 and desorption liquid 114.

With the system shown in FIG. 10, the general operation of this system for open tubular solid phase extraction in conjunction with a tubular extraction channel surface having an affinity binding property can involve the following sequence of steps:

1) As an optional first step, the valve 106 is positioned to pass conditioning liquid from conduit 110 into the extraction tube 98 and is discharged to waste.

2) Then sample liquid is introduced into the extraction channel 98 from sample vial 108 by pump 100, with valve 106 positioned to open communication between the pump and the extraction tube 98, to extract analyte from the sample.

3) Then gas can optionally be introduced into the extraction channel 98 from gas line 112, displacing the depleted sample liquid into waste.

4) Then desorption liquid is introduced into the extraction channel 98 from desorption liquid supply line 114 by way of valve 106 to desorb the analyte.

5) Finally, desorption liquid containing analyte is discharged by pump 100 into the electrospray interface 96. Alternatively, the platform 90 can be moved to position a target 94 such as a protein chip under the extraction tube 98, and desorption liquid containing analyte is discharged by pump 70 from the end of the extraction tube into the target 94.

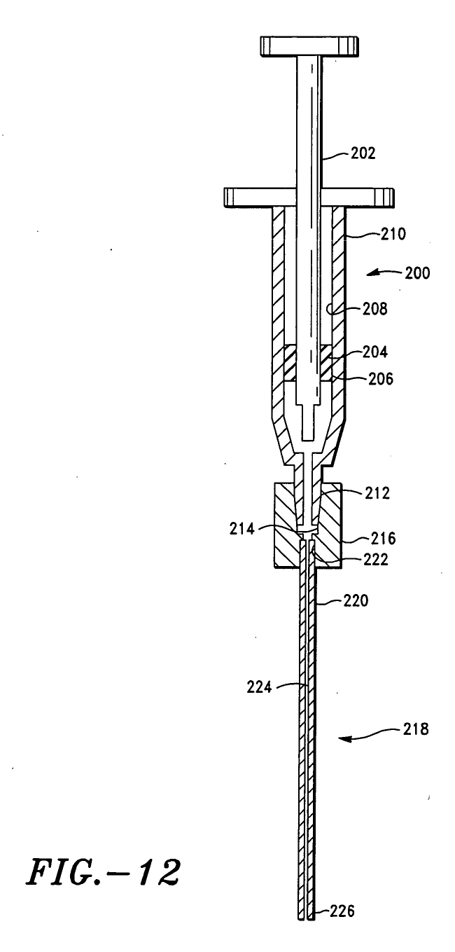

FIG. 11 is a schematic drawing wherein conditioning/wash liquid, desorption liquid, and gas are provided in pressurized containers; waste and a target are supported on a moveable platform, and both ends of the extraction channel are movable. In this embodiment, a platform 120 is connected to a conventional x and y-axis control system 122 for movement in the horizontal plane (x and y-axis movement) and supports the deposition target 124 and waste receptacle 126. The extraction channel 128 is an open tubular device for biomolecule open tubular solid phase extraction which is moveable at both inlet end 129 and the outlet end 131. The inner surface of the extraction channel 128 has a binding property such as is imparted by affinity binding agent or other extraction agent. Conditioning/wash liquid vial 132, sample vial 134, gas vial 136 and desorption liquid vial 138 are connected to a gas pressure line 140 to pressurize the vials.

With the system shown in FIG. 11, the general operation of this system for open tubular solid phase extraction in conjunction with a tubular extraction channel surface having an affinity binding property can involve the following sequence of steps:

1) As an optional first step, the inlet end 129 of extraction tube 128 is placed in pressurized conditioning liquid vial 132 and the outlet end 131 is placed in the waste vial 126, to pass conditioning liquid through the extraction tube.

2) Then the inlet end 129 is placed in the pressurized sample vial 134 and the outlet end 131 is placed in the waste receptacle 126 to introduce sample liquid into the extraction tube 128 to extract analyte therefrom.

3) Then inlet end 129 is placed in the pressurized gas vial 136 and the outlet end 131 is placed in the waste receptacle 126 to displace expended sample liquid from the extraction tube 128 into waste receptacle 126.

4) Then inlet end 129 is placed in pressurized desorption liquid vial 138 and the outlet end 131 is placed in the deposition zone of the target 124. The positioning of the deposition zone of the target is controlled by computer controller 130. This step passes desorption liquid through the extraction tube, desorbing analyte into the leading segment of the desorption liquid, and depositing the leading segment in the deposition zone.

FIG. 12 is a single syringe capillary embodiment of this invention. The syringe 200 has a conventional plunger 202 with an annular piston ring 204, the outer surface 206 of which forms a sealing engagement the inner wall 208 of the syringe barrel 210. This is typically 1-100 μl volume, may be controlled with a computer or manually. If a single syringe is used, the syringe volume is a compromise of the volume of the sample processed and the volume of the elution solvent. Many times a separate syringe is used to process the sample (to keep the volume large enough) and to process the elution (to keep the volume small). This is typically a luer adapter that connects the extraction tube to the syringe pump. If a disposable syringe is not used, a disposable chamber such as a pipette tip or plastic device may be used to connect the extraction tube to the syringe pump. The end of the syringe has a tapered connector 212 which engages with a corresponding receptor 214 of the capillary fitting 216.

Capillary 218 can metal, glass, fused silica, or plastic tube with extraction phase. In this straight configuration, it is typically 1-10 cm long and 0.1-100 μl volume. The outer surface 220 of the upper end of the capillary 218 is bonded to the inner surface 222 of the capillary fitting 220. The inner wall surface 224 of the capillary 220 can have an extraction agent coating as described with respect to FIG. 1. The capillary 218 has a lower end 226 which is placed in contact with a liquid sample containing analyte to be extracted.

Upward movement of the plunger 202 draws liquid (not shown) into the capillary 218 through its end 226, downward movement of the plunger 202 moves liquid toward or through the end 226, and small reciprocating movements of the plunger 202 can be used to move a slug of liquid up and down the capillary 218 to increase interaction of analyte in the liquid with the capillary walls 224 and the extraction agent bound thereto as is described in detail with regard to FIGS. 1-4.

The device, apparatus and method of this invention can be used to prepare materials for protein chips, surfaces which are spotted with proteins or other biomolecules for analysis.

Protein chips dynamics can be represented by the following equation:

A+B=AB

AB is capable of generating an analytical signal, where A is the chip-bound moiety and B is its cognate binder introduced to the chip. An assumption of specific interactions is always assumed. Binding events other than “AB” can have the appearance of AB, the variance being caused by non-A (i.e. contaminating) moieties having some affinity for B, non-B (i.e. contaminating) moieties having some affinity for A, or a combinations of the two; any of these events will have the appearance of a true AB event. This characteristic will define the success or failure of a particular protein chip experiment, and is the most trivialized or ignored aspects of the technology.

For some non-protein chips (specifically DNA chips), the A groups do not require purification or enrichment since they are synthesized in place, or are amplified via PCR and spotted. With the exception of very short peptides, the structural complexity of proteins will not allow for on-chip synthesis of A. Therefore, preparation of A materials for use within protein chips will place a premium on the purity of the material. In addition, the A materials will often need to be highly enriched so as to provide maximum opportunity for AB to occur.

Protein chips are characterized by having small volumes of “A” applied to the surface. The volumes are often on the order of 10 nL or less for each spot. Since many proteins are difficult and/or expensive to prepare, the ability to purify and enrich at scales on par with the spots would significantly reduce waste. It would also allow for “just-in-time” purification, so that the chip is prepared just as the protein is being purified.

Different materials are brought to the chip as A, and each material require purification and/or enrichment. Examples of these materials are antibodies (i.e. IgG, IgY, etc) as affinity molecules, general affinity proteins (i.e. scFvs, Fabs, affibodies, peptides, etc) as affinity molecules, other proteins that are being screened for general affinity characteristics, and nucleic acids/(photo)aptamers as affinity molecules, for example.

Different means of attaching A to chip surfaces, and each will require purification and enrichment procedures that are compatible with the attachment chemistry. Examples of attachment chemistry include direct/passive immobilization to protein chip substrates, and these can become covalent in cases of native thiols associating with gold surfaces, as one example. Covalent attachment is another method of attachment of functional groups at chip surface, and these can be self-assembled monolayers with and without additional groups, immobilized hydrogel, and the like. Non-covalent/affinity attachment to functional groups/ligands at chip surface is another method of attachment; examples of this method are ProA or ProG for IgGs, phenyl(di)boronic acid with salicylhydroxamic acid groups; streptavidin monolayers with biotinylation of native lysines/cysteines, and the like.

The samples or analyte to be brought to the chip can be varied in composition and mode of interaction with A.

There is more than one way to achieve specific AB interactions through the manipulation of B. One means is to remove potentially interfering non-B contaminants by their specific removal, provided these contaminants are sufficiently well-defined such as albumin, fibrin, etc.

Another means is the removal of non-B contaminants by trapping B (either individually or as a class), removing contaminants by washing, and releasing B. This simultaneously allows for enrichment of B, thus enhancing the sensitivity for the AB event.

Just as the scale of the chip is very small, there are opportunities to make the scale of the sample small—therefore allowing for analysis of very small samples. Since samples are precious materials, the scale of purification and enrichment would allow for this to occur. As with chip preparation, this can occur in a “just-in-time” manner.

The detection event requires some manner of A interacting with B, so the central player in the detection event (since it isn't part of the protein chip itself) is B. The means of detecting the presence of B (or, B-like substances described above) are varied and can include label-free detection of B (or B-like substances) interacting with A such as surface plasmon resonance imaging as practiced by HTS Biosystems—grating-coupled SPR or BiaCore—prism or Kretschmann-based SPR, or Micro-cantilever detection schemes as practiced by Protiveris.

The detection means can include physical labeling of B (or B-like substances) interacting with A, followed by spatial imaging of AB pair (i.e. Cy3/Cy5 differential labeling with standard fluorescent imaging as practiced by BD Biosciences Clontech, radioactive ATP labeling of kinase substrates with autoradiography imaging as practiced by Jerini or other suitable imaging techniques. In the case of fluorescent tagging, one can achieve higher sensitivity with fluorescent waveguide imaging as practiced by ZeptoSens.

The detection means can also include interaction of AB complex with a third B-specific affinity partner C, where C is capable of generating a signal by being fluorescently tagged, or is tagged with a group that allows a chemical reaction to occur at that location (such as generation of a fluorescent moiety, direct generation of light, etc). Detection of this AB-C binding event can occur via fluorescent imaging as practiced by Zyomyx and SomaLogic, chemilumine-scence imaging as practiced by HTS Biosystems and Hypromatrix, fluorescent imaging via waveguide technology, or other suitable detection means.

Arrayers are instruments for spotting nucleic acids, proteins or other reagent onto chips that are used for molecular biology research or diagnostic work. The arrayers can be used both in the manufacture of the chips and in the use of the chip. In manufacturing, an arrayer can be used to transport the chemical reactants to specific spots on the chip. This may be a multistep process as the chemical complex used for detection is built at each particular spot in the array.

Each process can require sample preparation. In some cases, DNA is purified and deposited to a surface on a chip. Then samples containing complementary DNA or RNA are reacted with the chip. Before the samples can be reacted, the nucleic acid is purified away from the other materials (proteins, particulate, carbohydrates, etc.) found in the samples. In other cases, protein chips may be manufactured by depositing specific proteins in an array. Then samples containing proteins can be reacted with various array sites to measure protein/protein interactions.

Current sample preparation technology relies on conventional technology, e.g. precipitation, column extraction, centrifugation, etc. finally depositing the purified materials or samples into a vial or plate of vials. The purified materials contained in vials are taken up by the spotters and deposited onto the array. In this invention, the end of the open tube column that is used for the sample preparation is in direct contact with the spotter tip used to spot materials on the array. The technology used to take up and dispense liquids in the open tube columns can be similar to that used for capillary electrophoresis instruments where very small amounts of sample are taken up and dispensed into the capillary. This can also be done in 96 and 384 capillary arrays as are the capillary units used for DNA sequencing. Related techniques are described in Andre Marziali, et al., Annu. Rev. Biomet. Eng., 3:195 (2001), the entire contents of which are hereby incorporated by reference. In some cases, the end of open tube column used for solid phase extraction can be the spotter itself. Related techniques are described in MICROARRAY BIOCHIP TECHNOLOGY, Chapter 2: Microfluidic Technologies and Instrumentation for Printing DNA Microarrays, Mark Schena (Editor), Telechem International, Eaton Publishing, ISBN1-881299-37-6 (2000), the entire contents of which are hereby incorporated by reference.

In application of mass spectrometry for the analysis of biomolecules, the molecules must be transferred from the liquid or solid phases to gas phase and to vacuum phase. Since most biomolecules are both large and fragile, the most effective methods for their transfer to the vacuum phase are matrix-assisted laser desorption ionization (MALDI) or electrospray ionization (ESI).

Mass spectrometry provides essentially two methods for analyzing proteins: bottom up and top down analysis. In bottom up analysis, the protein is manipulated and broken up in a controlled manner (usually through an enzymatic digestion process), analyzed, and then reassembled using the data from the various parts. Top down analysis works with the whole protein, optionally using an ion source to break apart the protein and determine the identity of the protein.

While both methods may require long mass spectrometer analysis times, top down approaches usually require the longest time. Under ideal cases, a static sample is measured and parameters on the manner in which the source is directed or implemented. The method in which the data are analyzed are varied to perform a full analysis of the protein.

Many sample introduction methods introduce samples “on-the-fly.” The sample is introduced from an HPLC column as continuous flow into the nozzle of the electrospray ionization (ESI) source. In order to introduce samples so that top down analysis can be implemented, the flow of the sample may be slowed. The method is called peak parking. In this way, the sample residence time can be increased by a factor of 10 or greater increasing the sensitivity of the analysis by a factor of 8 or greater. However, this method is still inflexible and inadequate because the analysis must still be performed quickly—often more quickly than the instrument is capable of performing.

This is also true for introduction of samples from a solid phase extraction device. One may introduce the entire sample before the analysis is completed. It is much better to introduce a discrete uniform sample into the mass spectrometer. In this way, the mass spectrometry method and procedure can be adapted to the sample in the best manner.

This can be accomplished by using an apparatus where the desorbed material from an open tube extraction device is deposited directly into an electrospray nozzle.

MALDI is commonly interfaced to time of flight (TOF) mass spectrometers (MALDI-TOF) and ESI is interfaced to quadrupole, ion trap and TOF mass analyzers. Both MALDI and ESI approaches are useful for determining the full masses of proteins and peptides in mixtures, before and after purification and to induce fragmentation of peptides for ms/ms analysis. Modern mass spectrometry is accurate enough to be useful for evaluating the correct translation or chemical synthesis of biomolecules. Any deviation of the observed mass of the sample from its calculated mass indicates incorrect synthesis or the presence of post-translational or chemical modifications. Biomolecules can be purposely fragmented in the mass spectrometer and the masses of the resulting fragments can be accurately determined. The patterns of such fragment masses are useful for ms/ms sequencing of the peptides and their identification in the data banks.

Electrospray is performed by mixing the sample with volatile acid and organic solvent and infusing it through a conductive needle charged with high voltage. The charged droplets that are sprayed (or ejected) from the needle end, are directed into the mass spectrometer, and are dried up by heat and vacuum as they fly in. After the drops dry, the remaining charged molecules are directed by electromagnetic lenses into the mass detector and mass analyzed. Electrospray mass spectrometry can be used to determine the masses of different molecules, from small peptides to intact large proteins. Even though the mass-range of the currently available instruments is only 2000 to 10000 mass unit, most proteins become multi-charged during the electrospray step and since the instrument measures the mass to charge ratio (m/z) of the molecules, most proteins are sufficiently charged to have an m/z that is within the mass range. To calculate the full mass of the protein from the different m/z measured, a deconvolution is performed, returning the full mass of the proteins.

For MALDI-TOF the proteins are deposited on metal targets, as co-crystallized with an organic matrix. The samples are dried and inserted into the mass spectrometer. After vacuum is established, the matrix crystals absorb the light energy from short flashes of a high-energy laser. The matrix rapidly sublimes, carrying with it the biomolecule into the vacuum phase. The sample and matrix plume enter a strong electromagnetic field that accelerate the charged molecules into a free flight zone where they fly until they hit a detector located at its far end. The mass of the protein can be calculated from its flight time. Accurate determination of the masses is obtained by the flight time to that of a standard of known mass. The flight time is proportional to the log of mass of the protein and the larger proteins fly slower and reach the detector later.

In the use of capillary channels to purify recombinant proteins, recombinant proteins will commonly possess a fusion tag that will allow for affinity-based separation of the expressed protein from its matrix. There are a wide variety of fusion tags, which will thus dictate that a number of different surface functionalities are available.

One of the most common fusion tags is the so-called “6-His” tag, which is comprised of six consecutive histidine residues. There are a number of metal-chelate groups that can be used at the capillary surface, including metal-IDA, metal-NTA, and metal-CMA (CMA: carboxymethylated aspartate). The trapped fusion protein is eluted by disrupting the histidine-metal coordination by some suitable salt such as imidazole or ethylene diamine tetra acetic acid (EDTA).

There are other means available for purifying recombinant proteins through their fusion tags. Antibodies can be used for purification through any peptide sequence (a common one is the FLAG tag); avidin (monomeric or multimeric) can be used for purifying a peptide sequence that is selectively biotinylated within the expression system; calmodulin charged with calcium can be used for purifying a peptide sequence that is often referred to as a “calmodulin binding peptide” (or, CBP), where elution is performed by removing the calcium with ethylene glycol tetra acetic acid (EGTA); glutathione can be used for purifying a fusion protein that carries the glutathione S-transferase protein (GST), where the GST is often cleaved off with a specific protease; amylose can be used for purifying a fusion protein that carries the maltose binding protein (MBP), where the MBP is often cleaved off with a specific protease; cellulose can be used for purifying a fusion protein that carries a peptide that is referred to as the cellulose-binding domain tag, followed by elution with ethylene glycol; S-protein (derived from ribonuclease A) can be used for purifying a fusion protein that carries a peptide with specific affinity for S-protein, where the peptide can be cleaved off with a specific protease.

It is also possible to create an affinity surface that has the bis-arsenical fluorescein dye FlAsH. For example, a FlAsH dye can be used for purifying a fusion protein that carries the peptide sequence tag CCxxCC (where xx is any amino acid, such as RE). The protein is then eluted with 1,4-dithiothreitol, or DTT.

Capillary channels can be used for purification of antibodies. Antibodies are frequently purified on the basis of highly conserved structural characteristics. For example, it is possible to create surfaces of Protein A, Protein G, or Protein A/G fusions to purify IgG antibodies through their Fc region (with lower affinity for the Fab antibody fragment region in the case of Protein G). These are often eluted by using low pH 2.5. It is also possible to purify IgG antibodies through their Fab antibody fragment region, provided their light chain is a kappa light chain. This is achieved by using a surface of Protein L.

There are also small molecule ligands that are capable of achieving separations on the basis of hydrophobic charge interactions. Ligands such as 4-mercapto-ethyl-pyridine and 2-mercaptopyridine are capable of trapping antibodies such as IgGs, which are eluted by changes to low pH much milder than in the case of Protein A or Protein G. For example, elution is accomplished with 4-mercapto-ethyl-pyridine at pH 4 (as opposed to pH 2.5 for the Protein A and Protein G).

In addition, other antibodies can be used for purification of antibodies. For example, it is possible to use an immobilized antibody on the surface of the capillary for the purification of IgE (with an anti-IgE surface), the purification of IgM (with an anti-IgM surface), the purification of IgA (with an anti-IgA surface), the purification of IgD (with an anti-IgD surface), as well as the purification of IgG (with an anti-IgG surface).

Capillary channels can be used for purification of phosphopeptides and phosphoproteins by creating suitable surfaces on the capillary wall. One means is to exploit the natural interaction between phosphate groups and metal ions. Therefore, phosphopeptides and phosphoproteins can be purified on metal-chelate surfaces made from IDA, NTA, or CMA.

It is also possible to purify these phosphopeptides and phosphoproteins with antibodies immobilized at the capillary surface. It is possible to immobilize antibodies on the capillary wall that are specific to phosphotyrosine residues, as well as phosphoserine and phosphothreonine residues. It is also possible to immobilize antibodies that are bind to specific phophorylated sites within a protein, such as specifically-binding phosphorylated tyrosine within a specific kinase. These antibodies are often referred to as phosphorylation site-specific antibodies (PSSAs). Once adsorbed the trapped phosphoprotein and phosphopeptides can be eluted at low pH.

Yet another approach to the purification of phosphopeptides and phosphoproteins involves the derivitization of the phosphate group such that biotin is attached to it. This biotinylated phosphoprotein or phosphopeptide can be purified on an avidin (monomeric or multimeric) coated capillary. Description of capillary channels used for purification of phosphopeptides and phosphoproteins.

There are a number of means applied for the purification of protein complexes by open-tube capillaries. One means involves the use of a recombinant “bait” protein that will form complexes with its natural interaction partners. These multiprotein complexes are then purified through a fusion tag that is attached to the “bait.” These tagged “bait” proteins can be purified through groups attached to the surface of the capillary such as metal-chelate groups, antibodies, calmodulin, or any of the other surface groups described above for the purification of recombinant proteins.

It is also possible to purify unativen (i.e. non-recombinant) protein complexes without having to purify through a fusion tag. This is achieved by immobilizing an antibody for one of the proteins within the multiprotein complex. This process is often referred to as “co-immunoprecipitation.” The multiprotein complexes can be eluted with low pH.

Capillary channels can be used to purify entire classes of proteins on the basis of highly conserved motifs within their structure, whereby an affinity ligand attached to the capillary surface reversibly binds to the conserved motif. For example, it is possible to immobilize particular nucleotides on the inner capillary surface. These nucleotides include adenosine 5′-triphosphate (ATP), adenosine 5′-diphosphate (ADP), adenosine 5′-monophosphate (AMP), nicotinamide adenine dinucleotide (NAD), or nicotinamide adenine dinucleotide phosphate (NADP). These nucleotides can be used for the purification of enzymes that are dependent upon these nucleotides such as kinases, phosphatases, heat shock proteins and dehydrogenases, to name a few.

There are other affinity groups that can be immobilized on the inner capillary surface for purification of protein classes. Lectins can be immobilized at the inner capillary wall for the purification of glycoproteins. Concanavilin A (Con A) and lentil lectin can be immobilized for the purification of glycoproteins and membrane proteins, and wheat germ lectin can be used for the purification of glycoproteins and cells (especially T-cell lymphocytes). Though it is not a lectin, the small molecule phenylboronic acid can also be immobilized at the inner capillary wall and used for purification of glycoproteins.

It is also possible to immobilize heparin onto the inner surface of the capillary, which is useful for the purification of DNA-binding proteins (e.g. RNA polymerase I, II and III, DNA polymerase, DNA ligase). In addition, immobilized heparin can be used for purification of various coagulation proteins (e.g. antithrombin III, Factor VII, Factor IX, Factor XI, Factor XII and XIIa, thrombin), other plasma proteins (e.g. properdin, BetaIH, Fibronectin, Lipses), lipoproteins (e.g. VLDL, LDL, VLDL apoprotein, HOLP, to name a few), and other proteins (platelet factor 4, hepatitis B surface antigen, hyaluronidase). These types of proteins are often blood and/or plasma borne. Since there are many efforts afoot to rapidly profile the levels of these types of proteins by technologies such as protein chips, the performance of these chips will be enhanced by performing an initial purification and enrichment of the targets prior to protein chip analysis.

It is also possible to attach protein interaction domains to the inner surface of the capillary for purification of those proteins that are meant to interact with that domain. One interaction domain that can be immobilized on the inner surface of the capillary is the Src-homology 2 (SH2) domain that binds to specific phophotyrosine-containing peptide motifs within various proteins. The SH2 domain has previously been immobilized on a resin and used as an affinity reagent for performing affinity chromatography/mass spectrometry experiments for investigating in vitro phosphorylation of epidermal growth factor receptor (EGFR) (see Christian Lombardo, et al., Biochemistry, 34:16456 (1995)). Other than the SH2 domain, other protein interaction domains can be immobilized on the inner surface of the capillary for the purposes of purifying those proteins that possess their recognition domains. Many of these protein interaction domains have been described (see Tony Pawson, Protein Interaction Domains, Cell Signaling Technology Catalog, 264-279 (2002)) for additional examples of these protein interaction domains).

As other class-specific affinity ligands, benzamidine can be immobilized on the inner surface of the capillary for purification of serine proteases. The dye ligand Procion Red HE-3B can be immobilized on the inner surface of the capillary for the purification of dehydrogenases, reductases and interferon, to name a few.

Because of the nature of the flow path in the capillary channel, it is possible to capture, purify and concentrate molecules or groups of molecules that have a relatively large structure compared even to a protein. The capillary channel with the appropriate binding functionality on the surface can bind and extract these structure without problems such as shearing or (frit or backed bed) filtration, that you might find in convention extraction columns. Care does have to be taken when introducing the solution to the capillary channel or when flowing solutions through the capillary channel so that the structure is not sheared. Slower flow rates may be necessary. Examples of large structures that can be extracted are protein complexes, viruses and even whole cells that can be captured by a specific surface group.

Example 44 describes the procedure for multidimensional stepwise solid phase extraction of isotope-coded affinity tagged (ICAT) peptides. In certain instances where higher protein capacities are desired to separate larger quantities, it may be necessary to use packed-bed or tubes with increased secondary structure to increase the amount of solid phase surface area available for extraction. In these cases, the packing or secondary structure will still allow passage of the fluid and air segments. The fractions will still be collected on the basis of increasing ionic strength or pH, and can be processed in the affinity separation dimension described below, but with suitable adjustments being made for larger sample volumes being introduced into the affinity capillary and/or possible differences in pH.

In certain instances the fractions collected from the avidin affinity column may be processed further for cleavage of the affinity tag from the isotope-coding region, prior to separation in the reversed-phase separation dimension described below. The cleavage can be performed directly upon the collected fraction by photocleavage as described in Huilin Zhou, et al., Nature Biotech., 19:512 (2002), or acid cleavage with TFA-triethylsilane as described in Brian Williamson, et al., Proceedings of the 50^{th} ASMS Conference on Mass Spectrometry and Allied Topics, Orlando, Fla., Jun. 2-6, 2002, Orlando, Fla., Poster # WPA023, or by evaporating the collected fraction to dryness by standard means and adding TFA-triethylsilane reagent to achieve acid cleavage as described in Williamson, et al, 50^{th} ASMS Conference Proceedings, June 2^{nd}-6^{th} 2002, Orlando, Fla., Poster # WPA023 (2002). In instances where the peptide mixture generated by the release, labeling and proteolysis is not excessively complex, it may be possible to bypass the ion-exchange separation dimension and proceed directly to the affinity separation dimension. An example of bypassing the ion-exchange separation dimension is given in LC Packings/Dionex' Application Note, “2D Analysis of Isotope Coded Affinity Tag (ICAT) Labeled Proteins,” Application Note UltiMate Capillary and Nano LC System, Proteomics #09. However, if this strategy is applied it is advised that some suitable means be applied for removal of the unincorporated ICAT tags prior to introducing the sample to the monomeric avidin column, which would otherwise be removed in the ion-exchange separation dimension.

In certain instances it may be possible to bypass the ion-exchange separation and affinity separation dimensions and proceed directly from the sample protein release, lysis and labeling step (i.e. the first step described at the beginning of this example) to the reversed-phase separation dimension, such as when solid-phase isotope-coded tagging reagents are being utilized as described in Huilin Zhou, et al., Nature Biotech., 19:512 (2002); in this case the cleavage of the isotope-coded peptide from the solid-phase support can be achieved by photocleavage as described in Huilin Zhou, et al., Nature Biotech., 19:512 (2002) or by acid cleavage as described in Brian Williamson, et al., Proceedings of the 50th ASMS Conference on Mass Spectrometry and Allied Topics, Orlando, Fla., Jun. 2-6, 2002, Orlando, Fla., Poster # WPA023.

Coiled Fused Silica Extraction Capillaries

In some preferred embodiments of the invention, the extraction channel comprises a coiled fused silica extraction capillary having an internal solid phase extraction surface that binds an analyte, wherein at least some portion of the capillary is coiled at a bend radius of less than 3 cms. In some embodiments, at least some portion of the capillary is coiled at a bend radius falling within one or more of the following ranges: between 0.1 and 3 cms, between 0.2 and 3 cms, between 0.5 and 3 cms, between 1 and 3 cms, between 0.1 and 2 cms, between 0.2 and 2 cms, between 0.5 and 2 cms, between 1 and 2 cms, between 0.1 and 1 cm, between 0.2 and 1 cm, and between 0.5 and 1 cm. The term “bend radius” refers to the radius of a bend in the capillary tubing. In the case of a coil, for example, a coil diameter of 2 cms corresponds to a bend radius of 1 cm.

As used herein the term “fused silica” refers to silicon dioxide (SiO₂) in its amorphous (glassy) state, which is a species of the broader genera of compositions commonly referred to as “glass.” Preferred capillaries of the instant invention are produced using high quality synthetic glass of nearly pure SiO₂. The term “synthetic fused silica” refers to amorphous silicon dioxide that has been produced through chemical deposition rather than refinement of natural ore. This synthetic material is of much higher purity and quality as compare to fused quartz made from natural minerals.

Fused silica capillaries, and especially capillaries comprising synthetic fused silica, have been found to be particularly suited for use as the extraction capillaries of the present invention. The fused silica provides numerous silanol groups which serve as useful attachment points for the extraction chemistries described elsewhere in this disclosure. Fused silica capillaries that are suitable for the purposes of this invention include those produced by Polymicro Technologies, LLC of Phoenix, Ariz. and SGE Inc. of Ringwood, Australia It has been the inventor's experience that the capillary tubing produced by Polymicro is generally better at withstanding breakdown at tight bending radius the that produced by SGE.

The use of a coiled extraction capillary column provides a number of advantages. As discussed elsewhere in this specification, coiling of the capillary results in a more tortuous flow path, which in many cases will improve the efficiency of the extraction process. Another benefit of coiling is that it allows for the production of a relatively compact extraction device that would not otherwise be feasible due to the length of the extraction capillary tubing. Tighter coiling of the tubing permits the production of more compact devices that are easier to position and manipulate. This is particularly important where the device is designed to be portable and/or is a component of a multiplexing system. Examples of devices comprising tightly coiled capillaries are provided in the Example section of the specification.

While the instant disclosure identifies a number of advantages resulting from the use of the tightly coiled fused silica extraction capillaries, there is a limit to how tightly a fused silica capillary can be coiled or bent without resulting in breakage or other impairment of function. This is because bending the capillary tubing results in applied bending stress in the tubing which will eventually cause the tubing to break if the bending radius is too tight. In an extreme case where the bending radius is very small, breakage occurs at the time of bending. However, at less extreme bending radii the tubing does not initially break, but over the course of time the bending stress will result in a breakdown of the capillary that will impact performance. Thus, although it has been recognized that fused silica capillary tubing can be bent to some degree, e.g., in loose, high bend radius loops, it has been thought that this type of tubing should not be wound into tighter coils of lower bend radius because this would presumably result in an applied bending stress exceeding the capillary break strength. This perceived inability to tightly coil fused silica capillary tubing would dissuade those of skill in the art from attempting to construct some of the compact extraction capillary devices of the present invention. However, the instant inventors have discovered that fused silica capillary tubing can be coiled substantially tighter that previously believed, while retaining the ability to function as an extraction device for extended periods of times. By employing these tightly coiled capillaries it is possible to create compact, tightly coiled extraction capillaries for use in extraction devices of the invention that are stable for extended periods.

Capillary coiling has been considered in the context of capillary zone electrophoreisis. Kasicka et al. presented a mathematical model of the deformation of the analyte zone in capillary zone electrophoresis (CZE) due capillary coiling (Electrophoresis (1995) 16:2034-38). These authors conclueded that, especially in the case of CZE separation of macromolecules and particles, capillary coiling can significantly decrease the separation efficiency. For that reason, they recommended that small radius coiling of capillary columns in the CZE apparatus should be avoided.

The bending stress on fused silica capillary tubing is a function of the diameter of the tubing and the radius at which the tubing is coiled or bent. For the purpose of describing the instant invention, the term “Applied Stress Ratio” (or “ASR”) is defined by the following formula: ASR=D¹¹/R, where D is the overall diameter of the tubing in microns (including the coating, e.g., a polyimide coating) and R is the radius of the bend in millimeters. The ASR of a coiled or bent fused silica extraction capillary increases with the overall diameter of the tubing and with decreasing bend radius, i.e., tighter coiling. For example, the ASR of a fused silica capillary having an overall diameter of 360 microns and coiled to a bend radius of 15 mm would be (360)^{1.1}/15=43.

In preferred embodiments of the invention fused silica capillary extraction tubing is used with an ASR of greater than 40. According to the prevailing thinking in the field prior to this invention, this ASR would result in a bending stress exceeds the break strength of the capillary. For example, Polymicro Technologies (a leading supplier of fused silica capillary tubing) has published a table (reproduced herein as FIG. 22) that predicts applied bending stress in kpsi as a function of total OD and bend radius (see “Mechanical Stress and Fiber Strength,” The Book on the Technologies of Polymicro (Polymicro Technologies LLC, Phoenix, Ariz., 2002) page 3-7). This predicted applied bending stress is roughly proportional to ASR, with applied bending stress of 100 kpsi being about equal to an ASR of about 40. According to this table, any capillary bend radius that results in an applied bending stress of greater than about 100 kpsi (i.e., an ASR of about 40) exceeds the capillary break strength and therefore should not be attempted. However, the instant inventors have shown that bending radii extending far into this forbidden domain are possible and indeed desirable.

Another method for calculating bending stress upon a fused silica capillary is by use of the following equation: CAS=(E′r)/(R+Cₜₕ+r), where CAS is Calculated Applied Stress (in pounds per square inch, or “psi”), r is ½ the outer diameter of the fused silica capillary (in μm), R is the bend radius (in μm), and Cₜₕ is the thickness of the capillary coating (in μm), and E′ is 1.06×10⁷ (a constant that incorporates E (Young's modulus) and a factor for conversion of μm and inches). For example, where R is 25,400 μm (1 inch), r is 340 μm, and Cₜₕ is 18 μm, the CAS is 70,391 psi (70 kpsi).

As pointed out above, at less extreme bending radii a fused silica capillary does not break upon the initial coiling, but nevertheless the capillary might gradually break down when coiled for an extended period of time. For use in the context of the present invention, it is generally not sufficient that a coiled capillary be resistant to breakage upon initial bending. Rather, to function as an effective extraction device it should be stable to bending for a period of at least a day, preferably a week, and more preferably at least a month, six months, or even a year. Stable in this context refers to a capillary capable of performing without substantial degradation of performance due to bending stress induced breakdown of the capillary.

Some embodiments of the invention involve the use of fused silica extraction capillary tubings coiled at a bend radius that results in an Applied Stress Ratio in the range of about 40 to 400, 40 to 300, 40 to 200, or 40 to 100.

As an alternative method for quantifying bending stress, some embodiments of the invention involve the use of fused silica extraction capillary tubings coiled at a bend radius that results in a Calculated Applied Stress greater than 100 kpsi, for example, in one of the following ranges: 100 to 200 kpsi, 100 to 300 kpsi, 100 to 500 kpsi, 100 to 1000 kpsi, 200 to 300 kpsi, 200 to 500 kpsi, 200 to 1000 kpsi, 300 to 500 kpsi, 300 to 1000 kpsi, or 500 to 1000 kpsi.

A number of the Examples provided in this specification employ fused silica extraction capillaries coiled so as to have an ASR in the ranges cited above. For example, in Example 36 fused silica capillary with an overall diameter of 360 microns was bent to form coils of an average diameter of 9 mm (i.e., a bend radius of 4.5 mm). The resulting ASR is (360)^{1.1}/4.5=144.

Some embodiments of the invention involve the use of fused silica extraction capillaries, preferably synthetic fused silica capillaries. These capillaries can be of any diameter so long as they are not to large to function as capillaries, e.g, total outside diameter in the range of 10 to 10,000, preferably 90 to 3500, more preferably 90 to 1500, 90 to 850, 150 to 850 or 238 to 435 microns.

Some embodiments of the invention involve the use of fused silica extraction capillary tubings having internal diameters in the range of about 2 to 3000 microns, about 2 to 1000 microns, about 10 to 700 microns, about 25 to 400 microns, or about 100 to 200 microns.

In preferred embodiments of the invention the capillary tubing is coated with a flexible coating material, typically a polymer or resin. Preferred coating materials include polyimide, silicone, polyacrylate, aluminum or fluoropolymer, especially semiconductor grade polyimide

Some embodiments of the invention involve the use of fused silica capillary tubing of a length of greater than 5 cm, especially in the range of 10 cm to 10 m, 20 cm to 2 m, or 100 cm to 1 m.

In some embodiments of the invention the fused silica capillary is coiled into a coil comprising multiple turns, e.g, at least five turns, at least 10 turns, at least 50 turns, at least 100 turns, or even 200 or more turns. The maximum number of turns is in general limited only by the length of capillary used, the design of the device, and the ASR limitations as described herein. Thus in some embodiments the number of coils can reach 1000, 2000, 10,000 or even more.

In order to successfully coil fused silica capillary tubing to achieve the tighter coils and higher ASRs associated with them, it is important to exert all possible care to coil the tubing without introducing nicks or other breakage that can lead to breakdown of extraction function. For instance, it is usually better not to introduce any twisting of the tubing during the coiling process, as this twisting will itself introduce stress into the tubing beyond that introduced by the coiling. Other precautions that will permit tighter coiling with breakage include minimizing nicks on inner and outer surface of capillary, the use of a thicker coating, preferably a polyimide coating, and minimizing exposure of the capillary surface to high pH or basic conditions.

One important factor to bear in mind with regard to the use and production of coiled fused silica extraction capillaries is that there is a great deal of variability in the “coilability” of fused silica capillaries. This variability can be seen from vendor to vendor, from batch to batch from the same vendor, and even from meter to meter on single batch of fused silica. Thus, the ability to achieve tight coiling can depend upon the selection of appropriate stock of fused silica capillary. For example, we have generally had better success in coiling fused silica capillary from Polymicro compared to that from SGE. We have also found that from a given lot or batch of fused silica capillary some sections are much more resilient to the stress introduced by coiling than others.

One method for dealing with this variability of coilabililty is to pre-test candidate fused silica capillary prior to coiling. The pre-testing involves bending the fused silica to a radius as tight (or preferably tighter) than the radius of the desired coiled extraction capillary. For example, if one wishes to prepare coils with a diameter of 3 or 4 cm, the capillary can be pre-tested by introducing a loop or bend into the capillary of a radius of about 0.5 to 1 cm and moving this loop through the length of the capillary that one is testing. The loop can be introduced and moved through the coil by hand. Alternatively, the loop can be introduced by running the capillary around a rod, wheel, pulley or the like that sequentially introduces the desired bend into the capillary along the length of the region to be tested. A lot that is found to withstand this treatment would be chosen for use in the production of coiled capillaries, while a lot that experiences significant breakage can be rejected. Alternatively, more resilient sections of the capillary can be selected for coiling, with the sections more prone to breakage not being used.

In one embodiment of the invention, this bending test can be used to improve the process for manufacturing fused silica capillary. That is, the bending test can be used as a means of assessing quality of different lots of capillary, and production (or handling) methods optimized to minimize breakage and thus achieve a more coilable product.

The invention is further illustrated by the following specific but non-limiting examples, where examples given in the past tense describe procedures which have been reduced to practice in the laboratory. Examples given in the present tense describe procedures which have not been carried out in the laboratory and are constructively reduced to practice by the filing of this application.

### EXAMPLE 1

### HF Etch-Conditioning a Capillary Channel

Capillaries (Polymicro Technologies, Phoenix, Ariz.) of dimensions 25, 50, 75, 100, 150, 200, 250, and 300 μm ID and lengths of 1 cm to 5 meters are obtained. In this example, a 100 μm ID 1 meter length fused silica capillary is filled with a 5% (w/v) solution of ammonium hydrogen fluoride in methanol and is flushed for 1 hour at room temperature at a 10 μL/min flow rate. The solution is changed to HPLC grade deionized water for 15 minutes and then flushed with nitrogen gas and heated to 300° C. for 2 hours with continued gas flow. At high temperature, residual ammonium hydrogen fluoride dissociates to produce gaseous hydrogen fluoride and ammonia which is removed from the channel by the nitrogen gas. Finally, the capillary is cooled and flushed with 0.1 M HCl for 30 minutes, flushed with HPLC grade deionized water for 15 minutes at a 10 μL/min flow rate and then flushed and stored with HPLC grade methanol. Increasing or decreasing the diameter of the channel being etched will increase or decrease the flow rate of the solvents used.

### EXAMPLE 2

### Hydroxide Etch-Conditioning a Capillary Channel

Capillaries (Polymicro Technologies, Phoenix, Ariz.) of dimensions 25, 50, 75, 100, 150, 200, 250, and 300 μm ID and lengths of 1 cm to 5 meters were obtained. In this example, a 100 μm ID 1 meter length fused silica capillary was filled with 0.1 M sodium hydroxide and flushed at room temperature for 1 hour. Then, the base solution was removed by rinsing with HPLC grade deionized water for 30 minutes. The solution was changed to 0.1 M HCl and the capillary was flushed for 30 minutes. Then the solution was changed to HPLC grade deionized water and the capillary was flushed for 15 minutes and was finally flushed and stored with HPLC grade acetone. Solvent flow rates were 10 μL/min. Increasing or decreasing the diameter of the channel being etched will increase or decrease the flow rate of the solvents used.

### EXAMPLE 3

### Attaching polyacrylamide to a Capillary Channel

A 200 μm ID 50 cm capillary is etched according to Examples 1 or 2. The fused silica capillary is reacted with a solution of γ-methacryloxypropyl-trimethoxysilane (Sigma-Aldrich, Milwaukee, Wis., PN 44,015-9) (30 μL mixed with 1.0 mL of 60% (v/v) acetone/water). The capillary is filled, the flow is stopped and the capillary wall reacted at room temperature. After 1 hour, the capillary is flushed with water to stop the reaction. Then the capillary is reacted with a solution of acrylamide. A solution of 3% (v/v) acrylamide with catalyst is prepared and immediately pumped into the capillary. Acrylamide (30 μL) is mixed with a 1.0 mL degassed water solution containing 2 mg of ammonium persulfate and 0.8 mg of TEMED (N,N,N′,N′-tetramethyl-ethylenediamine). The capillary is filled rapidly at 50 μL/min, the flow is stopped and the capillary reacted at room temperature for 1 hour. After 1 hour, the capillary is flushed with deionized water to stop the reaction. Alternatively, the acrylamide polymerization solution can be prepared at 4° C., pumped into the capillary and polymerization solution allowed to warm up to room temperature and react for 1 hour. Finally, the capillary is flushed and stored in deionized water.

### EXAMPLE 4

### Bonding a Sulfonic Acid, a Strong Acid Cation Exchanger to a Capillary Channel.

A 200 μm ID 50 cm capillary is etched according to Examples 1 or 2. The fused silica capillary is reacted with a solution of γ-methacryloxypropyl-trimethoxysilane (Sigma-Aldrich, Milwaukee, Wis., PN 44,015-9) (30 μL mixed with 1.0 mL of 60% (v/v) acetone/water). The capillary is filled, the flow is stopped and the capillary reacted at room temperature. After 1 hour, the capillary is flushed with water to stop the reaction. Then the capillary is flushed with dry THF.

Alternatively, the γ-methacryloxypropyltrimethoxysilane capillary is flushed with water and is reacted with a solution 2-acrylamido-2-methyl-1-propanesulfonic acid (Lubrizol™) (Sigma-Aldrich, Milwaukee, Wis., PN 28,273-1) that contains no free radical scavengers. A solution of 3% (v/v) Lubrizol™ with catalyst is prepared and immediately pumped into the capillary. Lubrizol™ (30 μL) is mixed with a 1.0 mL degassed water solution containing 2 mg of ammonium persulfate and 0.8 mg of TEMED (N,N,N′,N′-tetramethylethyl-enediamine). The capillary is filled rapidly at 50 μL/min, the flow is stopped and the capillary reacted at room temperature for 1 hour. After 1 hour, the capillary is flushed with deionized water to stop the reaction. Alternatively, the Lubrizol™ polymerization solution can be prepared at 4° C., pumped into the capillary and polymerization solution allowed to warm up to room temperature and react for 1 hour. A lower density cation exchange wall is prepared by using a 50/50 mixture of acrylamide/Lubrizol mixture in place of 100% Lubrizol™ as described above. Finally, the capillary is flushed and stored in deionized water.

### EXAMPLE 5

### Bonding a Sulfonic Acid, a Strong Acid Cation Exchanger to a Capillary Channel.

Capillaries (Polymicro Technologies, Phoenix, Ariz.) of dimensions 25, 50, 75, 100, 150, 200, 250, and 300 μm ID and lengths of 1 cm to 5 meters are obtained. In this example, a 100 μm ID 1 meter length fused silica capillary is filled with 0.1 M sodium hydroxide and reacted at room temperature for 1 hour. Then, the base solution is removed by rinsing with HPLC grade deionized water for 30 minutes.

The capillary is flushed with 100% HPLC grade methanol and then the capillary is filled with a 50% (v/v) 1,3-propane sultone (Sigma-Aldrich, Milwaukee, Wis., PN P5,070-6) in toluene and reacted for 1 hour 10 μL/min. The capillary is flushed with 100% HPLC grade methanol, and then 100% HPLC grade deionized water.

### EXAMPLE 6

### Bonding a Quaternary Amine, a Strong Base Anion Exchanger to a Capillary Channel

A 200 μm ID 50 cm capillary is etched according to Examples 1 or 2. The fused silica capillary is reacted with a solution of γ-methacryloxypropyl-trimethoxysilane (Sigma-Aldrich, Milwaukee, Wis., PN 44,015-9) (30 μL mixed with 1.0 mL of 60% (v/v) acetone/water). The capillary is filled, the flow is stopped and the capillary reacted at room temperature. After 1 hour, the capillary is flushed with water to stop the reaction. Then the capillary is flushed with dry THF.

Then the capillary is reacted with a solution (3-acrylamidopropyl)trimethylammonium chloride (Sigma-Aldrich, Milwaukee, Wis., PN 44,828-1) that contains no free radical scavengers. A solution of 3% (v/v) (3-acrylamidopropyl) trimethylammonium chloride with catalyst is prepared by taking 40 μL of a 75% aqueous solution of the (3-acrylamidopropyl) trimethylammonium chloride and mixing it with a 1.0 mL degassed water solution containing 2 mg of ammonium persulfate and 0.8 mg of TEMED (N,N,N′,N′-tetramethylethylenediamine). The capillary is filled rapidly at 50 μl/min, the flow is stopped and the capillary reacted at room temperature for 1 hour. After 1 hour, the capillary is flushed with deionized water to stop the reaction. Alternatively, the polymerization solution can be prepared at 4° C., pumped into the capillary and polymerization solution allowed to warm up to room temperature and react for 1 hour. A lower density anion exchange wall is prepared by using a 50/50 mixture of acrylamide/quaternary amine monomer mixture in place of 100% quaternary amine monomer as described above. Finally, the capillary is flushed and stored in deionized water.

### EXAMPLE 7

### Bonding a Carboxylic Acid, a Weak Acid Cation Exchanger to a Capillary Channel

A 200 μm ID 50 cm capillary is etched according to Examples 1 or 2. The fused silica capillary is reacted with a solution of γ-methacryloxypropyl-trimethoxysilane (Sigma-Aldrich, Milwaukee, Wis., PN 44,015-9) (30 μL mixed with 1.0 mL of 60% (v/v) acetone/water). The capillary is filled, the flow is stopped and the capillary reacted at room temperature. After 1 hour, the capillary is flushed with water to stop the reaction. Then the capillary is flushed with dry THF. Flush the capillary with deionized water. Flush the capillary with THF and then deionized water. Then, the capillary is filled with an acrylic acid monomer solution made up by the following procedure taking 30 μL of acrylic acid free of free radical scavengers (Sigma-Aldrich, Milwaukee, Wis.) and mixing it with a 1.0 mL degassed 0.05 M sodium phosphate buffer solution, pH 7.0 containing 2 mg of ammonium persulfate and 0.8 mg of TEMED (N,N,N′,N′-tetramethylethylene-diamine). The capillary is filled rapidly at 50 μL/min, the flow is stopped and the capillary reacted at room temperature. After 2 hours, the capillary is flushed with deionized water to stop the reaction. Alternatively, the polymerization solution can be prepared at 40° C., pumped into the capillary and polymerization solution allowed to warm up to room temperature and react for 2 hours. Finally, the capillary is flushed and stored in deionized water.

### EXAMPLE 8

### Bonding a Primary Amine, a Weak Base Anion Exchanger to a Capillary Channel

A 100 μm ID 50 cm capillary is etched according to Examples 1 or 2. The dry capillary is rinsed with a 110° C. solution of 10% (v/v) γ-glycidoxypropyl-trimethoxysilane (Sigma-Aldrich, Milwaukee, Wis., PN 44,016-7) in dry toluene and reacted for 2 hours. The capillary is flushed with deionised water and then filled and reacted with a 1 M aqueous solution of ethylenediamine for 30 minutes at 40° C. and flushed and stored with deionized water. Alternatively, the epoxide group may be reacted to insert a hydrophilic polyethylene glycol (PEG) linker in the amine group. A mono protected diamine is selectively reacted on one end and then subsequently deprotected with trifluoroacetic acid (TFA) to make the other amine available for reaction. The capillary is filled and reacted for 4 hours with a 45° C. 50 mg/mL aqueous solution of mono-N-t-bocamido-dPEG₃™-amine (Quanta BioDesign, Ltd. PN 10225, Powell, Ohio). The capillary is deprotected by filling and reacting the capillary with 1% 45° C. solution TFA for 1 hour at 10 μL/min. Then the capillary is flushed with 100% methanol and stored in 100% deionized water.

Alternatively, the fused silica capillary from Examples 1 or 2 is flushed with 100% methanol and then filled with a 65° C. solution of 3-aminopropyltriethoxysilane (0.6 mL silane in 3 mL of dry toluene) and is reacted for 2 hours at 10 μL/min. Then the capillary is flushed with 100% methanol and stored in 100% deionized water.

### EXAMPLE 9

### Attaching Antibodies and Other Proteins to a Capillary Channel Using a 1,4-phenylene diisothiocyanate (PDITC) Linker.

A 150 μm ID 30 cm capillary is prepared according to Example 8 to attach a primary amine group. Then the capillary is flushed with tetrahydrofuran and then filled with a solution of PDITC (500 mg phenylene diisothiocyanate in 10 mL of dry tetrahydrofuran) and reacted under slow flow conditions of 2 μL/min keeping the capillary at room temperature for 4 hours. The capillary is flushed with 100% HPLC grade methanol.

A solution of 1 mg/ml of monoclonal antibody is dialyzed extensively against buffer (0.2 M Na₂HPO₄, pH 7.5, 0.2% Nonidet P-40 surfactant). Then the antibody buffered solution is pumped slowly at 1 μL/min flow rate through the PDITC functionalized fused silica capillary for 4 hours at room temperature. The capillary is washed with the 10 mM phosphate buffer pH 7.5 for 30 minutes and then flushed with deionized water for 1 hour and stored at 4° C.

Alternatively, the PDITC coupling can be carried out at pH 9.0 to achieve a faster reaction. However, but in order to avoid deterioration of the capillary wall by the higher pH buffer, the reaction with the antibody is performed at 4° C. for 4 hours.

Other proteins may be attached through 1,4-phenylene diisothiocyanate (PDITC) linker. The protein may be native and will attach through native lysine residues, or the protein may be recombinant and will attach through a poly-lysine fusion tag at the protein terminus.

The capillary is washed with the 10 mM phosphate buffer pH 7.5 for 30 minutes and then flushed with deionized water for 1 hour and stored at 4° C.

### EXAMPLE 10

### Bonding Polyethylene Glycol (Peg) to a Capillary Channel

A 300 μm ID 4 meter length capillary is etched according to Examples 1 or 2. The capillary is washed with distilled water followed by methanol and then dried with nitrogen gas at 130° C. for 4 hours. The capillary is then filled with a 10% (w/v) PEG 8M-10 solution (PEG in methylene chloride) PEG 8M-10 polymer solution is obtained from Innophase Corporation (Portland, Conn., USA), other PEG (low molecular weight) materials are available from Shearwater Corporation, Huntsville, Ala. The capillary is then placed in the column oven of a Varian 3700 gas chromatograph under slow high-purity nitrogen flow with a temperature program of 30° C. raised to 225° C. at 5° C./min, holding at the upper temperature for 12 hours. After this, the capillary is washed for 1 hour with methylene chloride followed by methanol wash for 30 minutes and finally flushed and stored in 100% deionized water.

### EXAMPLE 11

### Attaching Cibacron Blue and ATP to a Capillary Channel

A 200 μm ID 30 cm length capillary is etched according to Examples 1 or 2. The capillary is filled with 100° C. 10% w/v glycidoxypropyl-trimethoxysilane (Sigma-Aldrich, Milwaukee, Wis., PN 44,016-7) in dried toluene, and then the capillary is reacted under slow flow conditions of 2 μL/min for 4 hours. The capillary is washed with toluene and then washed with methanol, then methanol/water 50/50 and then followed by water each for 30 minutes. The capillary is filled with 50° C. solution Cibacron Blue F3GA (1-Amino-4-[[4-[[4-chloro-6-[[3 (or 4)-sulfophenyl]amino]-1,3,5-triazin-2-yl]amino]-3-sulfophenyl]amino]-9, 10-dihydro-9, 10-dioxo-2-anthracenesulfonic acid, Sigma-Aldrich, Milwaukee, Wis., PN 24,222-5) 100 mg/mL in 10 mM phosphate buffer, pH 7.5 and reacted under slow flow conditions of 2 μL/min for 16 hours. The capillary is flushed with deionized water for 1 hour and stored at 4° C. until used.

Alternatively, γ-aminophenyl-ATP molecular group is attached to the capillary wall. The capillary is filled with a solution of adenosine-5′-[γ-(4-aminophenyl)]triphosphate, sodium salt, (Jena Bioscience, Jena, Germany, PN NU-801L) 15 mg/mL in water and reacted under slow flow conditions at room temperature for 4 hours. The capillary is flushed with deionized water and stored at 4° C. until used.

The capillary is used according to procedures described in reference Timothy Haystead, Current Drug Discovery, Proteome mining: exploiting serendipity in drug discovery, 22-24 (March 2001).

### EXAMPLE 12

### Preparing a C18 Reverse Phase Capillary Channel

A 200 μm ID 100 cm length capillary is etched according to Examples 1 or 2. The etched capillary tube is filled with 10% (w/v) colloidal silica solution and sealed (Ludox HS-40, Du Pont, Willmington, Del.) and heated to 250° C. for 1 hour. This treatment is repeated 3 times and finally the capillary is flushed with HPLC grade ethanol. The capillary is filled with an 80° C. solution of 0.2 g/mL dimethyloctadecyl-chlorosilane or octadecyltrichlorosilane (Petrarch Systems Inc., Bristol, Pa., USA) in toluene, and reacted for 2 hours at 10 pumin. This treatment is repeated twice. The capillary is endcapped by filling the capillary with 80° C. 0.2 g/mL solution of methyltrichlorosilane in toluene reacted for 2 hours at 10 μL/min. After this treatment, the capillary is flushed and stored with 100% HPLC grade methanol.

### EXAMPLE 13

### Bonding IDA, NTA, and CMA Chelating Groups to Fused Silica Capillary Channel.

A 200 μm ID 100 cm length capillary is etched according to Examples 1 or 2. The capillary is filled with a 100° C. solution of 10% (v/v) γ-glycidoxypropyl-trimethoxysilane (Sigma-Aldrich, Milwaukee, Wis., PN 44,016-7) in dry toluene and reacted for 1 hour at 10 μL/min. This treatment is repeated twice. The capillary is flushed with 100% HPLC grade methanol. To make IDA chelator, the epoxy bonded capillary is filled and reacted with a 65° C. solution of 10% (w/v) solution of iminodiacetic acid in methanol adjusted to pH 8.2 with lithium hydroxide for 4 hours at 10 μL/min. To make the NTA chelator, epoxy activated capillary is reacted with a 65° C. solution of 10% (w/v) solution of R-substituted nitrilotriacetic acid, either N-[3-amino-1-carboxypropyl]-iminodiacetic acid or N-[5-amino-1-carboxypentyl]-iminodiacetic acid, in methanol adjusted to pH 7.5 with lithium hydroxide for 4 hours at 10 μL/min. The synthesis procedures of R substituted NTA reagents are described in U.S. Pat. No. 4,877,830. For the carboxymethylated aspartate (CMA) metal chelate capillary channel, a solution of L-aspartic acid (100 mg/mL) is adjusted to pH 8.6 with sodium carbonate and pumped through the capillary channel at a rate of 5 μL/min at 30° C. for 12 hours. The capillary is washed with deionized water and a solution of bromoacetic acid (100 mg/mL) adjusted to pH 8.6 with sodium carbonate is pumped through the capillary channel at a rate of 5 μL/min at 30° C. for 12 hours. The capillary channel is washed with deionized water and is ready to be converted to the metal chelated form by pumping with a metal salt solution as described in U.S. Pat. No. 5,962,641. The excess epoxide groups are endcapped with a 1 M aqueous solution of ethanolamine for one hour at room temperature. Finally, the chelator capillary is flushed and stored in deionized water.

The chelator capillary is converted to the metal chelate form before use. This is accomplished by flushing the capillary with the appropriate metal salt solution. The capillary is flushed for 30 minutes each of 30 mM disodium EDTA and deionized water, and then flushed with either 0.2 M ZnCl₂, 0.2 M NiCl₂, Hg(NO₃)₂.H₂O or FeCl₃ in 1 mM HNO₃ to convert the capillary to the Zn form, Ni form, or the Fe form respectively. The capillary is washed and stored with deionized water.

### EXAMPLE 14

### Procedure for Immobilizing Protein G, Protein A, Protein AIG, and Protein L on a Fused Silica Capillary Channels

A 200 μm ID 100 cm length capillary is etched according to Examples 1 or 2. The capillary is filled with 10% w/v γ-glycidoxypropyltrimethoxysilane (Sigma-Aldrich, Milwaukee, Wis., PN 44,016-7) in dried toluene, and then the capillary is heated under slow flow conditions of 1 μL/min at 50° C. for 4 hours. The capillary is cooled, washed for 30 minutes each with toluene and methanol, and then deionized water. The capillary is filled with solution of protein G solution (5 mg/ml in 10 mM phosphate buffer, pH 7.5). The protein may be native Protein G (Calbiochem, San Diego, Calif., PN 539302-Y) which will attach through native lysine residues or recombinant Protein G from (Calbiochem, San Diego, Calif., PN 539303-Y) which will attach through a poly-lysine fusion tag at the protein terminus. The capillary is reacted by pumping the protein solution through capillary at 1 μL/min at 25° C. for 4 hours. The capillary is flushed and conditioned with 10 mM phosphate buffer solution pH 7.0 for 1 hour and then flushed and stored with deionized water at 4° C. until used.

In addition to Protein G, others, such as recombinant Protein L (Pierce, Rockford, Ill., PN 21189), recombinant Protein A (Calbiochem, San Diego, Calif., PN 539203-Y), and recombinant Protein A/G (Pierce, Rockford, Ill., PN 21186) may be used with the procedures described in this example.

### EXAMPLE 15

### Immobilizing Single Strand and Double Strand DNA on Fused Silica Capillary Channels Using a Streptavidin Biotin Synthesis Reaction

A 150 μm ID 75 cm length capillary is etched according to Examples 1 or 2. The capillary is then filled with a 650 C₄% (v/v) solution of 3-aminopropyltriethoxy-silane in methanol and reacted for 12 hours with a slow flow of 2 μL/min. After flushing with 100% methanol and then deionized water, the tube is filled with a 5.0 mg/mL NHS-LC biotin (Quanta BioDesign, Ltd., Powell, Ohio, PN 10206) in 50 mM sodium bicarbonate solution pH 8.3 and reacted for 4 hours at room temperature. N-hydroxysuccinimidobiotin (NHS-biotin), an alternative molecule, is also used (Quanta BioDesign, Ltd., Powell, Ohio, PN 10205; or Sigma-Aldrich, Milwaukee, Wis., PN H1759). An NHS-biotin reagent containing a hydrophilic polyethylene glycol spacer (NHS-dPEG₄™-Biotin, Quanta BioDesign, Ltd., Powell, Ohio, PN 10200) is used under the same reaction conditions as the other biotin reaction reagents.

Following biotinylation the capillary is flushed with deionized water and then the capillary is filled with 4.0 mg/ml solution of streptavidin (Sigma-Aldrich, Milwaukee, Wis., PN SO677) in 50 mM sodium phosphate buffer (pH 7.3). The streptavidin solution is reacted for 4 hours at 4° C. and any remaining free streptavidin is removed by rinsing the capillary tube with deionized water. The streptavidin capillary is stored in a refrigerator until the final attachment of the biotinylated DNA.

In some cases, single-stranded DNA is immobilized to the wall of the capillary by quickly heating the biotinylated double-stranded DNA PCR product to 95° C. for several minutes followed by rapid cooling to 5° C. and immediately pumping the solution into the reactor. Excess template is removed by rinsing with deionized water. The deionized water may be heated to ensure complete denaturing of the DNA and retention of single-stranded DNA. Alternatively biotinylated single-stranded DNA may be prepared and purified and then introduced into the streptavidin capillary. Double-stranded DNA is immobilized to the wall of the capillary by pumping biotinylated double-stranded DNA PCR product without prior heating.

### EXAMPLE 16

### Attaching Proteins to Capillary Walls by Ionic Forces

Proteins can be attached to capillary surfaces by ionic forces. Proteins can exist as net positively charged molecules, net negatively charged molecules, or net neutral molecules depending on the isoelectric point and the buffer pH of the solution in which the protein is dissolved. Proteins and their isoelectric points are shown in Table D.

TABLE D

| | | NET CHARGE AT pH |
|---|---|---|
| PROTEIN | ISOELECTRIC POINT | 7.0 |
| Protein G | 4.5-4.8 | Negative |
| Avidin | 10.5 | Positive |
| Streptavidin | 6.8-7.5 | Neutral |
| Lysozyme | 11.5 | Positive |
| Cytochrome C | 10.2 | Positive |
| Serum Albumin | 4.8 | Negative |

If the protein is dissolved in a buffer at the isoelectric point then the net charge on the protein is zero (and there may even be some danger of protein precipitation unless an additive is added to keep the protein in solution). If the protein is dissolved in a buffer that is significantly below the isoelectric point, i.e. more than 1 or 2 pH units, then the protein has a net positive charge. If the protein is dissolved in a buffer that is higher than the isoelectric point, then the protein has a net negative charge.

A cation exchange fused silica capillary prepared from procedures in Examples 4 or 5 or bare silica (from procedures in Examples 1 or 2) is conditioned with a 25 mM sodium phosphate pH 7 buffer for 30 minutes. A solution of 5 mg/mL avidin, lysozyme, or cytochrome C in 25 mM sodium phosphate pH 7.0 buffer is pumped slowly through the capillary until 100% breakthrough of the protein i.e. the concentration of the protein leaving the capillary channel is equal to the concentration entering the capillary. At this point the protein is fully coated to the wall of the capillary. The capillary is flushed with a 10% (v/v) ethanol/water solution and stored in a refrigerator until used.

An anion exchange fused silica capillary prepared from the procedure described in Example 6 is conditioned with a 25 mM pH 7.0 sodium phosphate buffer for 30 minutes. A solution of 5 mg/mL protein G or serum albumin in 25 mM sodium phosphate pH 7.0 buffer is pumped slowly through the capillary until 100% breakthrough of the protein, i.e. the concentration of the protein leaving the capillary channel is equal to the concentration entering the capillary. At this point the protein is fully coated to the wall of the capillary. The capillary is flushed with a 10% (v/v) ethanol/water solution and stored in a refrigerator until used.

### EXAMPLE 17

### Concentrating a Lysozyme With an Open Silica Capillary

An etched silica capillary (Polymicro Technologies, Phoenix, Ariz.) with 75 μm ID and length 74 cm was obtained in the manner described in Example 2. The end of the capillary was placed into a 2 mL sealed vial containing the solution to be pumped through the capillary. A diaphragm pump set to 6 psi output pressure pumped air into the sealed vial to force the liquid through the capillary. Near the outlet end of the capillary a window burned into coating and a Linear Model Spectra 200 UV detector (Therma Analytical, Pleasanton, Calif.) set to wavelength 220 nm was used to monitor the buffers (and proteins) flowing through the capillary. The vial was filled with 20 mM tris chloride pH 8.0 buffer and allowed to equilibrate for 10 minutes. The capillary was filled with lysozyme (2 mg/mL in water) and pumped through the capillary until the absorbance at 220 nm increased and leveled off. Pumping the lysozyme was continued for 6 minutes. The capillary was flushed with 20 mM tris chloride pH 8.0 buffer and then with deionized water until use.

The capacity of the protein modified capillary was measured by desorbing the protein with acid and measuring the area of the peak of the desorbed protein as it passed through the detector. A buffer containing 20 mM Tris chloride pH 8.0 was pumped through the capillary at a pressure of 6 psi. A 10 second injection at 6 psi of 0.1 M HCl was pumped into the capillary to desorb the lysozyme and the area of the desorbed peak measured. The area of the peak corresponded to a capacity of 0.095 μg.

### EXAMPLE 18

### Attaching Heparin to a Fused Silica Capillary Wall Channel

A 150 μm ID 30 cm capillary is etched according to Examples 1 or 2. The fused silica capillary is filled with a 45° C. solution of 3-aminopropyltrimethoxysilane (0.5 mL silane in 1 mL of dry toluene) and is reacted for 1 hour at 10 μL/min. Then the capillary is flushed with 100% HPLC grade methanol and finally 100% deionized water. A solution of heparin and a water soluble DCC, 1-(3-dimethylaminopropyl)-3-ethylcarbodiimide is prepared to activate a portion of the carboxylic acid groups on the heparin. A solution containing 10 mg of heparin and 5 mg of 1-(3-dimethylaminopropyl)-3-ethylcarbodiimide in 1 mL of deionized water is reacted at room temperature for 2 hours. Then the solution is pumped into the capillary and reacted at room temperature for 2 hours. The capillary is flushed with 100% deionized water and stored in a refrigerator before use.

### EXAMPLE 19

### Attaching Lectin to a Fused Silica Capillary Wall Channel

A 200 μm ID 100 cm length capillary is etched according to Examples 1 or 2. The capillary is filled with a 50° C. 10% w/v glycidoxypropyl-trimethoxysilane (Sigma-Aldrich, PN 44,016-7, Milwaukee, Wis.) in dried toluene, and then the capillary is heated under slow flow conditions of 2 μL/min for 4 hours. The capillary is cooled, washed for 30 minutes each with toluene and methanol, and then deionized water.

A lectin is any protein incorporating one or more (frequently two) sites highly specific for carbohydrate binding, occurring in the tissues of most living organisms. The capillary is filled with a solution of Con A lectin (5 mg/ml in 10 mM phosphate buffer, pH 8.0). The capillary is reacted by pumping the protein solution through capillary at 1 μL/min at 25° C. for 4 hours. The capillary is flushed and conditioned with 10 mM phosphate buffer solution pH 7.0 for 1 hour and then flushed and stored with deionized water at 4° C. until used.

There are many types of lectin including Con A, the lectin from Canavalia ensiformis, a metalloprotein which binds molecules containing α-D-mannopyranosyl, α-D-glucopyranosyl and sterically related residues The lectin from Lens culinaris (lentil) also binds residues of α-D-glucose and α-D-mannose. The wheat (Triticum vulgare) germ lectin (WGL) interacts with residues of N-acetyl-D-glucosamine while the soybean (Glycine max) lectin recognizes galactose and N-acetyl-galactosamine residues.

### EXAMPLE 20

### Attaching Protein to a Capillary Channel Using EDC & N-hydroxysulfosuccinimide.

A 200 μm ID 50 cm length capillary is prepared with a carboxylic acid group according to the procedure described in Example 7. Alternatively, the carboxylic acid capillary can be formed by two other synthesis routes. Route 1, the dry capillary prepared from the procedure in Examples 1 or 2 is filled with neat 70° C. thionyl chloride and reacted for 12 hours at 10 μL/min. The capillary is flushed with dry THF and then filled a 50° C. solution 20% (v/v) of vinylmagnesium bromide in THF (Sigma-Aldrich, Milwaukee, Wis., PN 25,725-7) and reacted for 12 hours at 10 μL/min. The capillary is flushed with THF and then deionized water. The capillary is filled with a solution of a 50° C. 10% (v/v) 3-mercapto propionic acid (Sigma-Aldrich, Milwaukee, Wis., PN M580-1) in a 3% aqueous hydrogen peroxide or a solution of a 50° C. 10% (v/v) Thio-dPEG₄™ acid (Quanta BioDesign, Ltd., Powell, Ohio, PN 10247) in a 3% aqueous hydrogen peroxide and reacted for 12 hours at 10 μL/min. Then the capillary is flushed with deionized water. Route 2, the capillary is prepared from the procedure in Examples 1 or 2 is filled and reacted with a neat solution of allyidimethylchlorosilane (Petrarch Systems Inc., Levittown, Pa., PN A0552) or allyltriethoxysilane (Petrarch Systems Inc., Levittown, Pa., PN A0564) at a flow rate of 10 μL/min at room temperature. After 6 hours, the capillary is flushed with 100% methanol and then deionized water. The capillary is filled with a solution of 10% (v/v) 3-mercaptopropionic acid (Sigma-Aldrich, Milwaukee, Wis., PN M580-1) in a 3% aqueous hydrogen peroxide or a 50° C. solution of 10% (v/v) Thio-dPEG₄™ acid (Quanta BioDesign, Ltd., Powell, Ohio, PN 10247) in a 3% aqueous hydrogen peroxide and reacted for 12 hours at 10 μL/min. Then the capillary is flushed with deionized water.

The carboxylic acid capillary from above is filled with an aqueous solution of EDC (1-Ethyl-3-(3-dimethylaminopropyl)-carbodiimide (Sigma-Aldrich, Milwaukee, Wis., PN 16,146-2) and sulfo-NHS (sodium salt of N-hydroxysulfosuccinimide (Sigma-Aldrich, Milwaukee, Wis., PN 56485) 10% each (w/v) and reacted at room temperature for 6 hours. The capillary is flushed with deionized water and filled with the aqueous solution of the protein 10 mg/mL and reacted at room temperature for 2 hours. The capillary is flushed with deionized and stored at 4° C. until use.

### EXAMPLE 21

### Purifying a (His)₆ Fusion Protein

A capillary of dimensions 25 cm×100 μm ID is functionalized with an NTA-Ni(II) chelator bonded according to the procedure described in Example 13. The capillary is coiled “figure 8” type configuration with 6 mm diameter coils with 5 cm straight sections on top and bottom of the configuration. The capillary is connected to a syringe pump (Tecan Systems, San Jose, Calif., CAVRO Model No. XP-3000) fitted with 100 μl or 1 mL syringe connected at the end of the open tube column. The capillary is conditioned with 20 mM sodium phosphate, 0.5 M sodium chloride, 10 mM imidazole, pH 7.4 at the rate of 25 μl/min for 2 minutes. The buffer is expelled and the capillary is filled with a 100 μL sample of clarified lysate of E. coli expressing His₆ fusion protein. It is drawn repeatedly through the capillary at the rate of 25 μL/min for a total of 100 μL passing back and forth 2 times for a total of 4 passes through the capillary. The sample is blown out of the capillary and a small plug, 50 nL (approximately 7 mm in length), of desorption buffer, 20 mM sodium phosphate, 0.5 M sodium chloride, 0.5 M imidazole, pH 7.4 is passed through the capillary and deposited into a nano-well plate for subsequent arraying operations.

A capillary of same type is used except the inside diameter is 200 μm with a sample volume and buffer volumes 4 times greater.

### EXAMPLE 22

### Purifying a (His)₆ Fusion Protein Integrated With Arraying the Protein Onto a Protein Chip

A capillary of dimensions 25 cm×100 μm ID is functionalized with an NTA-Ni(II) chelator bonded according to the procedure described in Example 13. The capillary is coiled “figure 8” type configuration with 6 mm diameter coils with 5 cm straight sections on top and bottom of the configuration. The capillary is connected to a syringe pump (Tecan Systems, San Jose, Calif., CAVRO Model No. XP-3000) fitted with 100 μl or 1 mL syringe connected to one end of the open tube capillary, and the other end is movable and is connected to an apparatus where the materials may be taken up or deposited at different locations. The capillary is conditioned by drawing up 20 mM sodium phosphate, 0.5 M sodium chloride, 10 mM imidazole, pH 7.4 at the rate of 25 μL/min for 2 minutes. The buffer is expelled and the capillary is filled with a 100 μL sample of clarified whole-cell lysate of E. coli expressing a fusion protein with a His₆ tag and a terminal cysteine residue. The sample is drawn repeatedly over the capillary surface at the rate of 25 μL/min so that the total 108 μL sample passes back and forth 3 times for a total of 6 passes over the capillary surface. The remaining sample Is blown out of the capillary with 3 psi air, and 10 μL of standard PBS (0.9% w/v NaCl, 10 mM sodium phosphate, pH 7.2) wash buffer is drawn into and out of the capillary at a rate of 25 μL/min. This is done for a total of 3 cycles over the capillary surface, and the remaining wash solution is blown out of the capillary with 3 psi air. A small plug, 50 nL (approximately 7 mm in length), of desorption buffer, 20 mM sodium phosphate, 0.5 M sodium chloride, 0.5 M imidazole, pH 7.4 is drawn into the capillary, and is passed over the capillary surface a total of six times at a rate of 5 μL/min. This elution plug is positioned at the opening of the capillary column, and a portion (10 nL) is deposited on a bare gold grating-coupled SPR chip for covalent attachment through the terminal cysteine's thiol group. Attachment of proteins to gold surfaces via cysteine residues, along with descriptions of collecting GC-SPR data from these surfaces, has been described previously. (Jennifer Brockman et al., Poster Presentation “Grating-Coupled SPR,” Antibody Engineering Conference, Dec. 2-6, 2001, San Diego, Calif.).

### EXAMPLE 23

### Purifying a Monoclonal Human IgG Protein

A capillary of dimensions 35 cm×100 μm ID is functionalized with an extraction phase on a capillary of recombinant Protein G bonded according to the procedure described in Examples 14 or 16. The capillary is a straight configuration where one end is movable and connected to a pumping means and the other end is movable and connected to an apparatus where the material may be taken up or deposited at different locations. The pumping means is a 200 μL vial that may be filled with conditioning fluid, sample, washing fluid or nitrogen gas. The vial is filled with the various fluids by draining and forcing the old fluid out and then refilling with the new fluid several times until the vial is rinsed and ready for use. The vial is pressurized to force fluids through the capillary usually at a pressure of 0.1 to approximately 300 psi depending on the diameter and length of the capillary. For this capillary, a pressure of 3 psi is used.

The capillary is conditioned with 100 mM sodium phosphate, 100 mM sodium citrate, 2.5 M sodium chloride, pH 7.4 at the pressure of 3 psi for 10 minutes. The buffer is expelled and the capillary is pumped with 300 μL hybridoma cell culture supernatant sample (preferably, but not necessarily, free from fetal bovine serum) containing monoclonal human IgG. The capillary is washed with 100 mM sodium phosphate, 100 mM sodium citrate, 2.5 M sodium chloride, pH 7.4 at the pressure of 3 psi for 10 minutes. The washing step may be omitted in cases where the enrichment is high and a small amount of residual sample material can be tolerated.

The wash solution is blown out of the capillary and a small plug, 50 nL (approximately 7 mm in length), of desorption buffer of 100 mM sodium phosphate, 100 mM sodium citrate, pH 3.0 is pumped through the capillary and deposited directly into a vial containing 40 nL of neutralization buffer of 100 mM H₂NaPO₄/100 mM HNa₂PO₄, pH 7.5. Alternatively, the desorption solution is introduced as a stream rather than a segment of liquid. The desorption process is performed so that the leading edge of the stream contains the desorbed material and the first 2 cm length of the stream (150 nL) is directed and deposited in directly into a vial containing 40 nL of neutralization buffer of 100 mM H₂NaPO₄/100 mM HNa₂PO₄, pH 7.5. The remaining portion of the stream is directed to waste. Alternatively, the leading edge desorption process is performed directly into the wash buffer or the sample. The desorption buffer containing 100 mM sodium phosphate, 100 mM sodium citrate, adjusted to pH 3.0 is pumped into the capillary containing residual wash buffer or sample. In this example, for the rate at which the desorption buffer is pumped into the capillary, it will take 5.0 minutes for the leading edge to start to exit the end of the tube. The sample or wash in the capillary is directed to waste. Then, the flow for the time segment of 5.0-5.3 minutes is directed and deposited directly into a vial containing 40 nL of neutralization buffer of 100 mM H₂NaPO₄/100 mM HNa₂PO₄, pH 7.5. The remaining portion of the stream is directed to waste.

Alternatively, a Protein L capillary channel as described in Example 14 can be used in this example.

### EXAMPLE 24

### Purifying a Monoclonal Human IgG Protein With Arraying Onto a Protein A-Functionalized Protein Chip

A capillary of dimensions 100 cm×200 μm ID is functionalized with an extraction phase on a capillary of recombinant Protein G bonded according to the procedure described in Examples 14 or 16. The capillary is a straight configuration where one end is movable and connected to a pumping means and the other end is movable and is connected to an apparatus where the material may be taken up or deposited at different locations. The pumping means is a 200 μL vial that may be filled with conditioning fluid, sample, washing fluid or nitrogen gas. The vial is filled with the various fluids by draining and forcing the old fluid out and then refilling with the new fluid several times until the vial is rinsed and ready for use. The vial is pressurized to force fluids through the capillary usually at a pressure of 0.1 to approximately 300 psi depending on the diameter and length of the capillary. For this capillary, a pressure of 3 psi is used.

The capillary is conditioned with 100 mM sodium phosphate, 100 mM sodium citrate, 2.5 M sodium chloride, pH 7.4 at the pressure of 3 psi for 10 minutes. The buffer is expelled and the capillary is pumped with 1,000 μL hybridoma cell culture supernatant sample (preferably, but not necessarily, free from fetal bovine serum) containing monoclonal human IgG. The capillary is washed with 100 mM sodium phosphate, 100 mM sodium citrate, 2.5 M sodium chloride, pH 7.4 at the pressure of 3 psi for 10 minutes. The washing step may be omitted in cases where the enrichment is high and a small amount of residual sample material can be tolerated.

The wash solution is blown out of the capillary and a small plug, 2 μL (approximately 6.4 cm in length) of desorption buffer of 100 mM sodium phosphate, 100 mM sodium citrate, adjusted to pH 3.0 is pumped into the capillary. This segment of fluid is passed over the inner capillary surface a total of five (5) times at flow rate of 30 μL/min. The complete segment is then deposited directly into a 384-well plate where an individual well contains 2 μL of neutralization buffer of 100 mM H₂NaPO₄/100 mM HNa₂PO₄, pH 7.5. The sample is then arrayed by available means onto a Protein A-coated grating-coupled SPR (GC-SPR) chip, for subsequent analysis of target binding to the antibody. The apparatus, procedures and conditions used for preparation of the Protein A-coated GC-SPR chip, arraying of the chip, and collection of the associated SPR data have been described (Jennifer Brockman et al., Poster Presentation “Grating-Coupled SPR,” Antibody Engineering Conference, Dec. 2-6, 2001, San Diego, Calif.).

Alternatively, a Protein L capillary channel as described in Example 14 can be used in this example.

### EXAMPLE 25

### Purifying a Monoclonal Mouse IgG Protein

A capillary of dimensions 60 cm×200 μm ID is functionalized with an extraction phase on a capillary of recombinant Protein G bonded according to the procedure described in Examples 14 or 16. The capillary is positioned in a “figure 8” configuration with an 8 mm radius and two 5 cm straight sections for inlet and outlet and has been dipped polymerized a fast curing polyurethane mix (Tap Plastics Inc., Dublin, Calif.) to stabilize the capillary structure. The capillary is connected to a syringe pump (Tecan Systems, San Jose, Calif., CAVRO Model No. XP-3000) fitted with 1 mL syringe connected to one end of the open tube column. The capillary is conditioned with 20 mM sodium phosphate, pH 7.0 at the rate of 100 μL/min for 2 minutes. The buffer is expelled and the capillary is filled with a sample mouse IgG hybridoma cell culture supernatant, 800 μL. The desorption liquid segment may be drawn up and expelled one or several times. In this example, the segment is drawn repeatedly through the capillary at the rate of 100 μL/min for a total of 3200 μL passing back and forth 2 times for a total of 4 passes through the capillary. The sample is blown out of the capillary and a small plug, 200 nL (approximately 7 mm in length) of desorption buffer of 0.1 M glycine-HCl, pH 2.7 is passed through the capillary and deposited directly into a nano-well plate containing 100 nL of neutralization buffer (500 mM Tris-HCl, pH 9.0).

### EXAMPLE 26

### Separating Phosphorylated From Non-Phosphorylated Peptides Derived From Enzymatically Digested Erythrocyte Membrane Proteins

A capillary of dimensions 25 cm×100 μm ID is functionalized with an IDA iminodiacetic chelator with Fe(III) bonded according to the procedure described in Example 13 through γ-glycidoxypropyltrimethoxysilane (Sigma-Aldrich, Milwaukee, Wis., PN 44,016-7), with the iminodiacetic acid on the chelator attached through the epoxide group. The capillary is coiled a “figure 8” type configuration with 6 mm diameter coils with 5 cm straight sections on top and bottom of the configuration. The capillary is connected to a syringe pump (Tecan Systems, San Jose, Calif., CAVRO Model No. XP-3000) fitted with 100 μL or 1 mL syringe connected to one end of the open tube column. The capillary is conditioned with 50 mM MES (2-morpholinoethanesulfonic acid) buffer, pH 6.0 at the rate of 25 μL/min for 2 minutes. The buffer is expelled and the capillary is filled with a 25 μL sample of erythrocytes that are purified from plasma and leucocytes by the procedure given in reference: Guenther Bonn, et al., Chromatographia, 30 (9/10):484 (1990). The sample is drawn repeatedly through the capillary at the rate of 25 μL/min for a total of 100 μL passing back and forth 2 times for a total of 4 passes through the capillary. The sample is blown out of the capillary and a small plug, 50 nL (approximately 7 mm in length) of desorption buffer, 20 mM disodium EDTA, pH 6.0, is passed through the capillary and deposited directly into a vial.

A capillary of the same type is used except the inside diameter is 200 μm with a sample volume and buffer 4 times greater.

### EXAMPLE 27

### Antibody Screening with Label-Free Grating-Coupled SPR

Individual IgG antibody clones are expressed within hybridomas, where the hybridoma supernatant is passed through an open-tube separation capillary (Polymicro Technologies, Phoenix, Ariz.) of 200 μm ID and 50 cm, as described in Examples 22 and 23, with Protein G immobilized on the surface, as described in Example 14. Once the IgGs are trapped on the surface, the tube is washed with a suitable buffer (i.e. phosphate buffer saline, 10 mM phosphate, 100 mM NaCl, pH 7.0), and all fluids are blown out. A very small volume slug (1 μL) of 10 mM phosphoric acid (pH 2.3) is introduced to the tube, and is moved back and forth across the internal walls to desorb the IgG from the immobilized Protein G. IgG is ejected from the tube and into a nano-well plate having 250 nL of phosphate buffer (100 mM H₂NaPO₄/100 mM HNa₂PO₄, pH 7.5), bringing the pH to −7. This is then ready for non-covalent spotting onto a GC-SPR array, where the surface chemistry has Protein G covalently attached to mercapto undecanoic acid. In addition, the desorption/neutralization process can be performed as part of the arraying apparatus itself so that the antibodies are fully processed as part of a larger integrated chip preparation process.

### EXAMPLE 28

### Phage Display Screening of Fab Antibody Fragments with Label-Free Grating-Coupled SPR

Phage-derived clones for different Fab antibody fragment sequences are released as whole-cell bacterial lysates, where there are two fusion tags on the Fab antibody fragment—one c-myc (for purification) and the other a terminal cysteine residue (for immobilization). The clarified lysate is passed through an open-tube separation capillary (Polymicro Technologies, Phoenix, Ariz.) of dimensions 200 μm ID and 60 cm with Protein G, as described in Example 14, immobilized on its surface, and an anti-c-myc monoclonal or polyclonal antibody is bound by the Protein G (a bifunctional linker covalently attaches the antibody to the Protein G; the bifunctional linker is dimethylpimelimidate (DMP); procedure for successful crosslinking are provided within “ImmunoPure Protein G IgG Orientation Kit” instructions (Pierce, Rockford, Ill., PN 44896). Once the Fab antibody fragment is trapped by the anti-c-myc antibody on the inside tube wall, a very small volume slug (1 μL) of 10 mM phosphoric acid (pH 2.3) is introduced to the tube, and is moved back and forth across the internal walls to desorb the Fab antibody fragment from the immobilized anti-c-myc. This is ejected from the tube into 250 nL of phosphate neutralization buffer (100 mM H₂NaPO₄/100 mM HNa₂PO₄, pH 7.5), bringing the pH to ˜7.0. This Is then ready for covalent spotting onto a grating-coupled surface plasmon resonance array (GC-SPR), where the surface chemistry is based upon the terminal cysteine's thiol group bonding with the gold surface of the GC-SPR chip. In addition, the desorption/neutralization process can be performed within the spotting apparatus itself so that the Fab antibody fragments are fully processed as part of a larger integrated chip preparation process.

In addition to Protein G, Protein A or Protein A/G (as described in Example 14) may be used in the procedures described in this example.

### EXAMPLE 29

### Preparing a Glutathione Capillary Channel

A 100 μm ID 25 cm length unchelated IDA fused silica capillary prepared according to the procedure described in Example 13 is flushed with deionized water and then is treated with a 0.1 M solution of Hg(NO₃)₂.H₂O at a flow rate of 2 μL/min for 2 hours. The capillary is flushed with deionized water and then reacted with a 5 mg/mL solution of reduced monomeric glutathione (Sigma-Aldrich, Milwaukee, Wis., PN G4251) at a flow rate of 2 μL/min for 1 hour. The capillary is flushed with deionized water and stored in a refrigerator.

### EXAMPLE 30

### Procedure for Protein-Protein Interaction Screening by Fluorescence Imaging

Different recombinant yeast proteins are released as whole-cell yeast lysates, the vector descriptions and lysis conditions of which are described in Heng Zhu, et al., Science, 293:2101 (2001), where there are two fusion tags on every protein—one (Glutathione S-transferase) GST (for purification) and the other a terminal 6-HIS tag (for immobilization). The clarified lysate (25 μL) is passed through an open-tube separation capillary (Polymicro Technologies, Phoenix, Ariz.) of dimensions 150 μm ID and 40 cm with glutathione immobilized on its surface, as described in Example 29. Once the protein is trapped by the glutathione on the inside tube wall, a very small volume slug (0.5 μL, approximately 2.8 cm in length) of 20 mM glutathione is Introduced to the tube, and is moved back and forth across the internal walls to desorb the protein (via competition for the GST). This is ejected from the tube, and is ready for arraying onto a nickel-coated array surface through the HIS₆ tag, as described in Heng Zhu, et al., Science, 293:2101 (2001). At this point the “target” protein that is being screened for its various interaction partners on the array is biotinylated and introduced to the array. Cy3-labeled streptavidin is introduced to the chip to detect those spots where the target is bound, which is determined by standard fluorescence imaging. The conditions related to target introduction, washing, detection, and other conditions related to the protein array are described in Heng Zhu, et al., Science, 293:2101 (2001).

### EXAMPLE 31

### Preparing a Quantifying Chip for Monitoring Antigen Protein Levels by Fluorescence Imaging

A capillary channel of dimensions 150 μm ID and 40 cm length with Protein G immobilized on its surface is prepared according to procedures described in Examples 9, 14 or 20. A pumping means, a 1.0 mL syringe pump (Tecan Systems, San Jose, Calif., CAVRO Model No. XP-3000) is connected to one end of the capillary. The capillary is flushed with deionized water. Then, an anti-phosphotyrosine (anti-pY) monoclonal antibody (BD Biosciences, PN 610430) is bound by to the Protein G surface by passing a 1 mg/mL aqueous solution of anti-pY through the capillary at a rate of 1 μL/min for 15 minutes and then flushing the capillary with deionized water. After forming the Protein G surface, a bifunctional linker dimethyl pimelimidate (DMP) is used to covalently anchor or crosslink the antibody to the surface. The reagents used to crosslink and to block residual groups are from ImmunoPure® Protein G IgG Orientation Kit (Pierce, Rockford, Ill., PN 44896). The procedures for cross-linking the antibody and blocking residual unreacted sites are provided by Pierce (Rockford, Ill.) in the associated instructions. Each of the reagents in the kit is pumped through the capillary at a rate of 1 μL/min for 30 minutes and the anti-pY antibody capillary is flushed with deionized water.

Five hundred μL of a clarified cell lysate (prepared according to the procedure described in Huilin Zhou, et al., Nature Biotech., 19:375 (2001)) is passed through the capillary at a rate of 25 μL/min. This process isolates and enriches the phosphorylated protein fraction and also eliminates any potentially confounding/interfering proteins such as albumin. Once the phosphorylated antigen proteins (i.e. phosphorylated at the tyrosine region) are trapped by the anti-pY antibody capillary, and the capillary is washed with PBS (0.9% w/v NaCl, 10 mM sodium phosphate, pH 7.2). The liquid is blown out with nitrogen gas and then a very small volume slug (0.5 μL, approximately 2.8 cm in length) of 10 mM phosphoric acid (pH 2.3) is introduced to the tube, and is moved back and forth across the internal walls with 2 cycles to desorb the phosphorylated proteins from the capillary channel. The liquid segment is ejected from the tube into 125 nL of phosphate buffer (100 mM H₂NaPO₄/100 mM HNa₂PO₄, pH 7.5), bringing the pH to 7.0±0.2.

The purified proteins in the collected sample are then labeled with either Cy5 or Cy3. The labeled purified phosphorylated protein samples are applied to a glass slide having an array of antibodies. Each spot of the array has a different antibody directed against a different phosphorylated protein. The presence or absence of each particular antigen protein is measured by fluorescence imaging. The results are compared to that obtained from a control sample. Descriptions of various labeling and array procedures are described at BD Biosciences Clontech, Antibody Microarrays User Manual, PN K1847-1, PT 3648-1 (PR2×045) Published Oct. 14, 2002.

### EXAMPLE 32

### Attaching Avidin to a Fused Silica Capillary Channel

A 200 μm ID 100 cm length capillary is etched according to Examples 1 or 2. The capillary is filled with a 50° C. 10% w/v glycidoxypropyl-trimethoxysilane (Sigma-Aldrich, Milwaukee, Wis., PN 44,016-7) in dry toluene, and then the capillary is heated under slow flow conditions of 2 μL/min for 4 hours. The capillary is cooled, washed for 30 minutes each with toluene and methanol, and then deionized water. The capillary is filled with solution of monomeric avidin solution (20 mg/ml in 10 mM phosphate buffer, pH 8.5) The protein may be native monomeric avidin which will attach through native lysine residues or recombinant avidin which will attach through a poly-lysine fusion tag at the protein terminus. Native monomeric avidin can be purchased from Bioline (London, UK) or can be prepared according to the procedure described by Green, Avidin and Streptavidin Method Enzymol., 184:51 (1990). The capillary is reacted by pumping the protein solution through capillary at 1 μL/min at 25° C. for 4 hours. The capillary is flushed and conditioned with 10 mM phosphate buffer solution pH 7.0 for 1 hour and then flushed and stored with deionized water at 4° C. until used.

Alternatively, multimeric, such as recombinant tetrameric avidin (Sigma-Aldrich, Milwaukee, Wis., PN A8706) may be used as described in this example.

### EXAMPLE 33

### Enriching and Purifying Isotope-Coded Affinity Tagged (ICAT) Peptides Using Avidin Open-Tube Capillaries

The primary purpose in this example is the enrichment and purification of isotope-coded affinity tagged (ICAT) peptides, achieved through monomeric avidin affinity groups. Monomeric avidin descriptions and preparations can be found in N. Michael Green, Methods Enzymol., 184:51 (1990). A single-use open-tube extraction column (produced as described in Example 32), is used in conjunction with a syringe pump of 100 μL or 1 mL. Ion-exchange fractionated peptides (approximately 10 μg, or 0.5-1 mL) are introduced to the monomeric avidin capillaries (Polymicro Technologies, Phoenix, Ariz.) of dimensions 200 μm ID and length 1 meter. Once introduced, the sample is passed over the surface at 100 μL/min for a total of four times. The biotinylated peptides (on the order of 1 μg or less) will selectively trap onto the surface of the monomeric avidin capillary. The capillaries are washed with water at 100 μL/min for 5 minutes, and the water is blown out. The biotinylated peptides are eluted into 1 μL (approximately 3.2 cm in length) of 0.3% formic acid by passing this elution slug over the monomeric avidin surface a total of four times at 20 μL/min. The elution zone containing the peptides are pushed out of the capillary, and are then separated by means of pLC-MS/MS, as described in Steven Gygi, et al., Nature Biotech., 17:994 (1999); David Han, et al., Nature Biotech., 19:946 (2001).

### EXAMPLE 34

### Enriching Isotope-Coded Affinity Tagged (ICAT) Peptides with Mass Spectrometric Identification of the Peptides

The primary purpose in this example is the enrichment and purification of isotope-coded affinity tagged (ICAT) peptides, achieved through monomeric avidin affinity groups. Monomeric avidin descriptions and preparations can be found in N. Michael Green, Methods Enzymol., 184:51 (1990). A single-use open-tube extraction column (produced as described in Example 32), is used in conjunction with a syringe pump of 100 μL or 1 mL. Ion-exchange fractionated peptides (approximately 10 μg, or 0.5-1 mL) are introduced in the monomeric avidin capillaries (Polymicro Technologies, Phoenix, Ariz.) of dimensions 200 μm ID and 1 meter. Once introduced, the sample is passed over the surface at 100 μL/min for a total of four times. The biotinylated peptides (on the order of 1 μg) will selectively trap onto the surface of the monomeric avidin capillary. The capillaries are washed with water at 100 μL/min for 5 minutes, and the water is blown out with pressurized air. The biotinylated peptides are eluted into 1 μL (approximately 3.2 cm in length) of 0.3% formic acid by passing this elution slug over the monomeric avidin surface a total of six times at 20 μL/min. The elution zone containing the peptides are pushed out of the capillary and onto a specified X-Y location of a matrix-assisted laser desorptionaonization (MALDI) target, which is facilitated through the application of a device for integrating chromatographic separations with MALDI target preparation (LC Packings, S. San Francisco, Calif., Probot™ Micro Fraction Collector). This same device can be used for placing an equal volume of energy-absorbing matrix solution, which are described in detail along with other MALDI-related descriptions (Martin Yarmush, et al., Annu. Rev. Biomed. Eng., 4:349 (2002)). Once the MALDI target is adequately prepared, it undergoes mass spectrometric analysis for the identification and measurement of relative abundance of the peptides. This is performed in a manner described previously (Martin Yarmush, et al., Annu. Rev. Biomed. Eng., 4:349 (2002); Timothy Griffin, et al., J. Biol. Chem, 276:45497 (2001)).

### EXAMPLE 35

### Extracting Multi-Protein DNA-Binding Complexes With Mass Spectrometric Identification of the Complex Composition

A 150 μm ID 75 cm length capillary is etched according to Examples 1 or 2. The capillary is then filled with a 650 C₄% (v/v) solution of 3-aminopropyltriethoxysilane in methanol and reacted for 12 hours at a slow flow of 1 μL/min. After flushing with 100% methanol and then deionized water, the tube is filled with a 5.0 mg/mL NHS-LC biotin (N-hydroxysuccinimido-biotin, Sigma-Aldrich, Milwaukee, Wis., PN H1759) in 50 mM sodium bicarbonate solution pH 8.3 and reacted for 4 hours at room temperature. Following biotinylation the capillary is flushed with deionized water and then the capillary is filled with 4.0 mg/ml solution of streptavidin (Sigma-Aldrich, Milwaukee, Wis., PN SO677) in 50 mM sodium phosphate buffer (pH 7.3). The streptavidin solution is reacted for 4 hours at 4° C. and any remaining free streptavidin is removed by rinsing the capillary tube with deionized water.

DNA sequences being screened for their interactions with multi-protein complexes are prepared. In all cases the target sequence is biotinylated at its 5′ end. An example of mulit protein complexes are described in Eckhard Nordhoff, et al., Nature Biotech., 17:884 (1999). Short single-stranded biotinylated DNA (<50 bp) is prepared by standard DNA synthesis techniques (i.e. oligonucleotide synthesis). Long single-stranded biotinylated DNA (≧50 bp) is prepared by standard PCR techniques, whereby one or both of the PCR primers is 5′-labeled with biotin. The primers are removed after the PCR reaction by standard purification techniques, including DNA Chromatography (Douglas Gjerde, et al., DNA Chromatography, Chapter 6, Wiley-VCH, Weinheim, Germany (2002)). The purified PCR product is then heated to >95° C and then cooled immediately to 4° C. to produce single-stranded biotinylated DNA. Long double-stranded biotinylated DNA (>50 bp) is prepared in the manner identical to the single-stranded variety, except for elimination of the final heat denaturation and cooling step.

Once the biotinylated DNA of interest is suitably prepared, it is allowed to incubate with the proteins being screened for their DNA interactions. The proteins will most often be derived from whole-cell extracts, nuclear extracts, or any other source of DNA-binding proteins that have been prepared by standard means. Biotinylated DNA (100 ng) is added to the extract and is allowed to incubate in the manner described previously for extraction of DNA-binding proteins (Eckhard Nordhoff, et al., Nature Biotech., 17:884 (1999)). Once the incubation is complete, the unbound biotinylated DNA is removed from the sample by its selective precipitation with polyethyleneimine (PEI), in the manner described previously for the precipitation and removal of DNA (Jesper Svejstrup, et al., Proc. Natl. Acad. Sci. USA, 94:6075 (1997)). Once the unbound DNA is removed, the entire sample that contains the protein-bound biotinylated DNA is introduced into the streptavidin capillary described above. The entire sample is fully drawn up into and pushed out of the capillary at a flow rate of 50 μL/min, and this action is repeated 5 times. Once completed, the capillary is washed by separately drawing up and pushing out to waste 15 μL of water at 100 μL/min, and this action is repeated 5 times. The capillary is then evacuated by flowing 10 psi of air through the capillary for 30 seconds. A single 1 μL segment (approximately 5.6 cm in length) of 50% methanol/50% water is then fully drawn into the capillary, and passing this elution slug over the entire streptavidin surface a total of 5 times at 20 μL/min. The entire 1 μL elution volume that contains the eluted proteins bound to the original DNA sequence is then pushed into an electrospray nozzle (Advion NanoMate™ 100, Advion BioSciences, Inc., Ithaca, N.Y.; Nanospray needle holder, PN NSI-01 and NSI-02, Nanospray needles, PN NSI-NDL-01 and NSI-NDL-02, LC Packings Inc., San Francisco, Calif.), which is in turn analyzed by ESI-MS/MS (examples of such electrospray nozzles, and their use with MS and MS/MS are described at Xian Huang, et al., Proceedings of the 50^{th} ASMS Conference on Mass Spectrometry and Allied Topics, Orlando, Fla., Jun. 2-6, 2002. The ESI-MS/MS is then used for identification of the proteins that comprise the DNA-binding complex, in a manner described previously (Martin Yarmush, et al., Annu. Rev. Biomed. Eng., 4:349 (2002)).

### EXAMPLE 36

### Influence of Tortuous-Flow in Open Tubular Solid Phase Extraction of Proteins

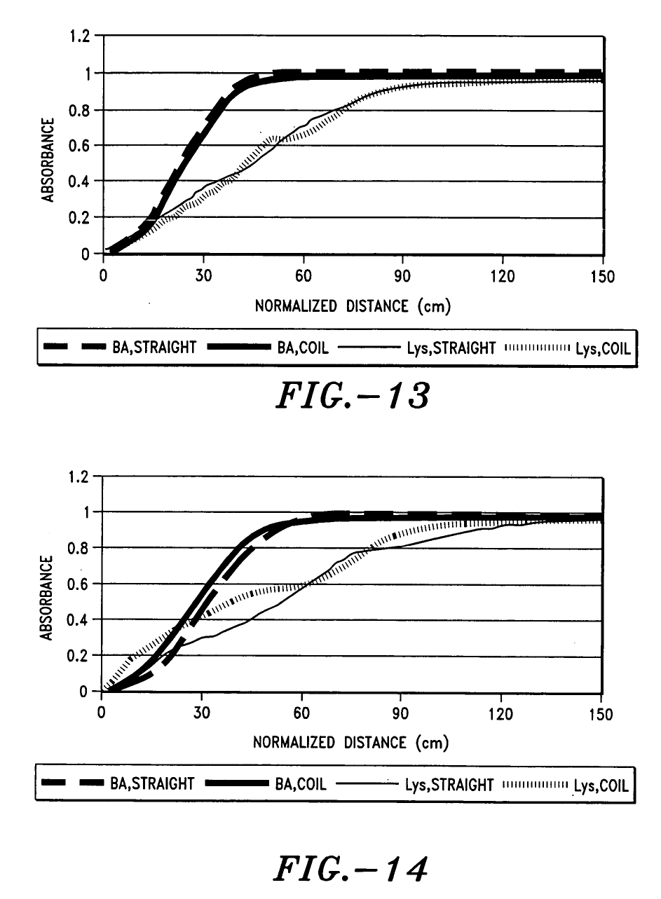

Two silica tubes coated with polyimide columns with dimensions 200 μm ID, 360 μm OD, and 63 cm length were prepared in two different configurations. Configuration number one was used in an uncoiled or “straight” form, the form designated as “straight” with respect to data in FIGS. 13-17, and 19. Configuration number two was coiled in a continuous series of “figure-eights.” The average diameter of each loop within each configuration was 9 mm with 55 cm of the total 63 cm column length coiled in this manner and with 4 cm of straight tubing on either side of the coiling. These coils are designated as coils in FIGS. 13-18, and 20. The “coil” column was embedded in fast-curing polyurethane to maintain the shape and mechanical integrity of the capillary channel while leaving the inlet and outlet fully exposed. Both configurations were washed with 0.1 M NaOH for 60 min, washed with deionized water for 15 min, washed with 0.1 M HCl for 15 min, then finally washed with deionized water for 60 min all at a flow rate of 120 μL/min.

The system was plumbed with two 3-way valves and one T-piece (Upchurch, Oak Harbor, Wash.) so that either 20 mM Tris-HCl buffer (pH 8), lysozyme or benzyl alcohol was introduced into each capillary by a 2.5 mL syringe pump (Tecan Systems, San Jose, Calif., CAVRO Model No. XP-3000). Detection was achieved in real-time through a UV-transparent window burned into the polyimide coating 2 cm from the end of the column, and the window is placed within the light path of a Linear Model Spectra 200 UV detector set to wavelength 215 nm. The capillary was conditioned with Tris-HCl buffer at 120 μL/min for 5 minutes. Then the flow was stopped and either 2 mg/mL lysozyme or 0.01% benzyl alcohol neutral marker was introduced at flow rates of 60, 120, 300 and 600 μL/min, with the absorbance signal collected in real-time. Absorbance readings at 3 Hz data rate were used to monitor the breakthrough of benzyl alcohol neutral marker and lysozyme flowing through the capillary. At the start of the experiment, absorbance is zero. As the benzyl alcohol or lysozyme start to break through the capillary column, the absorbance increases. The absorbance continues to increase until the concentration of the material entering the capillary is equal to the concentration leaving the capillary. At this time, the signal is at equilibrium and there is 100% breaththrough of the material. Once the signal from the lysozyme reached equilibrium, the same solution Tris-HCl buffer was passed through the tube once again to wash out any excess (i.e. unbound) lysozyme. The Tris-HCl was then replaced with 0.1 M HCl, which was then introduced to the capillary at 120 μL/min to elute or desorb the lysozyme. The desorbed lysozyme peak was detected via absorbance readings in real-time (3 Hz, 215 nm).

FIGS. 13-16 can be referred to as “breakthrough” curves. FIG. 13 shows breakthrough curves for neutral marker (benzyl alcohol) and lysozyme at 60 μL/min. The dashed line represents benzyl alcohol (straight channel); dark shaded line represents benzyl alcohol (coil channel); straight line represents lysozyme (straight channel); and light shaded line represents lysozyme (coil channel).

FIG. 14 shows breakthrough curves for neutral marker (benzyl alcohol) and lysozyme at 120 μL/min. The dashed line represents benzyl alcohol (straight channel); dark shaded line represents benzyl alcohol (coil channel); straight line represents lysozyme (straight channel); and light shaded line represents lysozyme (coil channel).

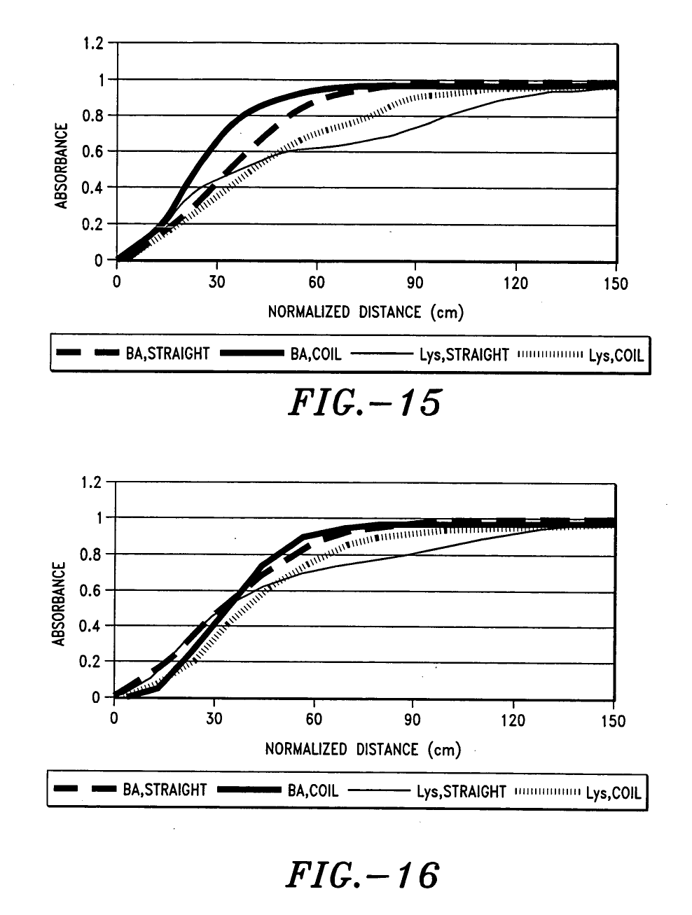

FIG. 15 shows breakthrough curves for neutral marker (benzyl alcohol) and lysozyme at 300 μL/min. The dashed line represents benzyl alcohol (straight channel); dark shaded line represents benzyl alcohol (coil channel); straight line represents lysozyme (straight channel); and light shaded line represents lysozyme (coil channel).

FIG. 16 shows breakthrough curves for neutral marker (benzyl alcohol) and lysozyme at 600 μL/min. The dashed line represents benzyl alcohol (straight channel); dark shaded line represents benzyl alcohol (coil channel); straight line represents lysozyme (straight channel); and light shaded line represents lysozyme (coil channel).

FIG. 17 shows breakthrough curves for neutral marker (benzyl alcohol) at 60 μL/min, and lysozyme at 60 μL/min and 600 μL/min. Dark shaded line represents benzyl alcohol (coil channel) at 60 μL/min; medium shaded line represents lysozyme (coil channel) at 60 μL/min; and light shaded line represents lysozyme (coil channel) at 600 μL/min.

In all of the figures, the dashed and straight lines represent data collected from the “straight” column, and the dark and light shaded lines represent data collected from the “coil” column. In addition, data in FIGS. 12-15 have all been normalized. Instead of plotting the normalized signal intensities as a function of time, each time point is multiplied by the linear velocity (in cm/sec) for that particular flow rate. This results in a normalized distance (i.e. cm) on the x-axis, which in turn makes it possible to perform direct comparisons between the different flow rates. For a 200 μm ID capillary the linear velocities for each flow rate investigated were: 3.18 cm/sec for 60 μL/min; 6.36 cm/sec for 120 μL/min; 15.90 cm/sec for 300 μL/min; 31.80 cm/sec for 600 μL/min.

FIG. 13 shows that a neutral small molecule (benzyl alcohol) that has no interaction with the wall and reaches a state of equilibrium as quickly in the coiled configuration as in the straight configuration (since the dashed line and dark shaded line entirely overlay each other). FIG. 1 also shows that a protein molecule (lysozyme) has an interaction with the wall (adsorbs to the wall) and reaches a state of equilibrium (100% breakthrough) considerably later than the benzyl alcohol. This is reasonable, since the lysozyme interacts with the wall surface as the protein is coming to equilibrium—hence the shift in the lysozyme curves to the right (FIG. 13). However, as with the benzyl alcohol neutral marker, the lysozyme reaches a state of equilibrium as quickly in the coiled configuration as in the straight configuration (since the straight line and light shaded line almost entirely overlay each other).

FIGS. 14-16 demonstrate the effect of increasing the flow rate and how this results in a more pronounced difference between coiled and straight reactors. In all three of these figures (FIGS. 14-16), the data for the neutral marker (dashed line and dark shaded lines) shows only modest (if any) differences between the coil and straight column, in particular with respect to how quickly the signal comes to equilibrium. However, in the case where the lysozyme was introduced breakthrough curve is shallower, i.e. it takes longer to achieve 100% breakthrough as the flow rate was increased. The effect increases with flow rate for the straight capillary. However, the effect is less pronounced and even decreases with flow rate with the coiled capillary. For example in FIGS. 14-16 the lysozyme curve for the straight column (straight lines) is always shallower in slope than the lysozyme curve for the coiled column (light shaded lines). This shallower slope for the straight column data indicates that the lysozyme takes longer to come to be “consumed” by the walls in cases where there is nothing to help push it towards the walls, and that this effect is increasingly pronounced as the flow rate increases. On the other hand, the steeper slope for the coiled column (light shaded lines) indicates that the lysozyme is being “consumed” by the walls more efficiently as a result of the flow tortuosity pushing the protein towards the walls. In addition, the highest flow rate (as shown in FIG. 17) indicates a decreasing distance gap between the neutral marker and lysozyme as compared to the slowest flow rate (as shown in FIG. 13). This indicates that the combination of tortuosity with high flow rates creates a condition where radial flow is increased. This observation is consistent with those made by others in different contexts (R. Tijjsen, Sep. Sci. Technol., 13:681 (1978)).

In fact, as shown in FIG. 17, the breakthrough curve for a coiled column at 600 μL/min is virtually identical to a breakthrough curve for a coiled column (or straight column, for that matter) at 60 μL/min. This indicates that protein samples can be processed at least ten times faster if there is a tortuous flow path that helps to ensure efficient radial transfer of protein to the BOTSPE column wall.

An experiment was performed to determine if the extraction capacity of the capillary channel was affected by the configuration of the channel (whether it was straight or coiled) or affected by the flow rate at which the protein was adsorbed. The lysozyme was adsorbed under coiled and straight configurations and at two flow rates, 60 μL/min and 600 μL/min. Tris-HCl buffer was pumped through the tube to wash out any excess (i.e. unbound) lysozyme. Then 0.1 M HCl was pumped at 120 μL/min flow rate to desorb the lysozyme which was detected as a peak.

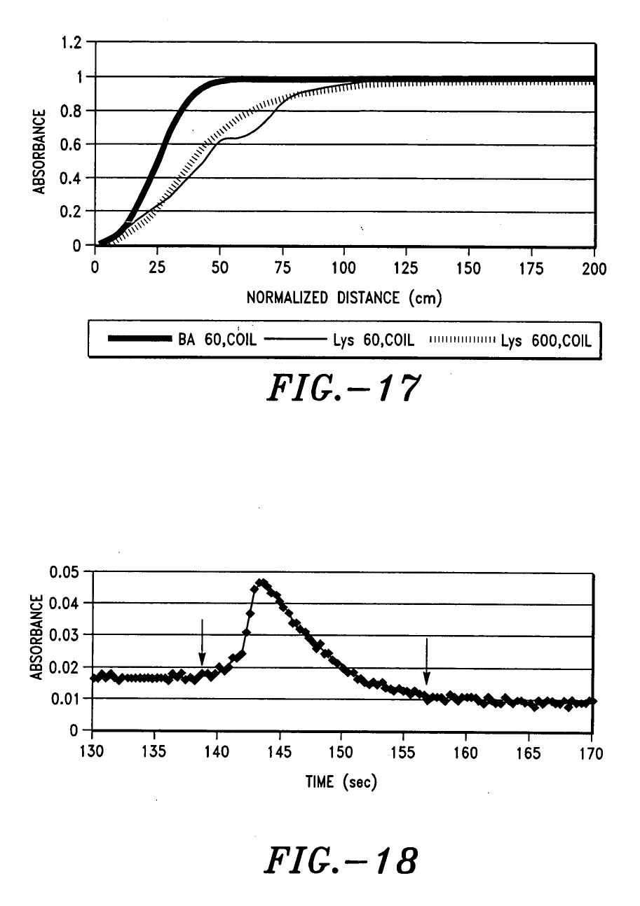

The graphs in FIGS. 18-20 show the results of this experiment. FIG. 18 shows breakthrough curves for lysozyme eluted from a coil channeled column, loaded at 60 μL/min. Arrows indicate the limits of the integration window (start of peak integration at 139.1 sec. and finish of peak integration at 156.6 sec.). The integrated peak area is 0.118 Abs-sec.

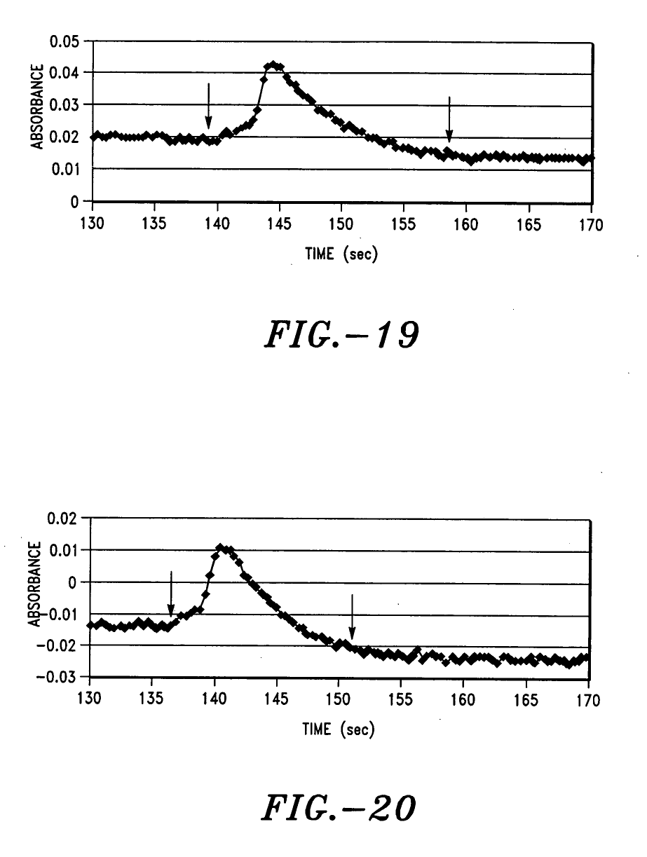

FIG. 19 shows breakthrough curves for lysozyme eluted from a straight channel column, loaded at 60 μL/min. Arrows indicate the limits of the integration window (start of peak integration at 139.5 and finish of peak integration at 157.8). The integrated peak area is 0.147 Abs-sec.

FIG. 20 shows breakthrough curves for lysozyme eluted from a coil channel column, loaded at 600 μL/min. Arrows indicate the limits of the integration window (start of peak integration at 136.5 sec. and finish of peak integration at 151.3 sec.). The integrated peak area is 0.138 Abs-sec.

From the peak integration data, it is shown that the amount of lysozyme material trapped and recovered from the surface is independent of the conditions used for the trapping (i.e. the amount is independent of the capillary channel configuration and protein adsorption flow rate). Therefore, the different adsorption conditions influence only the efficiency at which this capillary capacity is reached and do not affect the capacity amount itself.

### EXAMPLE 37

### Purification of Endothelial Cell Growth Factor (ECG) Using Heparin Affinity Capillary Channel

Endothelial cell growth factor (ECG) as described in U.S. Pat. No. 4,882,275 is useful in therapeutics, as an additive for cell culturing, and to raise antibodies that are used in therapeutics and in ECG immunoassays. A capillary of dimensions 150 μm ID and 25 cm length is functionalized with a heparin group bonded according to the procedure described in Example 18. The capillary is in a straight tube configuration. The capillary is connected to a syringe pump (Tecan Systems, San Jose, Calif., CAVRO Model No. XP-3000) fitted with 100 μl or 1 mL syringe connected to one end of the open tube capillary, and the other end is movable and is connected to an apparatus that can be used to collect the purified material into a small vial.

ECG from various sources, including mammalian hypothalamus, pituitary, cartilage, retinal, and brain tissue, possesses a strong and specific affinity for heparin. This strong affinity of ECG for heparin enables removal of undesired impurities from a mixture by: (a) contacting immobilized heparin with the mixture to form a heparin-ECG complex; (b) washing uncomplexed mixture from the channel; and (c) contacting the complex with a salt solution and pH effective to desorb and remove the ECG from the channel. A tissue sample containing swarm rat chondrosarcoma-derived growth factor is prepared according to a procedure described in U.S. Pat. No. 4,882,275. The capillary is flushed and conditioned with 50 μL of a solution of 0.1 M NaCl and 0.01 M Tris-HCl, pH 7.0. Then 200 μL of the clarified sample is passed through the capillary for a total of 4 passes. The capillary is washed with 25 μL of a solution of 0.1 M NaCl and 0.01 M Tris-HCl, pH 7.0. The solution is blown out and the ECG is desorbed with a 10 cm segment solution of 3 M NaCl and 0.01 M Tris-HCl, pH 7.0. The segment is deposited to a vial for use.

### EXAMPLE 38

### Purification of Specific Nucleic Acid Sequence Using a Nucleic Acid Modified Capillary Channel

A 100 μm ID and 25 cm length capillary is prepared with a single strand DNA group prepared according described in Example 15. The nucleic acid strand attached to the capillary channel is a 20 mer oligonucleotide with a sequence of attgcccgggtttaatagcg. The capillary is a straight configuration connected to a syringe pump (Tecan Systems, San Jose, Calif., CAVRO Model No. XP-3000) fitted with 100 μl or 1 mL syringe connected to one end of the open tube capillary, and the other end is movable and is connected to an apparatus where the materials may be taken up or deposited at different locations.

A 50 μL solution containing 0.01 μg of 20 mer oligonucleotide with the complementary sequence of taacgggcccaaattatcgc in 10 mM sodium phosphate buffer, pH 7.0 is passed through the capillary at a rate of 10 μL/min at room temperature and the sample nucleic acid is hybridized to the complementary strand attached to the channel wall. The tube is washed with 10 μL of 100% deionized water and is expelled from the capillary. The capillary is placed in an oven and a hot 90° C. solution of 10 cm segment of solution of 10 mM Tris-HCl 0.1 mM EDTA (disodium salt) pH 8.0 is passed slowly through the capillary channel denaturing and desorbing complementary strand of nucleic acid and depositing the denatured nucleic into a vial.

### EXAMPLE 39

### Preparation of a Hydrophobic Capillary Channel Suitable for Hydrophobic Interaction of a Protein

A 200 μm ID 50 cm length capillary is prepared with a carboxylic acid group according to the procedure described in Example 7. Alternatively, the carboxylic acid capillary can be formed by 2 other synthesis routes. In Route 1, the capillary prepared from the procedure in Examples 1 or 2 is filled with 70° C. solution of neat thionyl chloride and reacted for 12 hours at 10 μL/min. The capillary is flushed with dry THF and then filled a 50° C. solution 20% (v/v) of vinylmagnesium bromide in tetrahydrofuran (THF) (Sigma-Aldrich, Milwaukee, Wis., PN 25,725-7) and reacted for 12 hours at 10 μL/min. The capillary is flushed with THF and then deionized water. The capillary is filled with a solution of 10% (v/v) 3-mercapto propionic acid (Sigma-Aldrich, Milwaukee, Wis., PN M580-1) in a 3% aqueous hydrogen peroxide or a 50° C. solution of 10% (v/v) Thio-dPEG₄™ acid (Quanta BioDesign, Powell, Ohio, PN 10247) in a 3% aqueous hydrogen peroxide and reacted for 12 hours at 2 μL/min. Then the capillary is flushed with deionized water. In Route 2, the capillary is prepared from the procedure in Examples 1 or 2 is filled and reacted with a neat solution of allyldimethylchlorosilane (Petrarch Systems Inc., Levittown, Pa., PN A0552) or allyltriethoxysilane (Petrarch Systems Inc., Levittown, Pa., PN A0564) at a flow rate of 1 μL/min at room temperature. After 6 hours, the capillary is flushed with 100% methanol and then deionized water to stop the reaction. The capillary is filled with a solution of 10% (v/v) 3-mercaptopropionic acid (Sigma-Aldrich, Milwaukee, Wis., PN M580-1) in a 3% aqueous hydrogen peroxide or a 50° C. solution of 10% (v/v) Thio-dPEG₄™ acid (Quanta BioDesign, Ltd., Powell, Ohio, PN 10247) in a 3% aqueous hydrogen peroxide and reacted for 12 hours for 2 μL/min. Then the capillary is flushed with deionized water.

The carboxylic acid capillary from above is filled with an aqueous solution of EDC (1-Ethyl-3-(3-dimethylaminopropyl)-carbodiimide) (Sigma-Aldrich, Milwaukee, Wis., PN 16,146-2) and sulfo-NHS (sodium salt of N-hydroxysulfosuccinimide) (Sigma-Aldrich, Milwaukee, Wis., PN 56485) 10% each (w/v) and reacted at room temperature for 6 hours. The capillary is flushed with deionized water and then 100% methanol and then filled with 10% (w/v) solution of 4-phenylbutylamine in methanol and reacted at room temperature for 2 hours. The capillary is flushed with 100% methanol and stored at 4° C. until use.

Alternatively, a 200 μm ID 100 cm length capillary is etched according to Examples 1 or 2. The capillary is filled with a 50° C. neat solution of phenethyltrimethoxysilane (Gelest, Tullytown, Pa., PN SIP6722.6) and then the capillary is heated under slow flow conditions of 1 μL/min for 4 hours at 2 pumin. The capillary is cooled, washed for 30 minutes each with toluene and then 100% methanol.

### EXAMPLE 40

### Desalting a Protein Using a Hydrophobic Capillary Channel

A capillary of dimensions 200 μm i.d and 50 cm length is functionalized with a hydrophobic surface bonded according to the procedure described in Example 39. Alternative, a capillary of dimensions 200 μm i.d and 50 cm length is functionalized with a hydrophobic C₁₈ surface bonded according to the procedure described in Example 12. The capillary is coiled “figure 8” type configuration with 6 mm diameter coils with 5 cm straight sections on top and bottom of the configuration. The capillary is connected to a syringe pump (Tecan Systems, San Jose, Calif., CAVRO Model No. XP-3000) fitted with 100 μl or 1 mL syringe connected to one end of the open tube capillary, and the other end is movable and is connected to an apparatus where the materials may be taken up or deposited at different locations.

The sample is a 200 μl solution containing 0.1 μg of IgG proteins in a 1.5 M ammonium sulfate buffer. The sample is introduced into the capillary by passing the solution back and forth for 3 cycles and the protein is adsorbed to the hydrophobic phase of the capillary channel. The remaining sample solution is blown out of the capillary and a small 10 cm segment of 100% deionized water is passed through the capillary, desorbing the protein from the wall and the sample is deposited into a vial for analysis.

### EXAMPLE 41

### Procedure for Purification of Protein Kinase a with a Reverse Phase Capillary Channel and Ion Pairing Reagent

A capillary of dimensions 100 μm ID and 25 cm length is functionalized with a reverse phase surface bonded according to the procedure described in Example 12. The capillary is a straight configuration connected to a syringe pump (Tecan Systems, San Jose, Calif., CAVRO Model No. XP-3000) fitted with 100 μL syringe connected to one end of the open tube capillary, and the other end is movable and is connected to an apparatus where the materials may be taken up or deposited at different locations.

The sample is a 100 μL solution containing 0.1 μg of Protein kinase A in a phosphate buffer saline (0.9% w/v NaCl, 10 mM sodium phosphate, pH 7.2) (PBS) buffer. Ten μL of 10% aqueous solution of trifluoroacetic acid (TFA) is added so that the final volume of the solution is 110 μL and the concentration of the TFA in the sample is 0.1%. The sample is introduced into the capillary and the protein/TFA complex is adsorbed to the reverse phase of the capillary channel.

The sample is blown out of the capillary and a small 10 cm segment of 50% (v/v) acetonitrile/water is passed through the capillary, desorbing the protein from the wall and the sample is deposited into a vial for analysis.

Alternatively, the capillary channel may be washed with 10 μL of aqueous 0.1% TFA. This solution is ejected from the capillary channel and the protein is desorbed and deposited into the vial.

If necessary, alternatively 1% heptafluorobutyric acid (HFBA) is used as the ion pairing reagent to reduce the ion suppression effect of the ion pairing reagent when the sample is analyzed by electrospray ion trap mass spectrometry.

### EXAMPLE 42

### Purification of Nucleic Acid Mixture with Reverse Phase Capillary Channel and Ion Pairing Reagent

A capillary of dimensions 100 μm ID and 25 cm length is functionalized with a reverse phase surface bonded according to the procedure described in Example 12. The capillary is straight configuration connected to a syringe pump (Tecan Systems, San Jose, Calif., CAVRO Model No. XP-3000) fitted with 100 μL syringe connected to one end of the open tube capillary, and the other end is movable and is connected to an apparatus where the materials may be taken up or deposited at different locations.

A 100 μL sample containing 0.01 μg of DNA is prepared using PCR amplification of a 110 bp sequence spanning the allelic MstII site in the human hemoglobin gene according to the procedure described in U.S. Pat. No. 4,683,195. A 10 μL concentrate of triethylammonium acetate (TEM) is added so that the final volume of the solution is 110 μL and the concentration of the TEAA in the sample is 100 mM. The sample is introduced into the capillary and the DNA/TEAA ion pair complex is adsorbed to the reverse phase of the capillary channel.

The sample is blown out of the capillary and a small 10 cm segment of 50% (v/v) acetonitrile/water is passed through the capillary, desorbing the DNA from the wall and the sample is deposited into a vial for analysis.

### EXAMPLE 43

### Procedure for Extraction of Benzene and Substituted Benzene Compounds From Drinking Water

A 200 μm ID 1 m length reverse phase C₁₈ capillary is prepared according to the procedure described in Example 12 and configured into a “figure 8” coil with 1 cm coil diameter and 10 cm straight ends at the inlet and outlet of the capillary tube. A syringe pump (Tecan Systems, San Jose, Calif., CAVRO Model No. XP-3000) equipped with a 5 mL syringe is connected to the capillary. The capillary is cleaned with 100 μL of HPLC grade acetone and 100 μL of HPLC grade methanol at a flow rate of 50 μL/min to condition the column. The methanol is expelled from the capillary and a 4.5 mL sample of drinking water is introduced to the capillary. The drinking water is passed through the capillary at a rate of 200 μL/min until all of the sample has passed through the column. Then, the flow is reversed and the sample is pushed back through the capillary at a flow rate of 50 μL/min until all of the sample is expelled. The remaining fluid is expelled from the capillary and a small 2 cm segment plug of 100% HPLC grade methanol is taken up and passed once slowly up and down the capillary to desorb organics from the wall of the capillary and the methanol is deposited into a small vial. The sample is analyzed according to EPA method 502 or 524.2 for benzene and substituted benzene compounds.

### EXAMPLE 44

### Procedure for Multidimensional Stepwise Solid Phase Extraction of Isotope-Coded Affinity Tagged (ICAT) Peptides

Biological samples are processed in a manner previously described for the release, isotope-coded labeling and proteolysis of target proteins as described in Steven Gygi, et al., Nature Biotech., 17:994 (1999); David Han, et al., Nature Biotech., 19:946 (2001); Marcus Smolka, et al., Analytical Biochemistry, 297:25 (2001); Huilin Zhou, et al., Nature Biotech., 19:512 (2002); and W. Andy Tao, et al., Current Opinion in Biotechnology, 14:110 (2003).

A volume of the above sample containing 2-3 μg of the resulting labeled peptides in 5 mM NaH₂PO₄ (pH=3) is introduced to a 200 μm ID 1 m long strong acid cation exchanger capillary (as described in Example 5) that is equilibrated with 5 mM NaH₂PO₄ (pH=3). The entire quantity of protein in the sample is allowed to adsorb onto the surface of the cation exchanger by passing the entire sample volume over the surface a total of eight times at 100 pumin, and the non-adsorbed species are pushed out with air and collected for further analysis.

A 10 μL volume segment of 5 mM NaH₂PO₄+10 mM KCl (pH=3) is introduced to the capillary and is passed over the internal capillary surface a total of eight times at a flow rate of 100 μL/min to elute those proteins that are soluble at this ionic strength into the volume segment from the surface. This 10 μL volume segment is pushed out with air and collected in a suitable vessel for further analysis. This process is repeated for increasing concentrations of KCl (i.e. in 10 mM KCl increments up to 300 mM KCl for a total of 31 fractions) to elute and collect for further analysis those proteins that are soluble in increasing ionic strengths.

The individual 10 μL fractions collected from the ion-exchange dimension are individually combined with 10 μL of 5 mM Na₂HPO₄, bringing the pH to 7.2. Each subsequent 20 μL sample is introduced to a 200 μm ID 1 m long monomeric avidin column (as described in Example 32) whose multimeric avidin sites have been pre-blocked by flowing 300 μL 2 mM D-biotin in PBS (0.9% w/v NaCl, 10 mM sodium phosphate, pH 7.2) through the column at 100 μL/min, followed by flowing 300 μL 0.1 M glycine at pH 2.8 at 100 μL/min, and followed by equilibration to pH 7.2 with 300 μL PBS flowing at 100 μL/min and the remaining solution is expelled with air pressure. Once the 20 μL sample is introduced to the capillary, the sample is passed over the inner surface of the monomeric avidin capillary a total of eight times at a flow rate of 100 μL/min. The remaining solution is pushed out of the capillary by air pressure, 300 μL PBS is passed through the capillary to waste at 300 μL/min, and the capillary is again cleared of any solution by air pressure.

A 10 μL volume of 0.1 M glycine at pH 2.8 is introduced to the capillary and is passed over the internal capillary surface a total of eight times at a flow rate of 100 μL/min to elute those proteins that are soluble at this pH into the volume segment from the surface. This 10 μL volume segment is pushed out with air and collected in a suitable vessel for further analysis.

The individual fractions collected from the avidin separation dimension described above are individually combined with an equal volume (10 μL) of 0.2% trifluoroacetic acid (TFA) for cases of mass spectrometric detection by MALDI ionization or 0.2% heptafluorobutyric acid (HFBA) for cases of mass spectrometric detection using electrospray ionization (ESI). This TFA/HFBA step may or may not be necessary if acid cleavage was used after the avidin separation dimension. Each subsequent 20 μL sample is introduced to a 200 μm ID 1 m long open-tube capillary coated with C-18 groups (as described in Example 12) that is equilibrated with 0.1% TFA for cases of MALDI ionization or 0.1% HFBA for cases of ESI. The entire quantity of protein in the sample is allowed to adsorb onto the surface of the reversed-phase surface by passing the entire sample volume over the surface a total of eight times at 100 μL/min, and the non-adsorbed species are pushed out with air.

A 1 μL volume segment of 0.1% TFA or 0.1% HFBA in 4% acetonitrile is introduced to the capillary and is passed over the internal capillary surface a total of eight times at a flow rate of 30 μL/min to elute those proteins that are soluble at this acetonitrile concentration into the volume segment from the surface. This 1 μL volume segment is pushed out with air and is either collected in a suitable vessel for further analysis, is spotted onto a suitable MALDI target for subsequent MS, MS/MS or MSⁿ analysis, or is dispensed into a suitable ESI nozzle for subsequent MS, MS/MS or MSⁿ analysis. This process is repeated for increasing concentrations of acetonitrile (i.e. in 4% acetonitrile increments up to 96% acetonitrile for a total of 24 fractions) to elute and collect for further MS, MS/MS or MSⁿ analysis those proteins that are soluble in increasing acetonitrile concentration.

### EXAMPLE 45

### Procedure for His-tag on NI-IDA Surface

A capillary of dimensions 200 μm ID and 60 cm long was etched by the following procedure: The capillary was rinsed with 1 mL HPLC grade deionized water. Then the capillary was filled with 0.1 M sodium hydroxide and flushed at room temperature for 30 minutes. Then, the base solution was removed by rinsing with 1 mL HPLC grade deionized water. The solution was changed to 1 mL 0.1 M HCl, and followed by another rinsing with 1 mL deionized water. The water was blown out with air.

The capillary was reacted with a solution of 3-glycidoxypropyl-trimethoxysilane (Sigma-Aldrich, Milwaukee, Wis., PN 44,016-7) at 55° C. for 10 to 12 hours at a flow rate of 0.07 mL/hour with a syringe pump. The reagent was blown out with air. Then the capillary was rinsed with 1 mL of deionized water at room temperature.

A solution of 0.2M iminodiacetic acid (IDA) (Sigma-Aldrich, Milwaukee, Wis., PN 56781) in 0.25M sodium hydroxide (NaOH) was prepared, of which the pH of the solution was ˜9. The solution was pumped through the capillary at 50° C. for 10-12 hours at a flow rate of 0.07 mL/hour with a syringe pump. The capillary was rinsed with 2-3 mL deionized water and finally stored in water.

The chelator capillary was flushed with water and converted to the Ni form with a 0.1 mM solution of NiSO₄ and flushed with water again. The capillary is ready to extract the his-tagged protein.

A FIALab 3500 (FIAlab Instruments, Inc., Bellevue, Wash.) system with two syringe pumps (1 mL and 2.5 mL) was used for testing the capillary. Each syringe had a three-way valve at its outlet to allow for independent filling and/or exchange of the syringe contents prior to their being pumped into the capillary. The output of each syringe was plumbed into a three-way “T-piece,” whose output led to the Ni-IDA capillary.

The 1 mL syringe was loaded with Qiagen his-tagged protein ladder standard (Qiagen, Santa Clarita, Calif., PN 34705) that had been diluted by 20-fold with 0.01 M Tris buffer, pH 8 to give a total his-tagged protein concentration of 12.5 μg/mL. This 1 mL syringe was used for loading the capillary with his-tagged protein.

The 2.5 mL syringe was loaded with either 0.01 M Tris buffer, pH 8 (i.e. for when the capillary was equilibrated prior to loading, or was washed after loading); or 0.01 M citric acid, pH 3 (i.e. for when his-tagged protein was eluted from the capillary).

The FIALab 3500 was programmed through its software to pump 0.01 M Tris, pH 8 via the 2.5 mL syringe pump through the nickel-loaded capillary at 3 μL/second for 120 seconds and then stopped. The 1 mL syringe then pumped 12.5 μg/mL of his-tagged protein standard at 2 μL/second for 100 seconds and then stopped. The 2.5 mL syringe was then used to pump 0.01 M Tris buffer, pH 8 to wash the capillary at 3 μL/second for 120 seconds. The contents of the 2.5 mL syringe were then flushed out and replaced with 0.01 M citric acid, pH 3. The 2.5 mL syringe was then used to pump 0.01 M citric acid, pH 3 through the capillary at 3 μL/second for 100 seconds. During this elution step the absorbance across the end of the 200 μm ID capillary was monitored at 215 nm with a SpectraPhysics detector (Spectra 200 programmable wavelength detector) measuring data points at a 3 Hz data rate. This entire process was repeated for a capillary that had no nickel loaded, as well as a nickel-loaded column for a sample that contained only 0.01 M Tris buffer, pH 8 (i.e. no his-tagged protein present). Peak integration for the his-tagged protein sample with a nickel-loaded column indicated an eluted mass of 1.1 μg of his-tagged protein.

### EXAMPLE 46

### Procedure for Preparation and Use of Protein G Capillary Channel

Two 200 μm ID 114 cm length sections of fused silica capillary were etched according to the procedure described in Example 2. The capillaries were then dried at 160° C. for three hours with a continual stream of nitrogen. A 15% solution of γ-glycidoxypropyltrimethoxysilane (Sigma-Aldrich, Milwaukee, Wis., PN 44,016-7) in dry toluene (Sigma-Aldrich, Milwaukee, Wis., 99.8% anhydrous) was passed through the capillary at 110° C. for three hours at a rate of 60 μL per minute by gravity. The silane reservoir was refilled once during this time period.

Seven centimeters were cut from each end to produce the 100 cm capillary needed. A 25 mL volume was placed over sodium and distilled to obtain the dry toluene. This solution was used for making the silane reagent. One capillary was rinsed with toluene to remove the silane reagent and stored overnight. Binding of protein G was done the next day. One mg of Protein G (CalBiochem, San Diego, Calif., PN 539303) was dissolved in 500 μL of sodium phosphate buffer at pH=8.0, 25 mM buffer concentration. The capillary was air flushed to remove toluene, rinsed briefly with methanol to remove any adsorbed toluene on the silica surface, and then rinsed briefly with water. The protein G was now flushed through the capillary monitoring the capillary end with litmus paper until the pH was basic (about pH of 8). Two column volumes of protein G were then allowed to pass through the capillary. Then the filled capillary ends were pressed into a GC septum to seal the capillary and placed in a 37° C. air oven for 3.5 hours.

Twenty μL of 4.9 mg/mL anti-FLAG M2 mouse monoclonal IgG₁ sample (Sigma-Aldrich, Milwaukee, Wis., PN, F-3165) was aspirated into 1 meter of the Protein G capillary, thus occupying roughly two-thirds of the 30 μL internal volume of the capillary. This 20 μL sample zone was visually monitored and pulled with a 50 μL syringe to the top of the capillary without allowing it to leave the capillary. The sample zone was allowed to incubate in the capillary at room temperature for five minutes, thus leaving 10 μL of internal volume unoccupied at the bottom of the capillary. The sample zone was then pushed to the bottom of the capillary in the same manner without allowing it to leave the capillary and was allowed to incubate in the capillary at room temperature for five minutes, thus leaving 10 μL of internal volume unoccupied at the top of the capillary. This process of incubating the sample zone at the top and bottom of the capillary was repeated twice for this same sample, followed by finally expelling the sample zone from the capillary with 1 mL of air flowing at 10-20 mL/min. This capillary was then washed with 10 mM NaH₂PO₄/10 mM Na₂HPO₄ buffer, pH 7 by passing 500 μL of the buffer through the capillary at 1 mL/min, followed by expelling of the buffer from the capillary with 1 mL of air flowing at 10-20 mL/min.

Ten μL of 14.7 mM phosphoric acid (pH 2.2) was aspirated into this same capillary, thus occupying roughly one-third of the 30 μL internal volume of the capillary. This 10 μL elution zone was visually monitored and pulled with a 50 μL syringe to the top of the capillary without allowing it to leave the capillary and was allowed to incubate in the capillary at room temperature for one minute, thus leaving 20 μL of internal volume unoccupied at the bottom of the capillary. The elution zone was then pushed to the bottom of the capillary in the same manner without allowing it to leave the capillary and was allowed to incubate in the capillary at room temperature for one minute, thus leaving 20 μL of internal volume unoccupied at the top of the capillary. This process of incubating the elution zone at the top and bottom of the capillary was repeated twice for this same elution zone, followed by finally expelling and collection of the elution zone into a 0.5 mL Eppendorf vial with 1 mL of air flowing at 10-20 mL/min. This collected elution zone was combined with 10 μL of Bradford assay reagent (Pierce, Rockford, Ill., PN 23236), was allowed to incubate for ten minutes at room temperature, and an absorbance reading was taken of it at 595 nm with a SpectraPhysics detector (Spectra FOCUS forward optical scanning detector). Calibration was performed by measuring a 14.7 mM phosphoric acid blank and 490 μg/mL anti-FLAG IgG, standard in 14.7 mM phosphoric acid, each combined with equal volumes of Bradford assay reagent. Analysis of the eluted sample against the calibration indicated that 2.5 μg of IgG was trapped and eluted from the Protein G capillary into 10 μL of 14.7 mM phosphoric acid (corresponding to a concentration of 250 μg/mL IgG in the eluted zone).

### EXAMPLE 47

### Procedure for Fluid Movement for 1 Channel and 8 Channels

A 200 μm ID 1 m capillary is configured into a 1.5 cm diameter coil as described in Example 50 below. The capillary can be configured as one individual coil or as eight coils contained in a single manifold with luer connections. The capillary is reacted with IgG sample as described in Example 46. A syringe pump equipped with eight syringes (World Precision Products, Sarasota, Fla., Model 230) allows for one to eight samples to be processed at one time. For each channel, a 50 μL syringe (Hamilton, Reno, Nev., PN 1706TLL) and a 1.0 mL syringe (Hamilton, Reno, Nev., PN 1001 LT) are connected together with an actuated 3-way 2 position switching valve (Upchurch Scientific, Oak Harbor, Wash., PN V101L). The 3-way valve enables access to the appropriate syringes, depending on the loading, washing, and elution step which are being used. The computer hardware unit (Dell, Roundrock, Tex., SmartStep™, Model 200N) provides an interface with the PhyNexus pump control software. The appropriate vial or other containment unit is placed underneath the end of the capillary for drawing up gas or liquid.

The syringe pump is calibrated so that the dimensions of the syringe are used to define the number of motor steps corresponding to a given volume. The capillary channel is first washed or conditioned with a wash solution. The syringe pump, via the PhyNexus pump control software, withdraws 750 μL of the IgG sample at a flow rate of 300 μL/min. Then a wash step is performed with the capillary with 100 μL of wash solution at a flow rate of 300 μL/min to wash the nonspecific bound molecules from the capillary channel. The liquid is blown out, then a 10 μL segment of the desorbing solution is used to elute the sample. The sample can be deposited anywhere including into an electrospray nozzle as described in Example 35.

### EXAMPLE 48

### Procedure for Extraction and Multiplexing by 96 Channels

The Sciclone iNL10™ Liquid Handler (Zymark, Hopkinton, Mass.) is a 20 position deck with 96 independent channel heads. The system reports actual amount transferred by each channel in the 10 nL to 1.0 mL range. A microflowmeter valve assembly is built into each channel as well as a microprocessor control thus making it possible for each channel to aspirate or dispense a different volume at the same time. It is the first liquid handler to provide feedback on how well it is performing in real time. The system reports the actual amount transferred by each channel, reports the quality of the transfer, and provides diagnostic information on the status of each channel.

Four deck positions are used for each 96 capillary pack. Three of the deck positions contain the sample and two solvents used to process the sample (i.e. wash solvent and desorption solvent). The fourth position deck position contains the vial into which the purified, enriched samples are deposited.

A 100 μm ID 25 cm capillary is configured into a 1.0 cm diameter coil as described in Example 50 below. The capillary is reacted with the IgG sample as described in Example 46. The appropriate vial or other containment unit is placed underneath the end of the capillary for drawing up gas or liquid.

The syringe pump is calibrated so that the dimensions of the syringe are used to define the number of motor steps corresponding to a given volume. The capillary channel is first washed or conditioned with a wash solution. The syringe pump, via the PhyNexuS™ pump control software, withdraws 250 μL of the sample at a flow rate of 300 μL/min. Then a wash step is performed with the capillary with 25 μL of wash solution at a flow rate of 300 μL/min to wash the nonspecific bound molecules from the capillary channel. The wash solution is deposited into a waste station, leaving the channels filled with air. Then 4 μL of the sample is eluted at a flow rate of 50 μL/min.

### EXAMPLE 49

### Influence of the Tube Enrichment Factor (TEF) on Protein Concentration

A straight fused silica tube coated with polyimide columns with dimensions 200 μm ID, 360 μm OD, and 66 cm length was washed with 0.1M NaOH for 60 min, washed with deionized water for 15 min, washed with 0.1 M HCl for 15 min, then finally washed with deionized water for 60 min all at a flow rate of 120 μL/min. The capillary was then conditioned by flowing 500 μL 20 mM Tris-HCl buffer (pH 8) at 120 μL/min. One mL of 50 μg/mL lysozyme in water was passed through the capillary a total of six times at a flow rate of 360 μL/min. The remaining solution was pushed out of the capillary with air pressure, and the capillary was flushed two times with 500 μL of 20 mM Tris-HCl buffer (pH 8) at 360 μL/min. This Tris-HCl wash buffer was assayed for its total protein content by a Bradford assay with absorbance detection at 595 nm (acidic Coomassie/Bradford protein stain available from Pierce, Rockford, Ill., PN 23200; assay procedure performed as described in the documents accompanying this reagent, “Commassie Protein Assay Reagent Kit”). It was determined against a lysozyme protein calibration curve in the presence of Tris-HCl buffer that no detectable lysozyme was present in the wash solution.

A 10 μL segment of 0.1M HCl was drawn into the capillary at a flow rate of 100 μL/min. This segment was passed over the entire inside surface of the capillary for a total of six times at a flow rate of 100 μL/min, ensuring that the segment did not exit the capillary at any time. Once completed, the segment was pushed out of the capillary with air pressure and collected. This 0.1 M HCl was assayed for its total protein content by a Bradford assay with absorbance detection at 595 nm (acidic Coomassie/Bradford protein stain available from Pierce, Rockford, Ill., PN 23200; assay procedure performed as described in the documents accompanying this reagent, “Commassie Protein Assay Reagent Kit”). It was determined against a lysozyme protein calibration curve in the presence of 0.1M HCl that 246 μg/mL lysozyme was present in the 10 μL segment. These observations corresponded to an enrichment factor of 4.92 (=246 μg mL⁻¹/50 μg mL⁻¹), a tube enrichment factor of 2.07 (=20.7 μL/10 μL), and a capacity of 2.46 μg of lysozyme (=0.01 mL×(246 μg mL⁻¹)). This same elution procedure was repeated a second time on this same capillary with a separate 10 μL segment of 0.1 M HCl, which was also collected for further analysis. It was found that there was no detectable protein in the second 10 μL 0.1 M HCl segment by the Bradford assay.

### EXAMPLE 50

### Procedure for Ni-NTA Trapping of His-Tagged GST Protein Standard

A capillary of dimensions 200 μm ID and 60 cm long was etched by the following procedure: The capillary was rinsed with 1 mL HPLC grade deionized water. Then the capillary was filled with 0.1 M sodium hydroxide and flushed at room temperature for 30 minutes. Then, the base solution was removed by rinsing with 1 mL HPLC grade deionized water. The solution was changed to 1 mL 0.1 M HCl, and followed by another rinsing with 1 mL deionized water. The water was blown out with air.

N_{α}, N_{α}-Bis(carboxymethyl)-L-lysine hydrate (Sigma-Aldrich, Milwaukee, Wis., PN 14580) (0.300 g) was suspended in 4 mL dimethylformamide (DMF). After ten minutes, two mL N,N-di-isopropylethylamine (Sigma-Aldrich, Milwaukee, Wis., PN 496219) was added. After an additional ten minutes, 0.21 g (or ca. 200 μL) 3-glycidoxypropyltrimethoxysilane (Sigma-Aldrich, Milwaukee, Wis., PN 44,016-7) was added. The solution was heated to 75° C., and if the pH was less than 8, then more N,N-di-isopropylethylamine was added. The solution was reacted for 14-16 hours at 75° C.

A 1 mL syringe was filled with the solution prepared above, and any undissolved solids should not be introduced into the syringe directly but rather filtered through a 0.45 μm filter first. The solution was pumped through the capillary at 65° C. at a flow rate of 0.07 mL/hour for 10-12 hours. Then the capillary was rinsed with 2-3 mL deionized water and the capillary was stored in water.

The chelator capillary was flushed with water and converted to the Ni form with a 0.1 mM solution of NiSO₄ and flushed with water again. The capillary is ready to extract the his-tagged protein.

His-tagged GST standard (2.5 mg/mL) was used for demonstrating the functional activity of the Ni-NTA capillary surface. The his-tagged GST standard was prepared by transforming E. Coli BL21 DE3 competent cells (Stratagene, La Jolla, Calif., PN 200131) with a pET41a vector (Novagen, Madison, Wis., PN 70556-3). Transformation, inoculation, incubation, cell harvesting and centrifugation were performed exactly according to the cell manufacturer's instructions. The pelleted cells were lysed with Bugbuster protein extraction reagent (Novagen, Madison, Wis., PN 70584-3), which was used exactly according to the manufacturer's instructions to generate 3 mL of supernatant containing the his-tagged GST. This was combined with 3 mL of a 50% slurry of glutathione Sepharose 4 FastFlow (Amersham Biosciences, Piscataway, N.J., PN 17-5132-01), and the purification through the GST group proceeded exactly according to the manufacturer's instructions. The presence of this protein before and after glutathione purification was validated by SDS-PAGE. The purified protein fractions were pooled, dialyzed against 1×PBS (0.9% w/v NaCl, 10 mM sodium phosphate, pH 7.2) and freeze-dried by standard means. The addition of 2 mL deionized water resulted in 2 mL of 2.5 mg/mL his-tagged GST in 1×PBS.

In addition to these preparation procedures, this protein material was assayed for the presence of a functional and accessible 6×His fusion tag by loading 15 μL of the dialyzed stock protein solution onto 200 μL of Ni-NTA agarose (Qiagen, Santa Clarita, Calif., PN 30210). All Ni-NTA purification steps were performed exactly according to the manufacturer's instructions. The presence of his-tagged protein released from the Ni-NTA agarose was validated by SDS-PAGE.

Twenty μL of the 2.5 mg/mL his-tagged GST sample was aspirated into 1 meter of nickel-loaded NTA capillary, thus occupying roughly two-thirds of the 30 μL internal volume of the capillary. This 20 μL sample zone was visually monitored and pulled to the top of the capillary with a 50 μL syringe without allowing it to leave the capillary. This was allowed to incubate in the capillary at room temperature for five minutes, thus leaving 10 μL of internal volume unoccupied at the bottom of the capillary. The sample zone was then pushed to the bottom of the capillary in the same manner without allowing it to leave the capillary and was allowed to incubate in the capillary at room temperature for five minutes, thus leaving 10 μL of internal volume unoccupied at the top of the capillary. This process of incubating the sample zone at the top and bottom of the capillary was repeated twice for this same sample, followed finally by expelling the sample zone from the capillary with 1 mL of air flowing at 10-20 mL/min. This capillary was then washed with 10 mM NaH₂PO₄/10 mM Na₂HPO₄ buffer, pH 7 by passing 500 μL of the buffer through the capillary at 1 mL/min, followed by expelling of the buffer from the capillary with 1 mL of air flowing at 10-20 mL/min.

Ten μL of 200 mM imidazole eluent was aspirated into this same capillary, thus occupying roughly one-third of the 30 μL internal volume of the capillary. This 10 μL elution zone was visually monitored and pulled with a 50 μL syringe to the top of the capillary without allowing it to leave the capillary. This was allowed to incubate in the capillary at room temperature for one minute, thus leaving 20 μL of internal volume unoccupied at the bottom of the capillary. The elution zone was then pushed to the bottom of the capillary in the same manner without allowing it to leave the capillary and was allowed to incubate in the capillary at room temperature for one minute, thus leaving 20 μL of internal volume unoccupied at the top of the capillary. This process of incubating the elution zone at the top and bottom of the capillary was repeated twice for this same elution zone, followed by finally expelling and collecting the elution zone into a 0.5 mL Eppendorf vial with 1 mL of air flowing at 10-20 mL/min. This collected elution zone was combined with 10 μL of Bradford assay reagent (Pierce, Rockford, Ill., PN 23236), was allowed to incubate for ten minutes at room temperature, and an absorbance reading was taken of the sample at 595 nm with a SpectraPhysics detector (Spectra FOCUS forward optical scanning detector). Calibration was performed by measuring a 200 mM imidazole blank and 250 μg/mL his-tagged GST standard in 200 mM imidazole, each combined with equal volumes of the Bradford assay reagent. Analysis of the eluted sample against this calibration indicated that 0.8 μg of the his-tagged GST was trapped and eluted from the Ni-NTA capillary into 10 μL of 200 mM imidazole (corresponding to a concentration of 80 μg/mL his-tagged GST in the eluted zone).

### EXAMPLE 51

### Purifying a (His)₆ Fusion Protein

A capillary of dimensions 100 cm×200 μm ID, 360 μm OD was functionalized with an NTA-Ni(II) chelator bonded according to the following procedure: N,N-Bis-(carboxymethyl) lysine (commonly referred to as “Nitrilotriacetic acid,” or “NTA”) was synthesized as follows based on the procedure reported by Hochuli et al. (Journal of Chromatography, 411:177-184 (1987)). A solution of H-Lys(Z)-OH (42 g; 150 mmol) in 2N NaOH (225 mL) was added drop wise to a solution of bromoacetic acid (42 g; 300 mmol; 2 eq) in 2N NaOH (150 mL) at ˜0 to 10° C. White precipitate formed as the solution of H-Lys(Z)-OH added. The reaction continued at room temperature (RT) overnight, after which the temperature was increased to 60° C. and the reaction continued for another 2 h. 1 N HCl (450 mL) was added and the mixture was place in a refrigerator for a couple hours. The solid product (Z-protected NTA) was filtered off and recrystalized by re-dissolving the solid in 1 N NaOH, then neutralized with the same amount of 1 N HCl. The Z-protected NTA was collected by filtration and dried. Z-protected NTA was dissolved in 1 N NaOH (130 mL) and 5% Pd/C (˜450 mg) was added. The reaction mixture was evacuated and saturated with H₂ before being stirred at RT under H₂ balloon overnight. The reaction mixture was filtered through a celite bed to remove the Pd/C. The filtrate, containing NTA was collected and water (80 mL) was used to wash the filtering bed. 6N HCl was added to bring the pH down to 7.5-8.0. The collected NTA solution was diluted with water to have the final concentration of ˜200 mM.

Black Delrin® plastic (Dupont, Wilmington, Del.) or Ultem® (GE Plastics, Pittsfield, Mass.) was machined into a 0.140 inches wide circular ring with dimensions of 0.750 inches outside diameter and inside diameter of 0.550 inches. The inside center of the ring was machined out leaving a channel cavity inside the ring. The capillary was coiled inside of this cavity. A slit was cut into each side of the ring so that the entrance and exit of the tubing could be configured as straight lengths of tubing coming out from each end of the ring. Polyvinylchloride (PVC) was machined to standard female luer fitting dimensions and glued to one end of the tubing using epoxy glue. To coil the tubing, the fused silica tubing was fitted into one slit on the opposite side of the circle and then coiled into the inside of the ring until there was a short 4 cm length left coming out from the ring in the opposite direction of the luer fitting. The coil diameter was effectively 1.65 cm.

The capillary was connected to an ME 100 pumping system (PhyNexus, San Jose, Calif.) fitted with 1 mL syringe connected at the end of the open tube column. The capillary was conditioned with 20 mM sodium phosphate, 150 mM sodium chloride, pH 7 at the rate of 50 μl/min for 20 minutes. The buffer was expelled and the capillary was filled with a 500 μL sample of clarified lysate of E. coli expressing His₆ fusion protein. It was drawn repeatedly through the capillary at the rate of 100 μL/min passing back and forth 2 times for a total of 4 passes through the capillary. The sample solution was blown out of the capillary and the capillary was washed with 20 mM sodium phosphate, 150 mM sodium chloride, pH 7 containing 5 mM imidazole (500 μL) followed by water (500 μL). The capillary is dried with nitrogen gas (50 psi; 2 minutes) before a small plug, 1-15 μL of desorption buffer, 200 mM imidazole was passed through the capillary and deposited into an Eppendorf vial for subsequent processing.

Alternatively, capillaries of the same dimensions but varying diameter coils: 2.0 cm, 4.3 cm, and 6.5 cm were used in the same manner as described in this Example. These coils were made by manually taking the ends of the capillary and braiding or weaving the capillary together to keep the coils intact.

### EXAMPLE 52

### Desalting a Protein Using a Hydrophobic Capillary Channel

Three capillaries of dimensions 100 cm×200 μm ID, 360 μm OD are functionalized with a hydrophobic surface bonded according to the procedure described in Example 39. Alternatively, capillaries of dimensions 100 cm×200 μm ID, 360 μm OD are functionalized with a hydrophobic C₁₈ surface bonded according to the procedure described in Example 12. Each capillary is coiled into varying diameter coils: 2.0 cm, 4.3 cm, and 6.5 cm coils by manually taking the ends of the capillary and braiding or weaving the capillary together to keep the coils intact.

Each capillary is in turn connected to an ME 100 pumping system (PhyNexus, San Jose, Calif.) fitted with 1 mL syringe connected at the end of the open tube column and the other end is connected to an apparatus where the materials may be taken up or deposited at different locations.

The sample is a 200 μl solution containing 0.1 μg of IgG proteins in a 1.5 M ammonium sulfate buffer. The sample is introduced into the capillary by passing the solution back and forth for 3 cycles and the protein is adsorbed to the hydrophobic phase of the capillary channel. The remaining sample solution is blown out of the capillary and a small 10 cm segment of 100% deionized water is passed through the capillary, desorbing the protein from the wall and the sample is deposited into a vial for analysis.

### EXAMPLE 53

### Determination of Coilability of Fused Silica Capillary Tubing

A test was performed to determine the “coilability” of lengths of fused silica capillary tubing. Three experiments were performed. For each experiment approximately 10 meters of fused silica capillary tubing was bent to a diameter of 1.5-2 cm over the entire length of the capillary, starting at one end. The bending resulted in breakage at certain locations in the capillary. The length of the resulting sections of capillary tubing are reported in Table E.

For Experiment 1, fused silica tubing with ID of 220 μm, OD of 320 μm, obtained from SGE, Inc. (Part Number CC0647) was used. For Experiment 2, fused silica tubing with ID of 200 μm, OD of 360 μm, obtained from SGE, Inc. (Part Number CC0684) was used. For Experiment 3, the same fused silica tubing was used as in Experiment 2, the difference being that prior to the experiment the tubing used in Experiment 3 was subjected to substantial handling for about 15 minutes so as to introduce nicks into the tubing. The handling included coiling and uncoiling the tubing into very large diameter coils. All tubing had about 20 μm of polyimide coating.

The data indicates that the handling of the capillary tubing does decrease the coilability, with more breakage occurring in Experiment 3 than Experiment 2. It is also seen that for each experiment there were a number of long stretches (1 m or longer) that did not break and that could be used for making coiled extraction capillaries. By performing this test prior to coiling the capillaries, it is possible to avoid using sections of the tubing that will be prone to breakage due to bending stress in the coiled conformation.

TABLE E

Experiment

| | 1 | 2 | 3 |
|---|---|---|---|
| ID/OD (μm) | 220/320 | 200/360 | 200/360 |
| Length (m) | 4.43 | 0.84 | 0.44 |
| | 5.90 | 0.07 | 1.25 |
| | 0.04 | 2.28 | 3.82 |
| | | 1.74 | 1.89 |
| | | 0.42 | 0.05 |
| | | 0.47 | 0.08 |
| | | | 0.82 |
| | | | 0.30 |
| | | | 0.38 |
| | | | 0.30 |
| | | | 1.30 |

The invention claimed is:

1. A fused silica extraction capillary having an internal solid phase extraction surface that binds an analyte, wherein at least some portion of the capillary is coiled at a bend radius of less than 3 cms.

2. The extraction capillary of claim 1, wherein the capillary comprises synthetic fused silica and a polymer coating.

3. The extraction capillary of claim 1, wherein at least some portion of the capillary is coiled at a bend radius of between 0.2 and 2 cms.

4. The extraction capillary of claim 2, wherein the total outer diameter of the capillary is in the range of 90 to 1000 microns.

5. The extraction tubing of claim 4, wherein the total outer diameter of the capillary is in the range of 150 to 850 microns.

6. The extraction capillary of claim 5, wherein the total outer diameter of the capillary is in the range of 238 to 435 microns.

7. The extraction capillary of claim 4, wherein the polymer coating comprises polyimide.

8. The extraction capillary of claim 1, wherein the analyte is a biomolecule.

9. The extraction capillary of claim 8, wherein the biomolecule is a protein or polynucleotide.

10. The extraction capillary of claim 1, wherein the extraction surface comprises an immobilized metal ion.

11. The extraction capillary of claim 1, wherein the extraction surface comprises a protein.

12. The extraction capillary of claim 11, wherein the protein is Protein A or Protein G.

13. The extraction capillary of claim 1, wherein said bend radius produces a Calculated Applied Stress upon the capillary of greater than 100 kpsi.

14. The extraction capillary of claim 13, wherein the Calculated Applied Stress is in the range of 100 and 500 kpsi.

15. An open capillary channel device comprising a fused silica extraction capillary having a first end connected to a pump for pumping liquid and gas, and a second end, the pump being a syringe pump, pressurized container, centrifugal pump or electrokinetic pump.

16. A multiplexed solid phase extraction instrument comprising a plurality of the extraction devices of claim 15 arrayed for the parallel processing of multiple samples.

17. A method for molecular open tubular solid phase extraction, the method comprising the steps of
a) adsorbing analyte molecules in a sample solution to the extraction surface of a fused silica extraction capillary tubing of claim 1, the capillary tubing having a total capillary volume; and
b) desorbing a substantial portion of the analyte molecules from the extraction surface with a desorbent liquid passed through the capillary channel

18. The method of claim 18, wherein the analyte molecules is desorbed with a Tube Enrichment Factor of at least 1.

19. The method of claim 18, wherein the direction of passage of the desorption solution through the column reversed during the desorption step.

20. The method of claim 18, wherein a wash solution is passed through the capillary channel between steps (a) and (b).

21. The method of claim 518, wherein the wash solution is any liquid present in the capillary channel is substantially displaced from the capillary channel by a gas before step (b).

22. The method of claim 21, wherein the direction of passage of the gas through the column is reversed during displacement of the liquid.

23. The method of claim 18, wherein the extraction surface has an affinity binding agent bound thereto, and the affinity binding agents is:
a) a chelated metal having a binding affinity for a biomolecule analyte;
b) a protein having a binding affinity for a protein analyte;
c) an organic molecule or group having a binding affinity for a protein analyte;
d) a sugar having a binding affinity for a protein analyte;
e) nucleic acid having a binding affinity for a protein analyte;
f) a nucleic acid or a sequence of nucleic acids having a binding affinity for a nucleic acid analyte; or
g) a small molecule binding agent having a binding affinity for a small molecule analyte.

24. The method of claim 18 wherein the analyte concentration is increased at least 1000 times.

25. The method of claim 18, wherein the analyte molecules are desorbed with a Tube Enrichment Factor from within a range from 1 to 400.

26. The open capillary channel device of claim 15, wherein the second end is free for manual positioning.
